(19) United States
(12) Patent Application Publication
(10) Pub. No.: US 2026/0276551 A1
(43) Pub. Date: Sep. 17, 2026

(54) SURFACE-ENHANCED SPECTROSCOPY SUBSTRATES

(71) Applicant: CAMBRIDGE ENTERPRISE LIMITED, Cambridge (GB)

(72) Inventors: Jeremy Baumberg, Cambridge (GB); Rakesh Arul, Cambridge (GB); David-Benjamin Grys, Cambridge (GB); Marika Niihori, Cambridge (GB); Sarah May Sibug-Torres, Cambridge (GB); Elle W. Wyatt, Cambridge (GB)

(21) Appl. No.: 19/469,725

(22) PCT Filed: Mar. 4, 2024
(86) PCT No.: PCT/EP2024/055594

§ 371 Date: Sep. 26, 2025

(30) Foreign Application Priority Data
Mar. 30, 2023 (GB) 2304765.7

(51) Int. Cl. G01N 21/65; G01N 21/35

(52) U.S. Cl. CPC G01N 21/658; G01N 21/35

(57) ABSTRACT

A method of conditioning a SES substrate comprises providing a support and providing a nanoparticle layer on the support. The nanoparticle layer comprises metallic nanoparticles. The nanoparticle layer is subjected to an oxidative cleaning step, thereby producing an oxide coating at the surfaces of the nanoparticles. Subsequently, the nanoparticle layer is subjected to a redefinition step, wherein the oxide coating is removed in the presence of scaffolding ligands so that the scaffolding ligands are arranged between adjacent nanoparticles to define their relative spacing for subsequent use in SES analysis. The SES may be SERS or SEIRA. Also disclosed are methods for carrying out SES analysis.

### ACKNOWLEDGEMENT OF FUNDING

The project leading to this application has received funding from the EPSRC Centre for Doctoral Training in Sensor Technologies for a Healthy and Sustainable Future; Grant Ref: EP/S023046/1

The project leading to this application has received funding from the Engineering and Physical Sciences Research Council; Grant Ref: EP/X037770/1

The project leading to this application has received funding from the Engineering and Physical Sciences Research Council; Grant Ref: EP/T517847/1

### FIELD OF THE INVENTION

The present invention relates to substrates for use in surface-enhanced spectroscopy (SES) and methods of manufacture of such substrates and to methods of conditioning such substrates.

### BACKGROUND

In this disclosure, indications such as [1] identify reference disclosures, the full bibliographic details of which are set out at the end of the description.

Surface-enhanced spectroscopy (SES) describes the use of surfaces to enhance the spectroscopic response of a given method. For example, surface-enhanced Raman spectroscopy (SERS) is an optical technique where the inelastic Raman scattering of light by analytes is enhanced due to electromagnetic field amplification when light is confined in spaces between certain metal nanostructures, known as “hotspots”.[1] Surface-enhanced infrared absorption spectroscopy (SEIRA) is an optical technique where the absorption of infrared light is enhanced by the same electromagnetic field enhancement. Both SERS and SEIRA are able to give fingerprint spectra of analyte molecules and have strong potential for low-cost home or clinic applications in healthcare and biofluid analysis and sensing, particularly when employing nanoparticle layer-based SES substrates.

The successful use of SES in sensing applications requires such nanoparticle layer-based SES substrates to be stable, reproducible, easy to fabricate and have reliable SES enhancements.[1] Precisely defined hotspots can increase the SES signal reproducibility and choice of the nanoparticle spacing can tune the confined plasmon modes into resonance with common laser wavelengths.[1] Reproducibility also enables quantification of analytes with high sensitivity, in addition to identification.

It is also desirable to be able to re-use nanoparticle layer-based SES substrates for successive measurements without significant reduction in performance. Such capability may, for example, allow effective “in-flow” sensing of biofluids which generally results in rapid fouling of the substrate.

Methods employing aggregation and self-assembly have been demonstrated for the low-cost, facile fabrication of nanoparticle layer-based SES substrates.[2-16] However, control of surface chemistry can be problematic for these substrates, as synthesised nanoparticles often contain additional chemicals and surfactants to increase their shelf-life or functionality. Surface molecules cannot be fully removed, even by ligand-exchange, leading to risk of interference with the target analyte binding and reduction of SES sensitivity by blocking hotspots.[17] Variation of surfactants between batches and aging[18] of nanoparticles can lead to poor uniformity and reproducibility of these substrates.

Attempts have been made to create methods which allow SES substrates to be cleaned and reused.[19-20] However, these methods generally result in loss of activity, which prevents practical utility.

The present invention has been devised in light of the above considerations.

### SUMMARY OF THE INVENTION

The present inventors have realised that it would be advantageous to be able to manufacture a SES substrate in a manner offering precise control over nanoparticle spacing. It would also be advantageous to be able to condition a SES substrate with a similar aim. Furthermore, it would be advantageous to provide a route for the re-use of SES substrates with no or only limited degradation in activity.

In a first aspect, the present invention provides a method of conditioning a SES substrate, comprising
providing a support,
providing a nanoparticle layer on the support, wherein the nanoparticle layer comprises metallic nanoparticles,
subjecting the nanoparticle layer to an oxidative cleaning step, thereby producing an oxide coating at the surfaces of the nanoparticles, and
subsequently subjecting the nanoparticle layer to a redefinition step, wherein the oxide coating is removed in the presence of scaffolding ligands so that the scaffolding ligands are arranged between adjacent nanoparticles to define their relative spacing for subsequent use in SES analysis.

In this case SES is any surface-enhanced spectroscopic technique. SES describes any spectroscopic technique whereby the measured signal is enhanced due to amplification by a surface. SES is the result of optical field enhancement in the nanogaps between adjacent nanoparticles, this is known as plasmonic enhancement. SES may refer to surface-enhanced Raman spectroscopy (SERS), or surface-enhanced infra-red absorption spectroscopy (SEIRA), or any other surface-enhanced spectroscopy.

The nanoparticle layer is provided on the support. It may be that the nanoparticle layer is provided by a suitable route based on self-assembly of nanoparticles. It may be that the nanoparticle layer is provided by evaporative deposition and aggregation; this may involve the creation of a nanoparticle monolayer in a two-phase solvent system, forming a droplet containing the monolayer, and transferring this onto a support. The nanoparticle layer may be adhered to the support. Adherence of the nanoparticle layer may be facilitated by the provision of an adhesion coating on the support (for example, a coating of chromium metal).

In a second aspect, the present invention provides a conditioned SES substrate obtained or obtainable by the method of conditioning according to the first aspect of the present invention.

The method of conditioning according to the first aspect of the present invention allows for precise control over nanogap spacing between adjacent nanoparticles through the introduction of scaffolding ligands. SES substrates that are conditioned according to the first aspect of the present invention show uniform gap spacings, irrespective of how the nanoparticle layers are initially formed. SES substrates produced by carrying out such conditioning show reliable SES spectra with very little relative variance, making them particularly useful for sensing applications, and opening up the possibility for their use in methods that quantify analyte concentrations.

Inter-nanoparticle gap spacing (nanogap spacing) refers to the size of the nanogaps in the nanoparticle layers of the present invention. The nanogaps, more specifically, are the gaps of closest approach between adjacent nanoparticles.

In a third aspect, the present invention provides a method of carrying out SES, the method comprising providing a SES substrate comprising a support and a nanoparticle layer on the support, wherein the nanoparticle layer comprises metallic nanoparticles, the method further comprising the steps of, in order:
performing a first SES analysis using the SES substrate,
subjecting the nanoparticle layer to an oxidative cleaning step,
subjecting the nanoparticle layer to a redefinition step, to provide a reconditioned SES substrate, and
performing a second SES analysis on the reconditioned SES substrate.

The method of carrying out SES according to the third aspect of the present invention, whereby an SES substrate is used in an SES analysis and then re-used for a subsequent analysis is only possible due to the reliable and reproducible SES enhancements achieved by SES substrates that are subjected to the combination of an oxidative cleaning step followed by a redefinition step.

The re-use of SES substrates is highly advantageous. The substrates are often expensive to make and may contain rare metals. The ability to re-use an SES substrate allows for the possibility of in-flow sensing in a number of application areas. The ability to re-condition an SES substrate allows for changing the surface analyte binding and/or chemical characteristics in the nanogaps, controlling which analytes can be sensed.

Further optional features of the invention will now be set out. These can be applied singly or in any combination with any aspect of the invention unless the context demands otherwise.

In some embodiments, the oxidative cleaning step acts to strip away surface-bound molecules from the surfaces of the nanoparticles. Control of surface chemistry can be problematic for nanoparticle-based substrates, as synthesised nanoparticles often contain additional chemicals and surfactants to increase their shelf-life or functionality (both commercially prepared or produced in-house).

The oxidative cleaning step is capable of completely removing these additional chemical and surfactants to create pristine nanoparticle surfaces. The oxidative cleaning step may break down, oxidise, etch, remove, strip away, or otherwise chemically alter surface-bound molecules (for example, to lower their binding affinity towards the nanoparticle surfaces), or some combination thereof, to result in oxide coated nanoparticles with substantially no surface-bound molecules present.

The oxidative cleaning step creates an oxide coating on the surfaces of surfaces of the nanoparticles. This oxide coating may be a few monolayers thick and may expand into the gap between adjacent nanoparticles and fill the entire gap volume. It may be that the oxidative cleaning step involves a comprehensive oxidation of the nanoparticle surfaces, for an extended period of time, sufficient to creating a stabilising oxide coating. The oxide coating may be substantially of the metal forming the nanoparticles.

The oxidative cleaning step creates an oxide coating or layer on the surfaces of the nanoparticles which may stabilise the nanoparticle layer, and specifically stabilise the nanoparticle layer against sintering or any other form of degradation that may impact the plasmonic field enhancement effect, and ultimately impact the response enhancement in the SES technique.

In some embodiments, the metallic nanoparticles are selected from one or more metals which support optical-frequency or mid-infrared-frequency surface plasmons.

SES relies on amplification of electromagnetic radiation (for example, laser light) by local electric fields created by the resonant, collective movement of surface electrons, known as plasmons. SERS and SEIRA use optical-frequency or mid-infrared-frequency light to probe the vibrational states of analyte molecules that are present within hotspots on the SES substrate, and so for these methods the metallic nanoparticles must be of a metal which is capable of supporting plasmons which can resonate at these frequencies.

In some embodiments, the metallic nanoparticles are one or more metals selected from the group consisting of gold (Au), silver (Ag), copper (Cu) and aluminium (Al). It may be that the metallic nanoparticles are gold nanoparticles. It may be that the metallic nanoparticles are silver nanoparticles. It may be that the metallic nanoparticles are copper nanoparticles. It may be that the metallic nanoparticles are aluminium nanoparticles. It may be that at least the core of the nanoparticles is formed of one or more nanoparticles selected from the group consisting of gold (Au), silver (Ag), copper (Cu) and aluminium (Al). It may be that the oxide layer formed is an oxide of one of the aforementioned metals.

The metallic nanoparticles may have a diameter greater than or equal to 15 nm, or greater than or equal to 60 nm. In some embodiments, for example for SEIRA, the nanoparticles may have a relatively large diameter, for example up to 10 μm. The upper limit for the diameter of the nanoparticles may be 5 μm, 1 μm, 800 nm, 600 nm, 400 nm, 200 nm, 160 nm or 120 nm, for example. In some embodiments the nanoparticles have a diameter in the range 15-120 nm. The metallic nanoparticles may have a diameter in the range 60-100 nm. The metallic nanoparticles may have a diameter in the range 60-80 nm. The metallic nanoparticles may have a diameter of about 80 nm. The shape of the nanoparticles is not particularly limited, but it may be that the nanoparticles are substantially spherical. References to the diameter of nanoparticles typically refer to the average diameter.

In some embodiments, the metallic nanoparticles are provided with a coating of palladium (Pd) or platinum (Pt) on their surfaces. The coating of a thickness of Pd or Pt can be via chemical reduction or electrochemical deposition or underpotential deposition. For electrochemical underpotential deposition, the thickness can be controlled from 0-3 monolayers of atoms, including partial atomic monolayers.

In some embodiments, the nanoparticle layer is a monolayer nanoparticle layer, a multilayer nanoparticle layer, or a nanoparticle layer with monolayer nanoparticle regions and with multilayer nanoparticle regions. The multilayer nanoparticle regions may be bilayer or trilayer regions.

The nanoparticle layer being composed of few layers (i.e. having mono-, bi-, or multiple layers) provides good access to the nanogaps for oxygen plasma, if that is being used to carry out oxidative cleaning. It also provides good access to the nanogaps for scaffolding ligands during the redefinition step, and for any analytes that are to be probed during SES analysis.

It may be that the multilayer regions produce a stronger electronic field enhancement effect, and therefore produce greater response amplification in SES experiments.

In some embodiments, the redefinition step comprises removing the oxide coating under reducing conditions or acidic conditions in the presence of a scaffolding ligand.

It may be that the reducing conditions are created by one or more reducing agents, a scaffolding ligand which is a reducing agent, or a negative voltage being applied across the SES substrate in an electrochemical cell. That is, reducing conditions are those conditions which are capable of removing the oxide coating via reduction.

An electrochemical cell here means the nanoparticle layer is attached to a conducting substrate that acts as the working electrode, and an ionic solution immerses this nanoparticle layer and is contacted by a counterelectrode through which a potential difference is applied. The control of this counterelectrode may be through a third reference electrode which measures and controls the potential difference. The conducting substrate can be a metal substrate, or a transparent conducting layer coated onto any substrate such as indium tin oxide or fluorine-doped indium tin oxide.

It may be that the acidic conditions are created by one or more acids or a scaffolding ligand which is acidic. Acidic conditions are generally those with a pH<7, but more preferably those with a pH<3.

In some embodiments, the redefinition step comprises removing the oxide coating with an acid or reducing agent in the presence of a scaffolding ligand.

In some embodiments, the redefinition step comprises removing the oxide coating thermally (i.e. with heating) or with UV light in the presence of a scaffolding ligand.

In some embodiments, the redefinition step comprises removing the oxide coating under acidic or neutral pH conditions in the presence of a scaffolding ligand and a halide ion.

The redefinition step involves the removal of the oxide coating. This may comprise the reduction, hydrolysis or exfoliation of the oxide coating, or a combination thereof. During the redefinition step the scaffolding ligand arranges itself between nanoparticles, thus stabilising the nanogaps between nanoparticles and controlling the size of the nanogaps. In this sense, it may be that the scaffolding ligands prevent deformation of the nanoparticles and prevent sintering of the nanoparticles together via deformation of the nanoparticles or the flowing of gold atoms to form a bridge between adjacent nanoparticles. Therefore, it may be that the scaffolding ligand acts as a chemical spacer and it may be that the scaffolding ligand is sufficiently rigid to stabilise the nanogaps. “Rescaffolding” in the present disclosure is equivalent to “redefining”.

In some embodiments, the scaffolding ligand is one or more molecules which have a binding affinity for the surfaces of the metallic nanoparticles. It may be that the scaffolding ligand is one or more molecules which have a favourable affinity for binding to the surfaces of the metallic nanoparticles. It may be that the scaffolding ligand is a hydrophilic molecule, or a molecule with at least one hydrophilic moiety, or it may be that the scaffolding ligand is a polar molecule, or a molecule with at least one polar moiety. It may be that the scaffolding ligand binds analytes into the nanogaps.

In some embodiments, the scaffolding ligand is one or more molecules selected from the group consisting of a cucurbit[n]uril, a polystyrene molecule, 3-mercaptopropionic acid, citrate, acetic acid, cysteamine, dopamine, paracetamol, ethanol and methanol.

It may be that following the redefinition step, the nanoparticle layer is rinsed with de-ionised (DI) water and blow-dried.

In some embodiments, the surfaces of the nanoparticles comprise a sensitising agent that facilitates binding of molecules to the nanoparticles. It may be that the sensitising agent is introduced to the surface of the nanoparticles prior to the nanoparticle layer forming, or it may be that the sensitising agent is added to the nanoparticle layer after it has formed. It may be that the sensitising agent binds analytes or scaffolding ligands into the nanogaps. It may be that the sensitising agent is Fe(III).

In some embodiments, the support comprises a dielectric or a polymer. It may be that the support is comprises glass, silicon nitride or silicon. It may be that the support is a flexible polymer, for example the support may be PMMA. It may be that the support is transparent to the laser wavelengths being used in the SES technique (e.g. the support may be optically transparent) and allows for the backside illumination of the nanoparticle layer. This is a particularly useful arrangement for sensing applications.

In some embodiments, the support is electrically conductive. It may be that the support is a metal, or it may be that the support is a dielectric or polymer which comprises an electrically conductive coating. It may be that the support is gold coated silicon.

In some embodiments, the oxidative cleaning step comprises oxygen plasma treatment, wherein the nanoparticle layer is exposed to oxygen plasma. It may be that the oxygen plasma treatment comprises passing oxygen plasma over the nanoparticle layer or subjecting the nanoparticle layer to an environment containing oxygen plasma. Oxygen plasma here may refer to the atoms, molecules, ions, electrons, free radicals, metastables and photons created by subjecting oxygen gas to high voltages.

In some embodiments, the oxidative cleaning step comprises electrochemical oxidation, wherein a positive voltage is applied across the SES substrate in an electrochemical cell.

In some embodiments, the redefinition step comprises removing the oxide coating by electrochemical reduction, wherein a negative voltage is applied across the SES substrate in an electrochemical cell in the presence of a scaffolding ligand.

When electrochemically oxidatively cleaning and redefining, it may be that the SERS substrate formed on a conductive support is used as a working electrode in an electrochemical cell. In order to achieve the oxidative cleaning, it may be that, in an electrolyte solution (e.g., phosphate buffer, NaClO4, H2SO4, etc.), a potential of 1-2 V (vs. Ag/AgCl reference electrode) is applied for at least 1 s to oxidize the gold nanoparticle surface and to remove adsorbates.

In order to achieve redefinition it may be that, in an electrolyte solution containing the scaffolding molecule, a reducing potential step or sweep is applied to reduce the Au oxide layer and to re-scaffold/redefine the nanogaps with the respective scaffolding ligand. Examples of effective reduction protocols are: (a) potential step at −0.60 V for at least 1 s, or (b) potential sweep from the open-circuit potential to −1V and back to 0 V. Varying sweep rates can be used such as 50 mV/s or 200 mV/s. The potentials referenced here are specific to Au. For other metals, the potentials for oxidation and reduction can vary.

It may be that the method of the first aspect further comprises a subsequent oxidative cleaning step and redefinition step cycle. That is, the further “cycle” comprises, in turn, an oxidative cleaning step and a redefinition step. It may be that the total number of oxidative cleaning step and redefinition step cycles is at least 2, at least 3, at least 4, at least 5, at least 6, at least 7, at least 8, at least 9, at least 10, at least 20, or at least 30. The total number of cycles includes the first oxidative cleaning step and redefinition step. It may be that the present invention allows for multiple (numerous) cycles to be carried out, without a significant drop in the uniformity of the nanoparticle layer or the strength of the SES response.

In some embodiments, the method of carrying out SES according to the third aspect of the present invention, is a method of carrying out SERS, or is a method of carrying out SEIRA.

It may be that the method of carrying out SES according to the third aspect of the present invention comprises an oxidative cleaning step which produces an oxide coating at the surfaces of the nanoparticles.

It may be that the method of carrying out SES according to the third aspect of the present invention comprises a redefinition step which removes the oxide coating in the presence of a scaffolding ligand.

It may be that the method of carrying out SES according to the third aspect of the present invention comprises a redefinition step which results in scaffolding ligands being arranged between adjacent nanoparticles to define their relative spacing.

It may be that the method of carrying out SES according to the third aspect of the present invention comprises, in between the first SES analysis and the second SES analysis, oxidative cleaning and redefinition steps which amount to the conditioning method of the first aspect of the present invention.

It may be that the method of the third aspect further comprises a subsequent oxidative cleaning step, redefinition step and SES analysis cycle. That is, the further “cycle” comprises, in turn, an oxidative cleaning step, a redefinition step and a SES analysis step. It may be that the total number of oxidative cleaning step, redefinition step and SES analysis step cycles is at least 2, at least 3, at least 4, at least 5, at least 6, at least 7, at least 8, at least 9, at least 10, at least 20 or at least 30. The total number of cycles includes the first oxidative cleaning step, redefinition step and SES analysis step cycle. It may be that the present invention allows for multiple (numerous) cycles to be carried out, without a significant drop in the uniformity of the nanoparticle layer or the strength of the SES response. The SES response, produced in the SES analysis, may be due to probing an analyte, or a mixture containing an analyte. It may be that the relative standard deviation of the peak area of an analyte probed in the SES analysis is less than or equal to 10%, less than or equal to 9%, less than or equal to 8%, less than or equal to 7%, less than or equal to 6%, or less than or equal to 5.5% across all oxidative cleaning step, redefinition step and SES analysis cycles.

### SUMMARY OF THE FIGURES

Embodiments and experiments illustrating the principles of the invention will now be discussed with reference to the accompanying figures in which:

FIG. 1 illustrates methods of nanoparticle layer preparation and characterisation, specifically a preparation protocol by (i) partial aggregation of gold nanoparticles (AuNPs) in water above CHCl₃, (ii) salt removal (‘washing’) by repeated replacement of supernatant with DI water, and (iii) final concentration step.

FIG. 2 illustrates methods of nanoparticle layer preparation and characterisation. Deposition of a droplet on Au/Si support and a dried nanoparticle layer and SEM showing dense-packed layer of AuNPs.

FIG. 3 illustrates methods of nanoparticle layer preparation and characterisation. Darkfield (DF), brightfield (BF) images and SERS map scan showing single (1ML) and double (2ML) layer regions, with close up SEM confirming existence of 1ML and 2ML (white outline) layers.

FIG. 4 illustrates methods of nanoparticle layer preparation and characterisation. Darkfield spectra of 1, 2 ML regions.

FIG. 5 illustrates nanogap definition, oxidative cleaning and redefinition. Specifically the three-step nanogap redefinition protocol of nanoparticle layers. (i) Initial surfactants (L1) define nanogaps, (ii) oxygen plasma strips out surfactants, and (iii) nanogaps stabilised using scaffolding ligand (L2).

FIG. 6 illustrates surface modifications accompanying the three-step nanogap redefinition protocol of FIG. 5 (left=nanogap definition; middle=oxidative cleaning; right=redefinition).

FIG. 7 illustrates stacked SERS spectra (not normalised) from spatial mapping of nanoparticle layers recorded after each step (i-iii) in the three-step nanogap redefinition protocol of FIG. 5 (left=nanogap definition; middle=oxidative cleaning; right=redefinition). Shading shows interquartile variation, dotted lines show baseline shift.

FIG. 8 illustrates the controlled gold atom movement. (a) Dark-field spectra of three ligands (citrate, MUA and CB[5]) before plasma treatment. Average spectrum from 100 positions, together with histograms of peak wavelength. (b) Dark-field spectra of plasma-treated nanoparticle layers after CB[5] redefining.

FIG. 9 illustrates gold atom movement after O2 plasma treatment, which leads to sintered or stabilised nanogaps in the absence/presence of a scaffolding ligand (top), respectively; and corresponding SEM images of nanoparticle sintering (bottom left) after plasma stripping (bottom centre) and when followed by direct acid treatment with scaffolding ligands (bottom right), scale bar 100 nm.

FIG. 10 illustrates the sensing capabilities of nanoparticle layers treated according to the present invention and shows the sensing setup for recyclable sensing of hydrophobic toluene.

FIG. 11 illustrates the sensing capabilities of nanoparticle layers treated according to the present invention and shows the sensing protocol for volatile organic compounds (VOCs) in sealed container.

FIG. 12 illustrates the extracted toluene signature peak (995 cm⁻¹) from the sensing setup of FIG. 10, normalised to CB[7] scaffold, showing low detection limits.

FIG. 13 illustrates the VOCs (methanol, ethanol, toluene, acetone and dimethyl sulfoxide) used for experiments using the sensing protocol of FIG. 11.

FIG. 14 illustrates the SERS spectra of VOCs using the sensing protocol shown in FIG. 11 (VOCs shown in FIG. 13; with CB[7] signal subtracted; left); and SERS maps showing CB[7] signal peak intensity (top right) and toluene signature peak normalised to CB[7] (bottom right).

FIG. 15 illustrates the application of nanoparticle layers to flow sensing, specifically showing cycling SERS sensing of paracetamol in a PDMS flow-cell.

FIG. 16 illustrates time-resolved SERS measurements showing paracetamol (Para) and acid-cleaned (HCl) spectra in the flow sensing experiment (see FIG. 15).

FIG. 17 illustrates how the extracted independent components from the flow-sensing experiment (see FIG. 15) resemble CB[7], protonated and deprotonated paracetamol.

FIG. 18 illustrates time evolution of protonated and deprotonated paracetamol components during cycling in the flow-sensing experiment (see FIG. 15).

FIG. 19 illustrates equilibration times for different paracetamol concentrations with fit (line) and standard error during the flow-sensing experiment (see FIG. 15).

FIG. 20 illustrates AuNP colloid phase above chloroform (left), and concentrated AuNP droplet before deposition (right),

FIG. 21 illustrates a deposited droplet on gold-coated support during drying.

FIG. 22 illustrates a nanoparticle layer (appearing black) deposited on coverslip (with chromium layer for improved adhesion appearing dark grey).

FIG. 23 illustrates direct deposition into coverslip.

FIG. 24 illustrates Xray photoelectron (XPS) spectrum (C 1s scan) of nanoparticle layer. Layers created using CB[5] show C═O and C—N—C bonds of CB[5] (pre plasma) which are removed after plasma treatment (post plasma). Characteristic bonds return after redefining with CB[5]. C—C contamination is present throughout measurements as well as bare gold surface (Au ref).

FIG. 25 illustrates XPS spectrum (C 1s scan) of nanoparticle layer created by NaCl aggregation (citrate stabilised) showing full removal of citrate and redefining with CB[5].

FIG. 26 illustrates evidence for oxygen on AuNP surface following plasma treatment.

FIG. 27 illustrates evidence for oxygen on AuNP surface following plasma treatment.

FIG. 28 illustrates gold nanoparticle size dependence of sintering (60, 80 and 100 nm commercial AuNPs). For the same concentration of HCl, larger AuNPs are more robust to sintering. SEMs are taken after plasma treatment.

FIG. 29 illustrates (a) control measurement demonstrating that HCl exposure of non-plasma treated nanoparticle layers (AuNPs: 80 nm) does not lead to sintering. (b) Sintering of nanoparticle layers (AuNPs: 80 nm) after plasma treatment followed by exposure to H₂SO₄. This shows that not only HCl causes sintering.

FIG. 30 illustrates (a) toluene chemical structure. (b) SERS of CB[7] redefined nanoparticle layers and Raman of toluene solution (top), DFT calculation of toluene (centre) and polarised DFT (recalculated SERS intensities within polarised E-field, bottom).

FIG. 31 illustrates normal modes of the characteristic vibrations of toluene.

FIG. 32 illustrates (a) toluene experiment with nanoparticle layers that were neither redefined nor plasma cleaned. (b) Toluene concentration series starting from highest concentration, followed by repeated HCl cleaning.

FIG. 33 illustrates dark-field scattering of nanoparticle layers constructed from D=80 and 50 nm diameter AuNPs and aggregated initially by CB[7]. Pre=before plasma cleaning, Post=after plasma cleaning for 45 mins, Rescaffold (equivalent to redefine)=after HCl+CB[7] treatment.

FIG. 34 illustrates dark-field scattering of nanoparticle layers constructed from D=40 and 20 nm diameter AuNPs and aggregated initially by CB[7]. Pre=before plasma cleaning, Post=after plasma cleaning for 45 mins, Rescaffold (equivalent to redefine)=after HCl+CB[7] treatment.

FIG. 35 illustrates SERS of nanoparticle layers constructed from D=80 and 50 nm diameter AuNPs and aggregated initially by CB[7]. Pre=before plasma cleaning, Post=after plasma cleaning for 45 minutes, Rescaffold (equivalent to redefine)=after HCl+CB[7] treatment.

FIG. 36 illustrates SERS of nanoparticle layers constructed from D=40 and 20 nm diameter AuNPs and aggregated initially by CB[7]. Pre=before plasma cleaning, Post=after plasma cleaning for 45 minutes, Rescaffold (equivalent to redefine)=after HCl+CB[7] treatment.

FIG. 37 illustrates dark-field spectral resonance positions vs AuNP diameter (extracted from FIG. 34).

FIG. 38 illustrates (top) spectral resonances of single NP, dimer, and chain of NPs in nearest-neighbour coupling approximation, and (bottom) relation between dimer and nanoparticle-on-mirror (NPoM) mode resonance.

FIG. 39 illustrates SERS of 80 nm nanoparticle layers formed by CB[7] aggregation, before/after 2-30 mins oxygen plasma cleaning showing the gradual oxidation of the nanogaps.

FIG. 40 illustrates repeated cleaning cycles of two nanoparticle layer samples, in each case formed from 80 nm AuNPs. Each cleaning cycle uses 30 mins of oxygen plasma cleaning, and redefining with 0.5 M HCl and CB[6].

FIG. 41 illustrates SERS of nanoparticle layer after oxygen plasma cleaning and redefining with various example molecular scaffolds. (a) 4-aminothiophenol (ATP), (b) 4-mercaptobenzoic acid (MBA). Spectra are taken after exposure to air, and after immersion for 10 mins in 1 M HCl.

FIG. 42 illustrates SERS of nanoparticle layer after oxygen plasma cleaning and redefining with various example molecular scaffolds. (a) 4-mercaptopyridine (MPy), (b) cyclodextrin (CD). Spectra are taken after exposure to air, and after immersion for 10 mins in 1 M HCl.

FIG. 43 illustrates the sensing of dopamine using AuNP SERS substrates. Solution aggregation (Solagg) in water using NaCl results in fractal-like chains of 60 nm AuNPs.

FIG. 44 illustrates the sensing of dopamine using AuNP SERS substrates. Schematic of nanoparticle layer on glass support. SEM image shows its random close-packed array of 60 nm gold nanoparticles.

FIG. 45 illustrates the sensing of dopamine using AuNP SERS substrates. Schematic of Fe(III)-sensitised AuNPs producing gaps of <1 nm between NPs on the nanoparticle layers, with glass support providing access from both sides.

FIG. 46 illustrates the sensing of dopamine using AuNP SERS substrates. Comparison of dopamine SERS intensity per probed nanogap in the corresponding SERS substrate.

FIG. 47 illustrates the characterisation of nanoparticle layer dopamine sensing. DA SERS spectra of three nanoparticle layer samples functionalised using different protocols. PreFe(III) gives 3-fold higher signal than PostFe(III).

FIG. 48 illustrates the characterisation of nanoparticle layer dopamine sensing. DFT calculations of the bis-dopamine complexation of both the deprotonated and protonated DA.

FIG. 49 illustrates the characterisation of nanoparticle layer dopamine sensing. Schematic of the bis-dopamine complexation to Fe.

FIG. 50 illustrates the characterisation of nanoparticle layer dopamine sensing. Kinetic study (left) of DA (added at time t=0) diffusing into the gaps, at varying concentrations. Delay time τ_{d} to reach 50% of saturated signal, and binding rate

$${τ}_{r}^{- 1}$$

as indicated (lines left to right: 100 uM, 50 uM, 10 uM). Corresponding τ_{d} and

$${τ}_{r}^{- 1}$$

(right) extracted vs DA concentration (circles on each line, left to right: 10 uM, 50 uM, 100 uM).

FIG. 51 illustrates the cleaning of nanoparticle layer SERS substrates. SERS spectra after each step of the cleaning process (arrows). Oxygen plasma treatment removes all organic analytes, allowing layers to be reused.

FIG. 52 illustrates the cleaning of nanoparticle layer SERS substrates. XPS counts (after scaling) showing formation of Au(III).

FIG. 53 illustrates the cleaning of nanoparticle layer SERS substrates. SERS uniformity over measurements of 50 different locations (average 100 μm separation), from extracted relative standard deviation (RSD) of 6%.

FIG. 54 illustrates the limits of detection for sensing DA using nanoparticle layers. Spectra after 24 hour immersion showing visible DA peaks <500 nM, vertical offsets indicated by lines on right. Vertical ordering in key corresponds to vertical ordering of lines.

FIG. 55 illustrates the limits of detection for sensing DA using nanoparticle layers. Principal component analysis (PCA) shows different DA concentration regimes. Dotted line is component score of 0M DA, shaded area above this line indicates LOQ corresponding to 9σ. Arrow indicates clinical concentration range of DA found in human urine. The quantitative region was fitted with a Langmuir-Hill equation (inset) in order to calculate the LOD.

FIG. 56 illustrates the multiplexed sensing of DA and EPI in nanoparticle layer. a) Chemical structures of dopamine (DA) and epinephrine (EPI). b) Corresponding SERS spectra when complexed with Fe(III) in nanoparticle layer.

FIG. 57 illustrates normalised SERS spectra with varying ratios of DA:EPI (left) and SERS peak at 895 cm⁻¹ from DA-EPI-Fe(III) complex, emerging only with mixed catecholamines (right).

FIG. 58 illustrates experimental SERS peaks of 10 mM DA labelled through a-j and are assigned in Table S1 based on density functional theory (DFT) calculations. All frequencies are scaled by a factor of 0.9671.

FIG. 59 illustrates SERS DA signals from nanoparticle layer before/after multiple cycles of plasma cleaning and DA exposure to test the repeatability of the cleaning protocol and accrued damage. The SERS intensity at 1481 cm⁻¹ was extracted in each case.

FIG. 60 illustrates XPS survey spectra of nanoparticle layer after being exposed to 10 mM of DA solution.

FIG. 61 (a) illustrates Au 4f before plasma cleaning and (b) after plasma cleaning for 15 minutes with fraction of Au(III) species detected.

FIG. 62 illustrates SERS spectra after 10 minutes immersion in DA, with visible DA peaks above 10 μM, vertical offsets indicated by lines on right. Vertical ordering in key corresponds to vertical ordering of lines.

FIG. 63 illustrates a principal component analysis (PCA) showing typical Langmuir isotherm model behaviour (inset).

FIG. 64 illustrates eigenvalues obtained from principal component analysis (PCA) on 160 SERS spectra with different analyte concentrations. I-III identifies the 3 dominant PCA components and their weights based on the eigenvalue %.

FIG. 65 illustrates the first three PCA component scores relative to the SERS sample number plotted together with the corresponding concentration (bottom).

FIG. 66 illustrates the loading plots of the corresponding components from FIG. 65, with I resembling the expected DA: Fe(III) SERS spectrum.

FIG. 67 illustrates a comparison between expected DA and the measured DA by calculating the ratio of the 100% SERS spectrum which maximised the overlap with each experimental SERS spectrum.

FIG. 68 illustrates (top) the residual area of the new peak at 895 cm⁻¹, with the line representing DA %×(1−DA %) and (bottom) residuals when the peak area at 895 cm⁻¹ is fitted against the DA %×(1−DA %) curve.

FIG. 69 illustrates preparation and in-flow EC-SERS analyte detection, cleaning and redefinition with nanoparticle layer-CB[5], specifically a schematic illustrating the integration of a nanoparticle layer-CB[5] into an EC-SERS flow system. All SERS spectra are collected with 1s integration time and 1 mW 785 nm laser.

FIG. 70 illustrates preparation and in-flow EC-SERS analyte detection, cleaning and redefinition with nanoparticle layer-CB[5], specifically a cross-section of the EC-SERS flow cell (CE=counter electrode, RE=reference electrode, and WE=working electrode). All SERS spectra are collected with 1s integration time and 1 mW 785 nm laser.

FIG. 71 illustrates a schematic diagram of the electrochemical SERS (EC-SERS) flow and optical set-up.

FIG. 72 illustrates a photo of the electrochemical SERS (EC-SERS) flow and optical set up.

FIG. 73 illustrates potential-dependent binding of adenine (ADN) on nanoparticle layer-CB[5], specifically time-series SERS spectra (top) of the nanoparticle layer-CB[5] cycled between +0.5 V and −1 V in 10 μM adenine (ADN) and 50 mM potassium phosphate buffer (pH 7.0) at 50 mV/s for 5 scans. Peak intensities of CB[5] (830 cm⁻¹) and ADN (~732 cm⁻¹) are also plotted (centre) per SERS spectrum. The applied potential and corresponding current response are plotted (bottom) with time. All SERS spectra collected at 1 s integration time, 785 nm excitation laser with 1 mW power.

FIG. 74 illustrates potential-dependent binding of ADN on nanoparticle layer-CB[5], specifically molecular structure of ADN and its acid and base forms (top) and SERS spectro-voltammogram of the CV scans 1-2, showing the evolution of ADN peak intensity as the potential is scanned. The dotted line indicates the applied starting potential (bottom). All SERS spectra collected at 1 s integration time, 785 nm excitation laser with 1 mW power.

FIG. 75 illustrates potential-dependent binding of ADN on nanoparticle layer-CB[5], specifically (left) time-series SERS spectra of the nanoparticle layer-CB[5] incubated in 10 μM ADN in 50 mM potassium phosphate buffer (pH 7.0) at open-circuit potential (OCP), at various applied step potentials (vs Ag/AgCl), and after relaxation back to OCP. (right) ADN peak (vADN~732 cm⁻¹) tracked from time-series SERS spectrum. All SERS spectra collected at 1 s integration time, 785 nm excitation laser with 1 mW power.

FIG. 76 illustrates potential-dependent binding of ADN on nanoparticle layer-CB[5], specifically SERS spectra before (t=0 s from time-series SERS spectra), during (t=30 s), and after different applied potentials (t=45 s). All SERS spectra collected at 1 s integration time, 785 nm excitation laser with 1 mW power

FIG. 77 illustrates potential-dependent binding of ADN on nanoparticle layer-CB[5], specifically normalised intensities of ADN peak during and after different applied potentials. All SERS spectra collected at 1 s integration time, 785 nm excitation laser with 1 mW power.

FIG. 78 illustrates preparation and in-flow EC-SERS analyte detection, cleaning and redefinition with nanoparticle layer-CB[5], specifically a schematic of in-situ electrochemical SERS analyte detection and cleaning/redefinition protocol. Potentials are vs Ag/AgCl. All SERS spectra are collected with 1s integration time and 1 mW 785 nm laser.

FIG. 79 illustrates preparation and in-flow EC-SERS analyte detection, cleaning and redefinition with nanoparticle layer-CB[5], specifically SERS spectra from: initial nanoparticle layer-CB[5] (top), after detection of 10 μM adenine (ADN) (second from top), after oxidative cleaning step (second from bottom), and after redefinition step (bottom). ADN peak at 732 cm⁻¹ is marked by asterisk. SERS spectra are collected with 1s integration time and 1 mW 785 nm laser.

FIG. 80 illustrates analyte detection, cleaning and redefinition cycles with CB[5], specifically SERS spectra from 30 cycles of 10 μm ADN detection and redefinition with CB[5], spectra are offset for clarity, and redefined spectra are the lower members of each pair of spectra.

FIG. 81 illustrates analyte detection, cleaning and redefinition cycles with CB[5], specifically ADN peak areas (v_{ADN}=732 cm⁻¹) from the SERS spectra of each ADN detection and cleaning/CB[5]-redefinition cycle. Dotted horizontal line represents the average ADN peak area of all analyte detection cycles.

FIG. 82 illustrates regional uniformity of ADN signal on nanoparticle layer-CB[5] over multiple cycles of analyte detection and cleaning/redefinition with CB[5], specifically SERS spectrum of nanoparticle layer-CB[5] before analyte cycling tests. SERS map captured using 1 s integration time, 785 nm excitation laser, 2.14 mW power with a 20× objective

FIG. 83 illustrates regional uniformity of ADN signal on nanoparticle layer-CB[5] over multiple cycles of analyte detection and cleaning/redefinition with CB[5], specifically optical microscope image of 465×330 μm region-of-interest used for SERS mapping.

FIG. 84 illustrates regional uniformity of ADN signal on nanoparticle layer-CB[5] over multiple cycles of analyte detection and cleaning/redefinition with CB[5], specifically for cycles 1 (top), cycle 10 (bottom), (left) SERS spectra of nanoparticle layer-CB[5] after 5 μM ADN binding with −0.60 V enhancement potential in 50 mM potassium phosphate buffer (pH 7.0), and after cleaning and redefinition with CB[5]. Spectra were taken in-situ with 1 s integration time, 785 nm laser with 1 mW power using a 40× objective. Heatmaps of SERS ADN peak area (v_{ADN}=732 cm⁻¹) over the dried nanoparticle layer-CB[5] surface area (middle) after ADN binding and (right) after redefinition cycle with CB[5]. Heatmaps were taken over the region shown in FIG. 83, right on a 31×11 grid with 15×30 μm spacings. SERS map captured using 1 s integration time, 785 nm excitation laser, 2.14 mW power with a 20× objective.

FIG. 85 illustrates regional uniformity of ADN signal on nanoparticle layer-CB[5] over multiple cycles of analyte detection and cleaning/redefinition with CB[5], specifically for cycles 20 (top), cycle 30 (bottom), (left) SERS spectra of nanoparticle layer-CB[5] after 5 μM ADN binding with −0.60 V enhancement potential in 50 mM potassium phosphate buffer (pH 7.0), and after cleaning and regeneration with CB[5]. Spectra were taken in-situ with 1 s integration time, 785 nm laser with 1 mW power using a 40× objective. Heatmaps of SERS ADN peak area (v_{ADN}=732 cm⁻¹) over the dried nanoparticle layer-CB[5] surface area (middle) after ADN binding and (right) after redefinition cycle with CB[5]. Heatmaps were taken over the region shown in FIG. 83, right on a 31×11 grid with 15×30 μm spacings. SERS map captured using 1 s integration time, 785 nm excitation laser, 2.14 mW power with a 20× objective

FIG. 86 illustrates analyte detection, cleaning, and redefinition cycles with CB[5], specifically CB[5] peak areas (vCB[5]=830 cm⁻¹, circles) and integrated SERS background (squares) for the CB[5]-regenerated nanoparticle layer. Dotted horizontal line represents the average CB[5] peak area of all redefinition cycles.

FIG. 87 illustrates analyte detection, cleaning, and redefinition cycles without CB[5], specifically overlaid SERS spectra from 15 cycles of 10 μM ADN detection and (top) after redefinition without CB[5] (bottom). A constant background was subtracted from all spectra to facilitate comparison across 15 cycles.

FIG. 88 illustrates analyte detection, cleaning, and redefinition cycles without CB[5], specifically ADN peak areas (vADN=732 cm⁻¹) from the SERS spectra of each ADN detection and cleaning/redefinition cycle without CB[5].

FIG. 89 illustrates regional uniformity of ADN signal on nanoparticle layer-CB[5] over multiple cycles of analyte detection and cleaning/redefinition without CB[5], specifically (left) SERS spectrum of nanoparticle layer-CB[5] before analyte cycling tests and (right) optical microscope image of 465×330 μm region-of-interest used for SERS mapping. SERS map recorded using 1 s integration time, 785 nm excitation laser, 2.14 mW power with a 20× objective.

FIG. 90 illustrates regional uniformity of ADN signal on nanoparticle layer-CB[5] over multiple cycles of analyte detection and cleaning/redefinition without CB[5], specifically for cycles 1 (top), cycle 2 (middle), and cycle 10 (bottom): (left) SERS spectra of nanoparticle layer-CB[5] after 5 μM ADN binding with −0.60 V enhancement potential in 50 mM potassium phosphate buffer (pH 7.0), and after cleaning and redefinition without CB[5]. Spectra were taken in-situ with 1 s integration time, 785 nm laser with 1 mW power using a 40× objective. Heatmaps of SERS ADN peak area (VADN=732 cm⁻¹) over the dried nanoparticle layer-CB[5] surface area (centre) after ADN binding and (right) after redefinition without CB[5]. Heatmaps were taken over the 465×330 μm region shown in FIG. 89 (right) on a 31×11 grid with 15×30 μm spacings. SERS map recorded using 1 s integration time, 785 nm excitation laser, 2.14 mW power with a 20× objective.

FIG. 91 illustrates cycles of 10 μM ADN detection, cleaning and redefinition with buffer and 1 mM KCl on nanoparticle layer-CB[5], specifically SERS spectra from 15 cycles of 10 μM ADN detection and cleaning/redefinition in 1 mM KCl, 50 mM potassium phosphate buffer (pH 7.0). Spectra are offset for clarity.

FIG. 92 illustrates cycles of 10 μM ADN detection, cleaning and redefinition with buffer and 1 mM KCl on nanoparticle layer-CB[5], specifically (top) ADN peak areas after analyte detection and cleaning/regeneration. (bottom left) Dark field scattering spectra and (bottom right) scanning electron micrographs of the MLagg-CB[5] before and after 15 cycles and analyte detection and cleaning/redefinition in 1 mM KCl and buffer.

FIG. 93 illustrates cycles of 10 μM ADN detection, cleaning, and redefinition with buffer on nanoparticle layer-NaCl, specifically SERS spectra from 15 cycles of 10 μM ADN detection and cleaning/redefinition in 50 mM potassium phosphate buffer (pH 7.0). Spectra are offset for clarity.

FIG. 94 illustrates cycles of 10 μM ADN detection, cleaning, and redefinition with buffer on nanoparticle layer-NaCl, specifically (top) ADN peak areas after analyte detection and cleaning/redefinition. (bottom left) Dark field scattering spectra and (bottom right) scanning electron micrographs of the nanoparticle layer-NaCl before and after 15 cycles and analyte detection and cleaning/regeneration in buffer.

FIG. 95 illustrates Initial EC cleaning and regeneration of nanoparticle layer-CB[5], specifically schematic of the initial cleaning and redefinition of freshly prepared nanoparticle layer-CB[5] using in situ electrooxidation and reduction.

### DETAILED DESCRIPTION OF THE INVENTION

Aspects and embodiments of the present invention are discussed below with reference to the accompanying figures. Further aspects and embodiments will be apparent to those skilled in the art. All documents mentioned in this text are incorporated herein by reference.

In particular, the discussion below is centred around SERS as the SES technique, however the aspects and the embodiments of the invention that are exemplified in the context of SERS are applicable to any suitable SES technique (for example, SEIRA). The discussion below is around two embodiments of the present invention, a gold nanoparticle-based SERS substrate, and a gold nanoparticle-based SERS substrate that is sensitised with Fe(III).

### Gold Nanoparticle SERS Substrates

The inventors below demonstrate the reliable creation of layers of gold nanoparticles in random close-packed arrays with sub-nm gaps as a sensitive SERS substrate. Using oxygen plasma etching as an oxidative cleaning tool, all the original molecules creating the nanogaps between adjacent nanoparticles in the nanoparticle layers can be removed and replaced with scaffolding ligands that deliver extremely precise nanogap sizes even below 1 nm. This allows tailoring of the chemical environment of the nanogaps which is crucial for practical Raman sensing applications. Because the resulting nanoparticle layers are easily accessible from opposite sides by fluids and by light, high performance fluidic sensing cells are enabled. The ability to cyclically clean off analytes and reuse these nanoparticle layers is shown, exemplified by sensing of toluene, volatile organic hydrocarbons, and paracetamol, among others.

Surface-enhanced Raman scattering (SERS) is a promising optical sensing technique that billion-fold enhances the inelastic Raman scattering from analytes due to electromagnetic field amplification when light is confined in nanogaps (hotspots) between suitable metal nanostructures.

To fabricate nanoparticle layer SERS substrates for applications such as sensing, the nano-assembly, growth, functional binding, hotspot control, and surface chemistry of the nano-constructs is essential. Sensing relies on the substrate being stable, reproducible, easy to fabricate and having reliable SERS enhancements.[1] Precisely defined hotspots increase the SERS signal reproducibility, while choice of the gap size tunes the confined plasmon modes into resonance with common Raman laser wavelengths.

Top-down approaches such as electron-beam lithography,[21-23] deep-UV lithography, focused-ion beam milling,[25-26] and nanoimprint lithography[27-29] have been used to fabricate reproducible and scalable SERS substrates with pristine metal surfaces. However, these lithography-based strategies are time-consuming, require high-cost infrastructure, and can only reliably reach gap dimensions down >5 nm.[30, 31]

Alternatively, bottom-up approaches based on nanoparticle self-assembly have been demonstrated for low-cost, facile fabrication of nanoparticle layer-based SERS substrates. Using template-assisted,[2-4] evaporative,[5-9] and interfacial[10-16] self-assembly, close-packed nanoparticle constructs can be prepared with high spatial uniformity. By selecting the nanoparticle surfactant[6, 12, 14] and carefully controlling the self-assembly process,[5, 7, 8] inter-nanoparticle gap spacings can be tuned, even down to the sub-nanometre level.[32]

Control of surface chemistry can be problematic for nanoparticle-based substrates, as synthesised nanoparticles often contain additional chemicals and surfactants to increase their shelf-life or functionality (both commercially prepared or produced in-house). Surface molecules cannot be fully removed, even by ligand-exchange, causing interference with the target analyte binding association constants[17] and diminishing the sensitivity to trace analytes by blocking the regions of greatest SERS enhancement. Variation of surfactants between batches and aging of gold nanoparticles (AuNPs; involving adatom morphological changes on the metal facets[18]) can lead to poor uniformity and reproducibility of these substrates.

The inventors have found a simple and reproducible method to efficiently construct a nanoparticle layer with uniform nanogaps through a conditioning method that can be used to sequester and detect small molecules with high levels of specificity. These nanoparticle layers consist of dense-packed single (or bi) layers of spherical gold nanoparticles with precision-controlled nanogap separations defined by molecular scaffolding ligands such as cucurbit[n]urils.[17, 18] The AuNPs form a close-packed disordered network but have a well-defined fill fraction, allowing for excellent optical properties due to the consistent sub-nanometre (<1 nm) gap spacing control. Having a monolayer of AuNPs in the nanoparticle layer allows the analyte to diffuse uniformly across the nanogaps and gives capability for reproducible backside illumination.

The inventors also find that the metallic nanoparticle layers can be directly deposited onto various supports including glass, Si, PDMS or Au-coated silicon wafers, and integrated into flow systems. Once the nanoparticle layers are fixed in place, oxygen plasma etching which is known to remove/break down surface-bound molecules, can be used to strip contaminant molecules (citrate, stabilising agents, coagulants) from the nanoparticle layer in an oxidative cleaning step.[33]

The inventors find that the nanoparticle layer can be reused as part of a SERS substrate by oxygen plasma cleaning or flushing analytes from the nanogaps using HCl, enabling continuously reusable flow sensing systems unviable for solution aggregates. Liquid, vapour, and flow sensing are demonstrated here, highlighting the exceptional suitability for integration with other devices for a variety of applications spanning from environmental to healthcare monitoring.

### Nanoparticle Layer Preparation and Characterisation

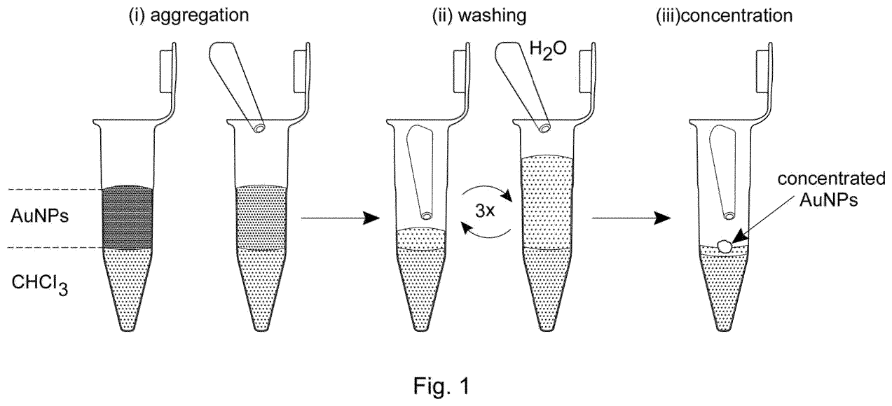

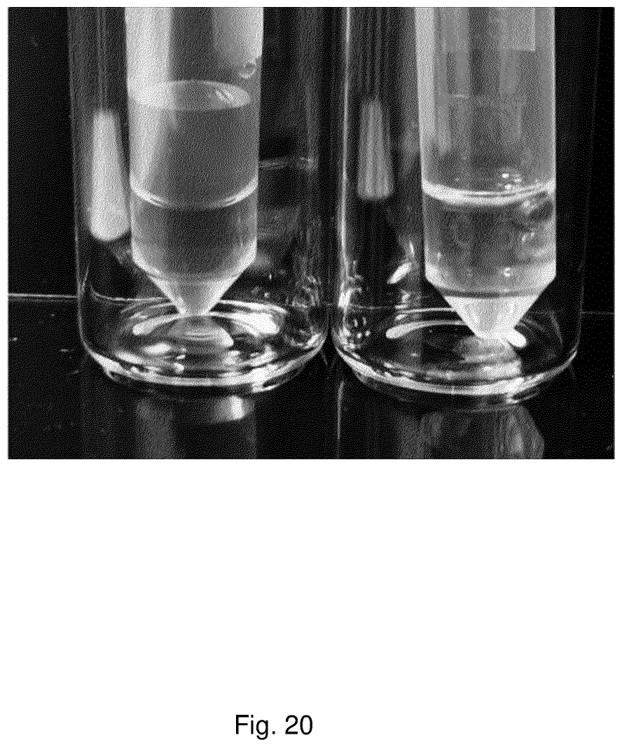

Nanoparticle layers are simply prepared in <5 minutes by partial aggregation of AuNPs (80 nm diameter unless otherwise stated, 15-120 nm also tested) in a two-phase chloroform-water system (FIG. 1). The addition of an aggregating agent (either salts or other ligands) forces AuNPs to the water-air and water-chloroform interfaces (FIG. 1(i)). Removal of the supernatant concentrates AuNPs at the interfaces, visible by eye as a reflective red-gold film. Three-fold repetition of this washing procedure further increases the AuNP density (FIG. 1(ii)), leaving a small AuNP droplet and approximately 10 μL of residual supernatant floating on the chloroform phase (FIG. 1(iii); see FIG. 20 for photos).

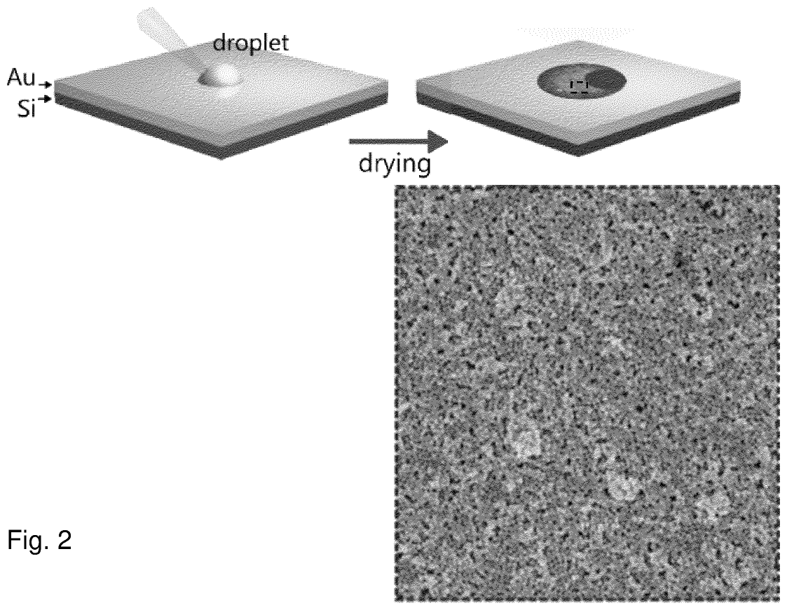

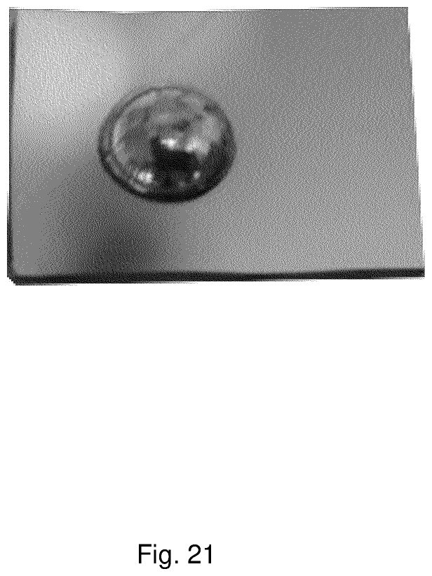

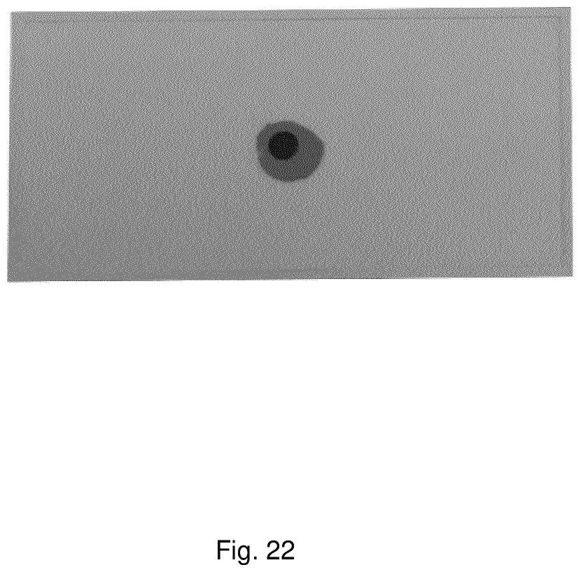

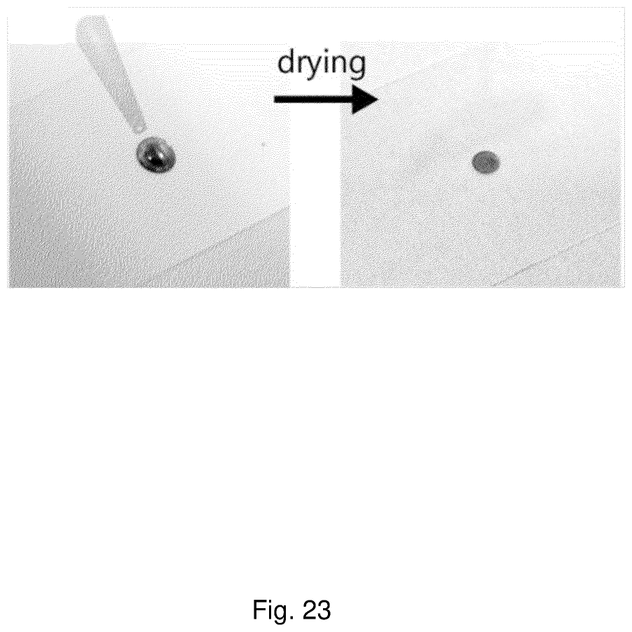

This droplet can then be deposited onto various supports such as gold, glass, silicon, or PDMS (FIG. 2), for direct integration into microfluidic systems (see FIG. 21 and FIG. 22). As the residual supernatant evaporates, a dense-packed disordered arrangement of AuNPs is formed into a metallic nanoparticle layer of approximately 5 mm diameter (FIG. 2, SEM).

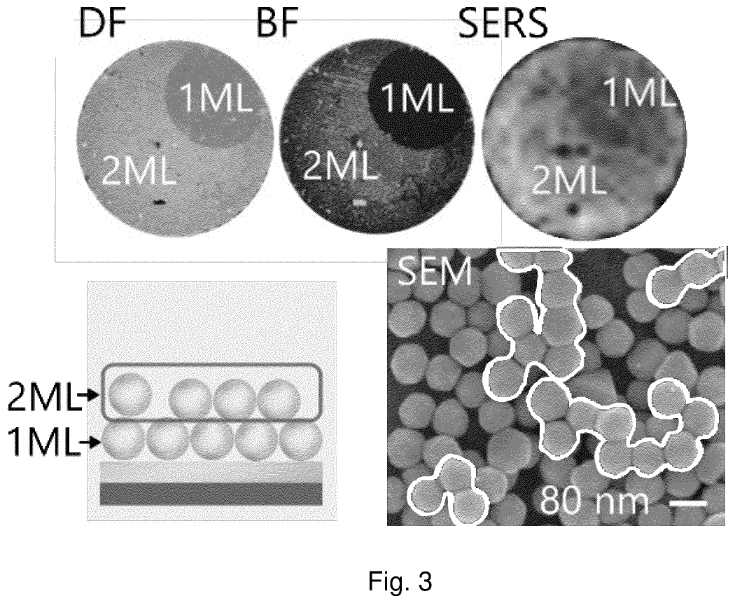

These metallic nanoparticle layers show distinct regions with a monolayer (1ML) or bilayer (2ML) of AuNPs (FIG. 3, bottom). The second layer forms because the surface area of the drying droplet (consisting of a AuNP monolayer) is larger than its footprint on the substrate due to surface pinning. The inventors note that the relative areas of mono/bi-layer nanoparticle layer can be controlled by predefined surface patterning of the substrate.

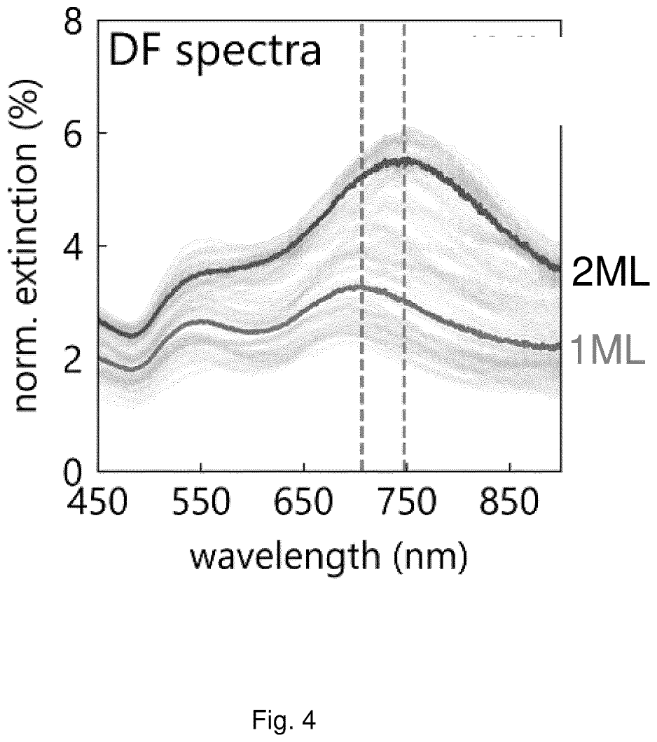

The 1ML and 2ML regions are clearly visible in bright and dark-field images as well as SERS map scans (FIG. 3, top). The plasmonically-active nanogaps produce strong SERS signals from trapped molecules (see below) exhibiting stronger emission in the 2ML region. This enhanced optical interaction is confirmed by darkfield spectra showing distinct resonant modes from the 1ML and 2ML regions (FIG. 4). In both cases the precisely controlled gap spacings (see below) produce clear plasmonic modes from the 1ML and 2ML gold nanoparticle layers, which redshift and strengthen with increasing number of layers.

### Defining, Oxidative Cleaning, and Redefining Nanogaps

A key feature of these close-packed nanoparticle layers is their very tight gap spacing control. Since the nanoparticle layers are supported on a support with all the spaces between adjacent nanoparticles accessible, the inventors are able to introduce the process of the embodiments of the present invention which transforms the gap scaffolding and controls the spacing between nanoparticles. This contrasts with solution aggregation in which such molecular replacement is not viable.

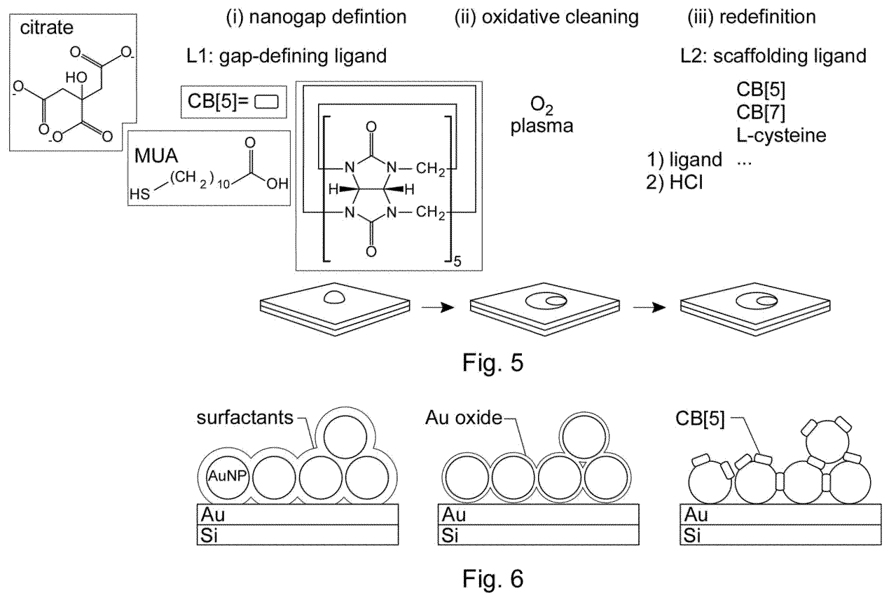

This three-step process (FIG. 5 and FIG. 6) separates (i) the definition of nanogap size by initial scaffolding, (ii) oxidative cleaning, and (iii) the redefinition of the gaps using any desired scaffolding ligand. This makes it possible to fully control and fine tune the nanoparticle spacing and facet chemistry.

The initial gap spacing is defined by the chemistry of the aggregating agents that act as gap-defining ligands. Using different aggregating agents which bind to the 80 nm diameter AuNP surfaces, a range of spacings can be produced (0.9-3 nm). If the ligand of choice is not water-soluble it can instead be dissolved in the organic chloroform phase and which, after vigorous shaking of the two-phase system, binds to the AuNP surface. To demonstrate the nanogap definition, use of 11-mercaptoundecanoic acid (MUA), sodium chloride (NaCl), and cucurbit[5]uril (CB[5]) as the initial aggregating agents (FIG. 5 top left) is compared.

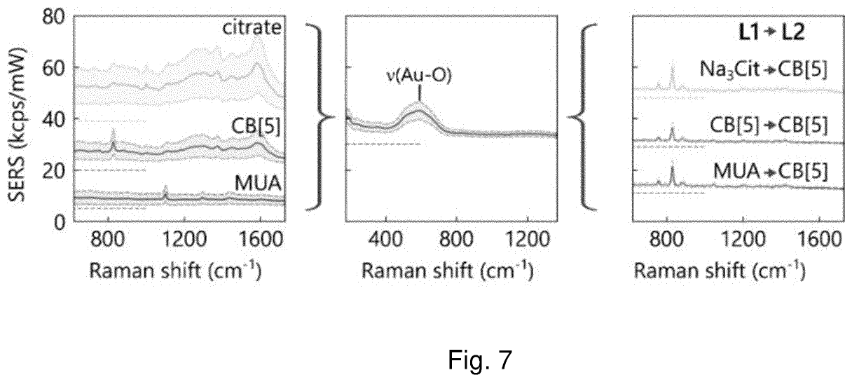

The SERS spectra recorded after deposition and drying of the nanoparticle layers (FIG. 7, left) reveal the nanogap chemistry of the initially-prepared nanoparticle layers. The NaCl-salted layers (“citrate”) show the citrate surface chemistry of the AuNPs employed. The characteristic vibration at 995 cm⁻¹ shows that citrate anions define the gap spacing, which is estimated to be 1.0±0.2 nm (shaded region shows interquartile range over an area 200 μm×200 μm, laser spot size ~1 μm).

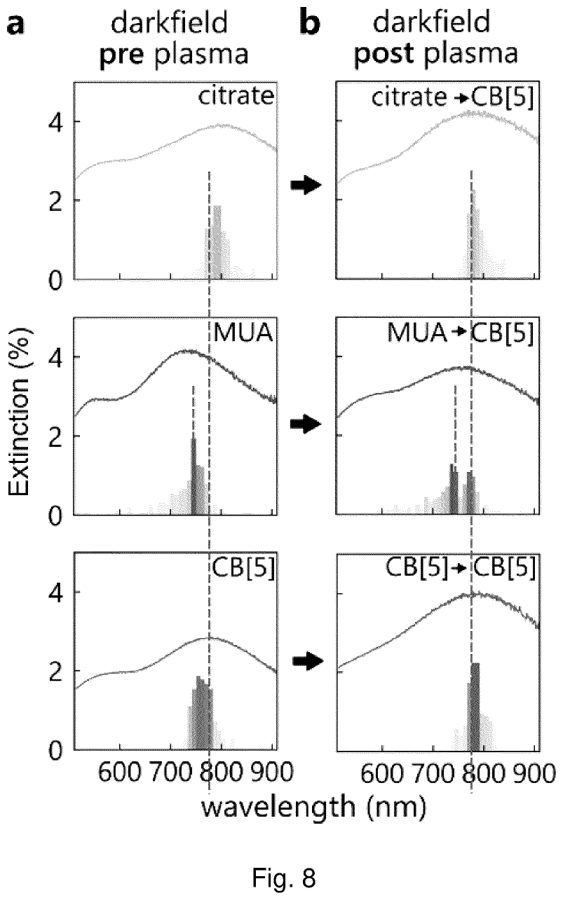

Aggregating the nanoparticle layers instead with CB[5] (FIG. 7, left, “CB[5]”) gives similar SERS spectra to the NaCl-salted films but with additional strong CB[5] modes, particularly the ring-breathing mode at 829 cm⁻¹. This shows the CB[5] does not fully displace citrate anions from the AuNP surfaces leading to a mixed chemical environment. The gap spacing here is constrained to the CB[5] portal-to-portal height of 0.9 nm (see below). The SERS spectra of the MUA-aggregated layers (FIG. 7, left, “MUA”) show an even higher relative variance than the NaCl or CB[5] nanoparticle layers. The long and flexible alkane chains (as compared to smaller citrate or rigid CB[5]) presumably lead to larger gap sizes (compare DF spectra in FIG. 8) and gap size variation.

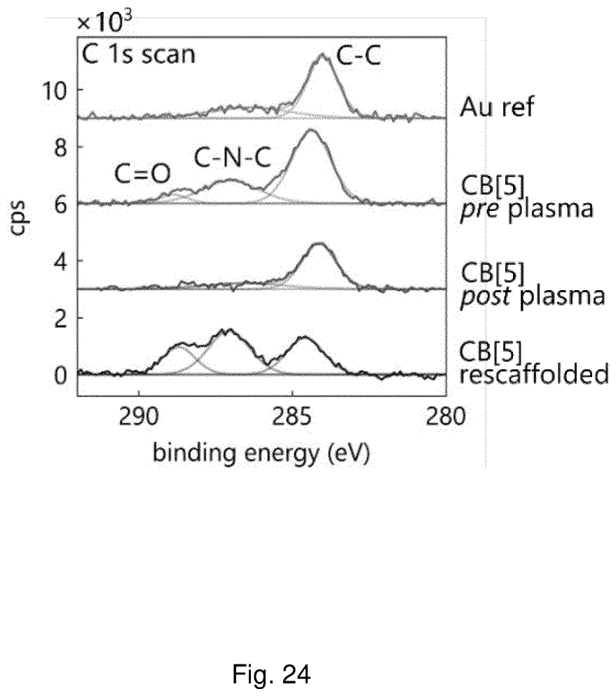

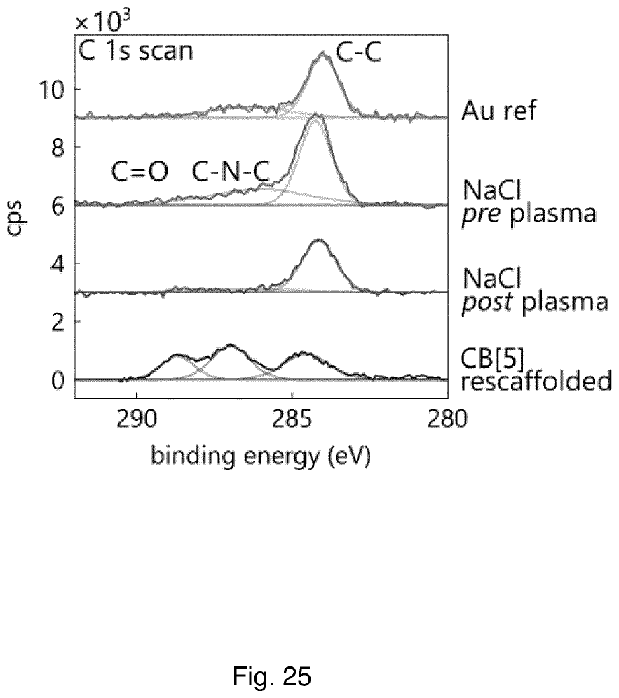

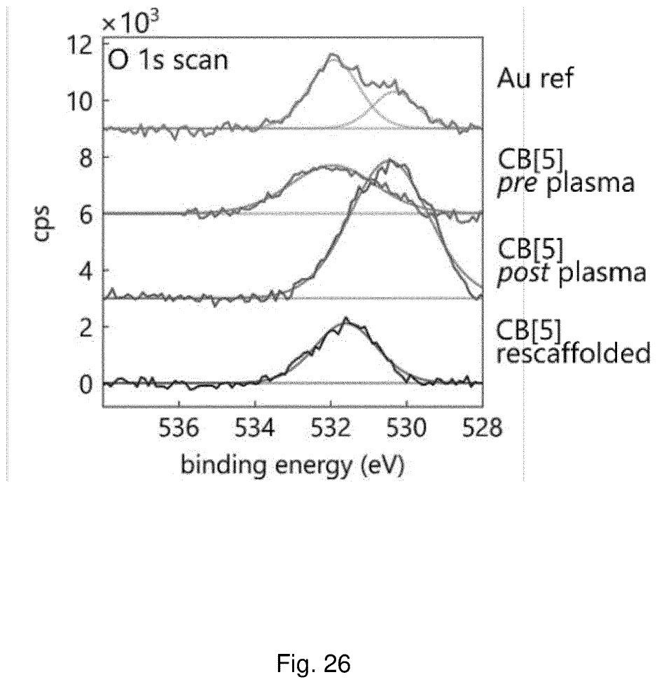

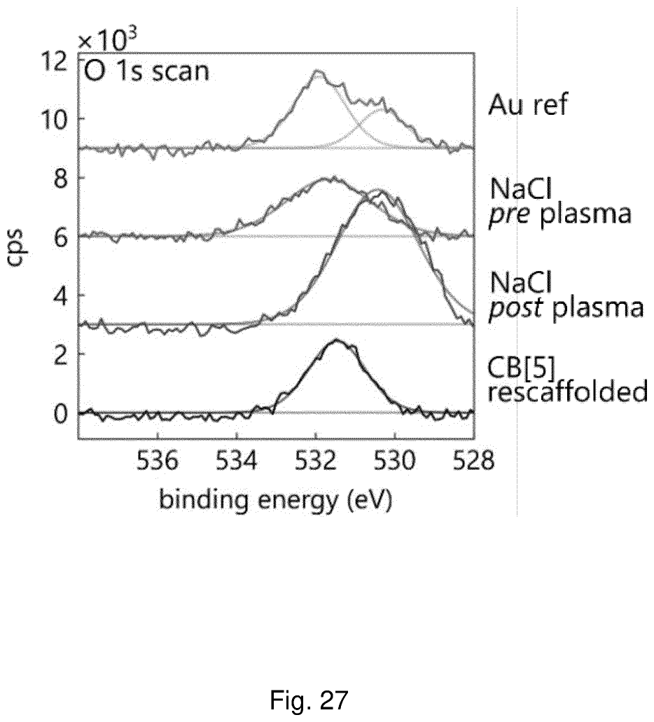

The subsequent oxidative cleaning step utilizes oxygen plasma cleaning of the nanoparticle layer (90% power, 30 sccm, 30 minutes) to fully remove all surface-bound molecules from the AuNP nanogaps. Surprisingly, the plasma-treated AuNP nanogaps remain stable and sintering is not initially observed (see darkfield in FIG. 8b). The SERS spectra (FIG. 7, centre) confirm this complete stripping of the surface-bound molecules, with all molecular vibrations now absent (see FIG. 24 and FIG. 25 for XPS spectra). Oxygen plasma cleaning introduces a few monolayers of gold oxide on the AuNP surfaces giving the broad peak[35] at v(Au—O)≃600 cm⁻¹ which is also clearly evident in XPS measurements (FIG. 26 and FIG. 27). The volume per Au atom doubles when forming the Au₂O₃ phase, implying that it expands into the gap until 3 surface layers are fully oxidised, which then plug the entire gap volume. The nanoparticle layer remains intact in this metastable state for many hours if kept at low temperature (<4° C.) and shielded from direct light. In aqueous solution, the nanoparticle layer maintains stability for several days.

In the final step, a scaffolding ligand is reintroduced to the oxidatively clean AuNP surfaces, by immersing the nanoparticle layer into an appropriate solution. The inventors successfully tested a wide range of small ligands (including L-cysteine, cysteamine, CB[5], CB[7], and others). It is shown that irrespective of the initial ligand L1, one can replace L1 with L2=CB[5] which has highly-advantageous scaffolding properties.

Three initial L1 surfactants (MUA, CB[5], NaCl) are employed as above, before immersing the layers in CB[5] solution (~1 mM). At pH7, several days are required for the CB[5] to penetrate all nanogaps because the gold oxide layer is inert. However at low pH, for example pH<3, using 1M HCl or H₂SO₄ which removes the gold oxide, CB[5] now binds within seconds to the gold nanoparticle surfaces. All three nanoparticle layers now show extremely clean CB[5] SERS spectra (FIG. 7, right) exhibiting only a small relative variance (hundred-fold smaller than before replacement). This confirms that the gap nano-architecture is now much more consistent after the oxidative cleaning and redefining steps, implying its reconstruction into a reliable geometry as well as the removal of unwanted molecules.

### Controlled Restructuring of Nanogaps

Due to the difficulty of quantitative and reliable transmission electron microscopy (TEM) characterisation of sub-nm-scale gaps, a more suitable tool for analysing these changes is darkfield (DF) spectroscopy. Spectra are collected over the same area across the three nanoparticle layers, both prior to oxygen plasma treatment and just after redefinition of the gap with CB[5] (FIG. 8). For each nanoparticle layer sample, histograms record the peak wavelength of the coupled plasmon mode, with the average darkfield spectra also shown. These peak wavelengths are determined by the gap sizes and the effective refractive index inside each nanogap.[36]

The DF spectra before plasma treatment for different initial ligands L1 are distinctively different in peak positions and distributions. The MUA layer (FIG. 8, left, “MUA”) exhibits the shortest wavelength plasmon (~740 nm) and widest peak distribution. As MUA molecules are longer and more flexible (in comparison to citrate and CB[5]), this confirms a larger average gap size which fluctuates more (estimated as 1.2±0.4 nm[37]). The CB[5] and citrate nanoparticle layers by contrast show a narrower peak distribution. The CB[5] peak is blue shifted (~780 nm) in comparison to the citrate-defined nanogaps (~800 nm), and assuming similar refractive indices, this difference suggest a smaller mean gap size for the citrate-defined nanoparticle layer (by 0.1 nm).

Despite these different initial gap sizes, after oxygen plasma treatment and redefining of the nanogaps with CB[5]/HCl, the same peak wavelength ~790 nm is now seen for all three nanoparticle layers. This implies that the gap sizes of all three layers are now almost identical, explaining why the SERS (FIG. 7, right) is so consistent. The MUA layer also gives a smaller extra peak ~735 nm after plasma treatment and redefining, suggesting that some larger gaps are also present although the SERS spectra (FIG. 7, right) show no sign of residual MUA molecules.

Additional experiments confirmed the stabilisation of nanogaps by various scaffolding ligands after oxygen plasma treatment. Molecules such as 3-mercaptopropionic acid (MPA), citrate, acetic acid, cysteamine, dopamine, paracetamol, ethanol, and methanol all give robust constructs. By contrast, molecules that do not typically bind to gold such as acetone and glucose do not act as stabilising agents.

### Surface Gold Atoms “Flowing” at Room Temperature

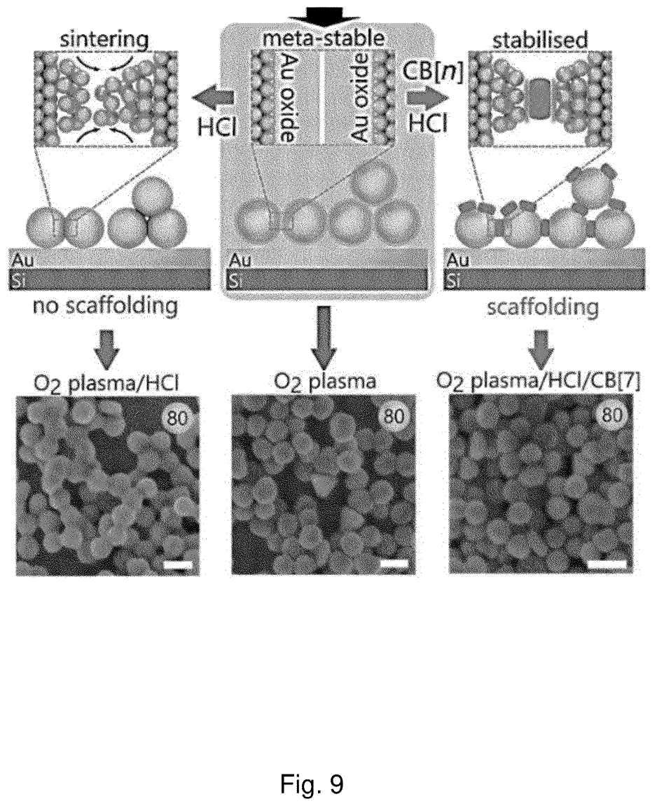

The DF and SERS data evidence atomistic restructuring of the gold surface inside the plasma-treated nanogaps, which makes it possible to redefine the nanogaps in a controlled way. After stripping surface-bound molecules from the gold nanoparticle surface during oxygen plasma treatment, an oxide coating is formed, stabilising the metastable state by plugging the nanogaps (FIG. 9, top centre). Even when immersed in CB[5] solution (pH7), the oxide coating protects against CB[5] binding inside the nanogaps with only very weak CB[5] SERS peaks emerging over several days.

Upon addition of small quantities of 0.5 M HCl (pH 0.3), the oxide groups undergo hydrolysis, which immediately destabilises the AuNP architecture. The inventors observe two pathways for this process: (1) if the nanoparticle layers are exposed to HCl in the absence of any scaffolding ligand, individual gold atoms inside the nanogaps flow towards adjacent AuNP facets (FIG. 9, top left) forming bridges between AuNPs and losing all SERS (within seconds). While AuNP sintering typically requires heating of the substrate to overcome the activation barrier for gold atom movement,[38-41] the chemical sintering process here occurs at room temperature. The inventors find that this process is irreversible—subsequent plasma treatment does not reactivate the nanoparticle layers. (2) Conversely, in the presence of a scaffolding ligand and HCl (FIG. 9, top right), the binding of the scaffolding ligand into the nanogaps effectively prevents the AuNPs from sintering. The inventors thus suggest that a key component of the present invention is the loss of oxide and the rescaffolding of the nanoparticles with the scaffolding ligand, that precisely reconstructs the nanogap and facets.

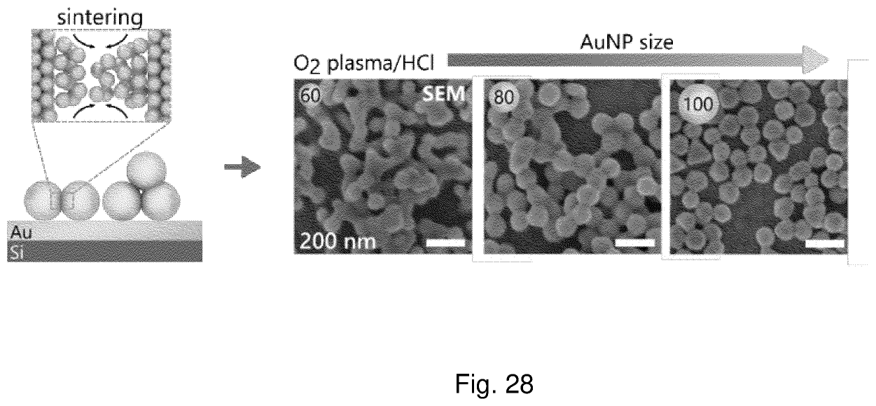

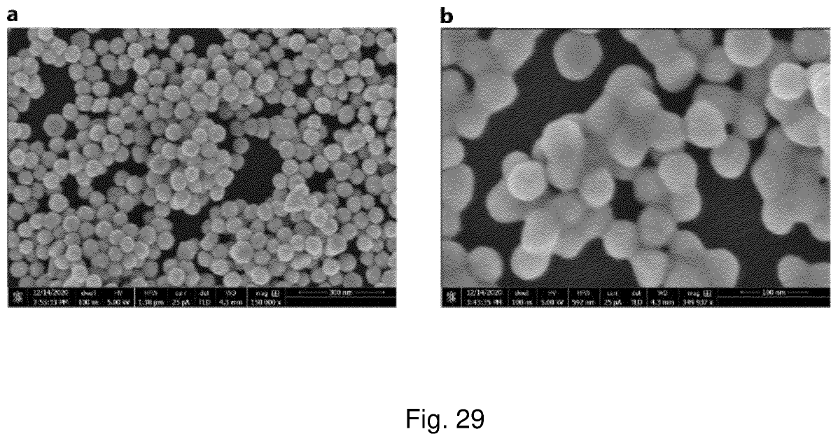

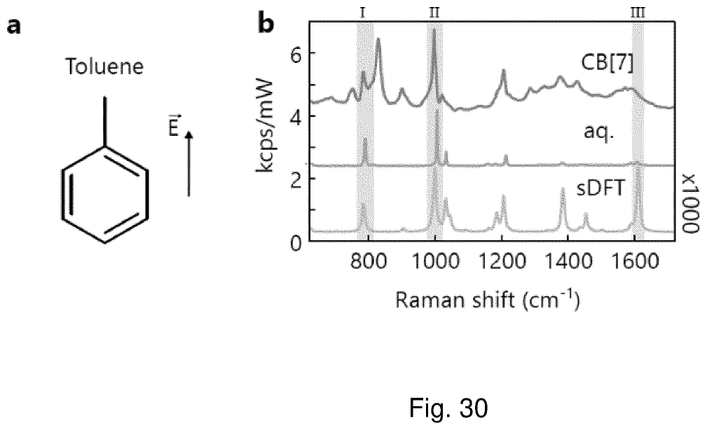

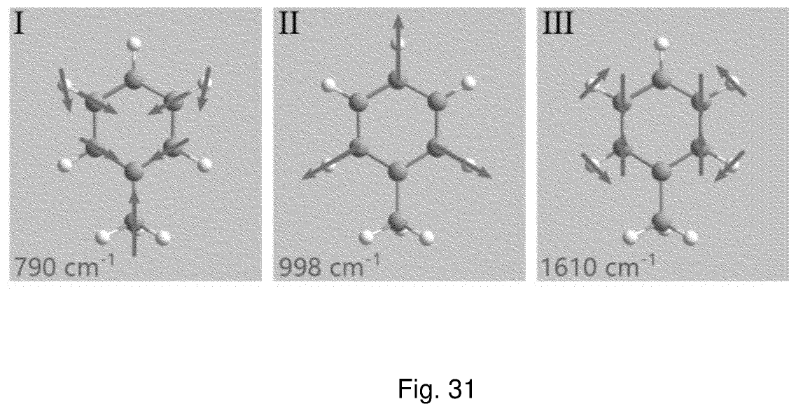

The results of the HCl-induced sintering for freshly plasma treated AuNPs can be observed in SEM images (FIG. 9, bottom left). These images clearly show that the gold atoms on facets of adjacent AuNPs flow towards each other, forming bridges. For larger AuNPs (diameter 100 nm) which have larger initial facets,[42] this sintering is less pronounced than for smaller AuNPs (80 and 60 nm; FIG. 28). Most important to note is that sintering neither occurs for non-plasma treated nanoparticle layers exposed to the same concentration of HCl (FIG. 29a) nor for the plasma and ligand/HCl treated nanoparticle layers (FIG. 9, bottom right). Repeating the sintering experiment with the same molar concentration of sulphuric acid instead of HCl leads to a similar outcome (FIG. 29b). The size dependence observed suggests that curvature can drive this process, in concert with liquid-solid surface energies.

### Nanoparticle Layers as Molecular Sensors

Plasma-treated nanoparticle layers open up wide opportunities for molecular sensing applications. Below, nanoparticle layers will be shown to offer improved spatial reproducibility after oxygen plasma cleaning in conjunction with full control over the scaffolding ligands, allowing for stripping off unwanted compounds from the metal surfaces (such as citrate). With CB[n] as the scaffolding ligand, the inventors find that substrates can be multiply reused by immersing them in 1M HCl solution.

### Liquid Sensing

To demonstrate these sensing and cleaning capabilities, the inventors, first show that toluene, a very hydrophobic and volatile compound can be detected down to concentrations below 10 ppm. In order to simplify handling and better control the toluene concentration, a range of different concentrations in aqueous solution is first detected. Despite its hydrophobicity, it is possible to obtain concentrations in water up to 5 mM which is sufficient to cover the desired range.

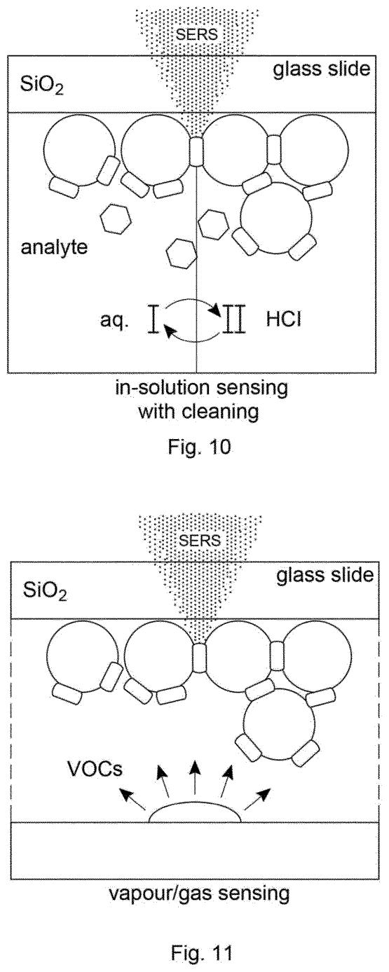

The experimental protocol (FIG. 10) cycles between (I) exposing a nanoparticle layer sample to toluene (20 minutes), and (II) subsequent cleaning with HCl followed by blow-drying with N₂. The nanoparticle layer used for this experiment is tethered to a thin glass slide, plasma cleaned and redefined with CB[7] molecules. The SERS signals are collected through the cover slip, which is a key advantage of these nanoparticle layers that combines simple optics with immersion in liquid or vapour cells.

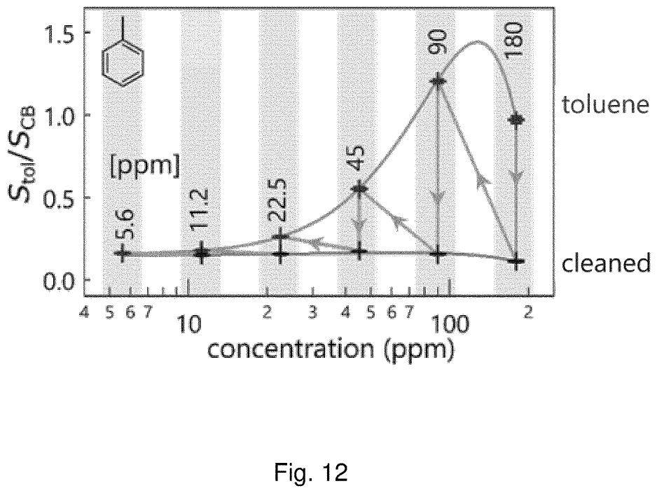

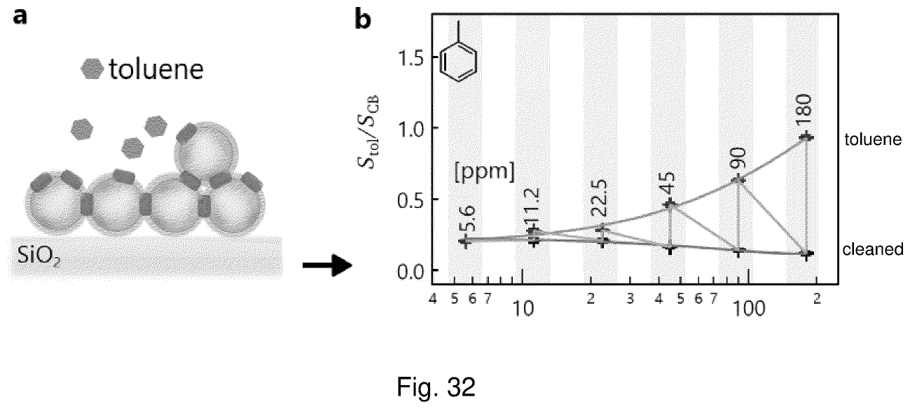

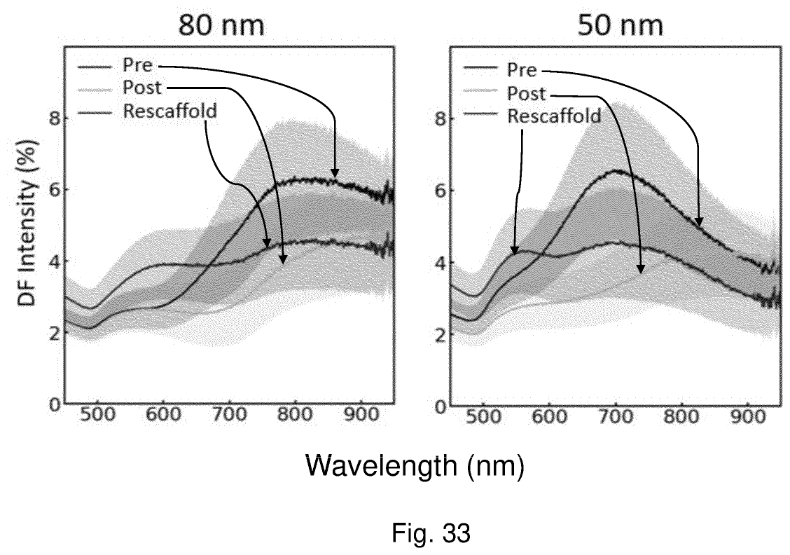

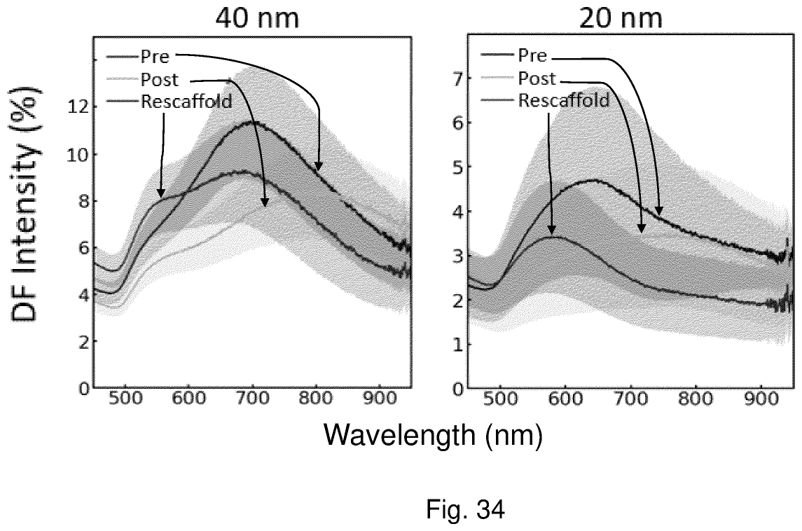

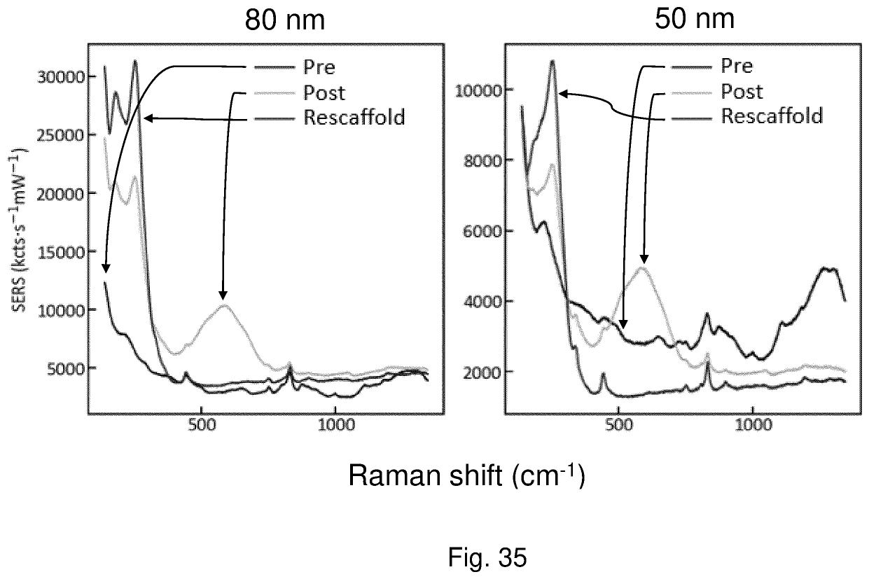

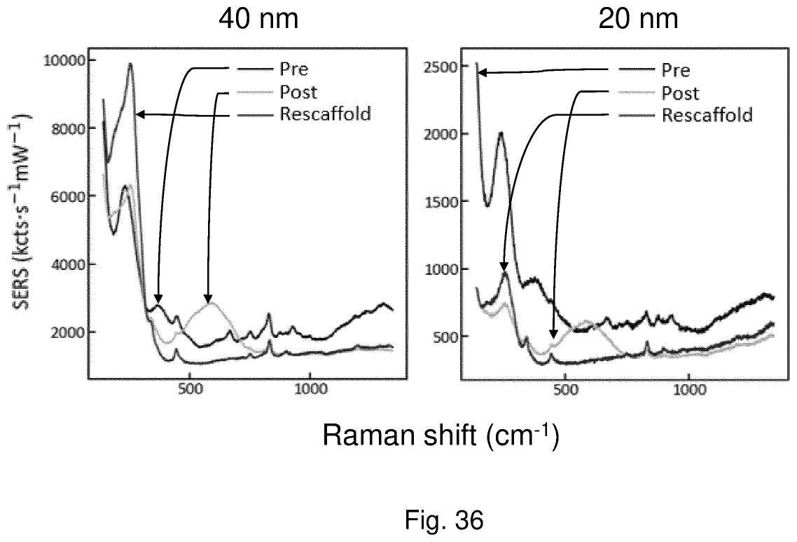

Extracting the ratio of the toluene ring-breathing mode (995 cm⁻¹) to the CB[7] signature peak (833 cm⁻¹) clearly demonstrates the cleanability with HCl as well as a detection limit below 11 ppm (FIG. 12). This is below the ACGIH 8-hour threshold limit of 20 ppm. It is important to stress that the same nanoparticle layer was used throughout this experiment starting with the highest (180 ppm) concentration of toluene. The small background signal ratio after each cleaning is nearly constant, increasing only after the first exposure, possibly due to slight restructuring of the gold. Surprisingly, the highest concentration does not produce the strongest response. This is likely because of dimerization of toluene inside the nanogaps at high concentration. For the non-plasma cleaned nanoparticle layers, this effect is not observed, and the detection limit is considerably worse (FIG. 32).

### Vapour Sensing

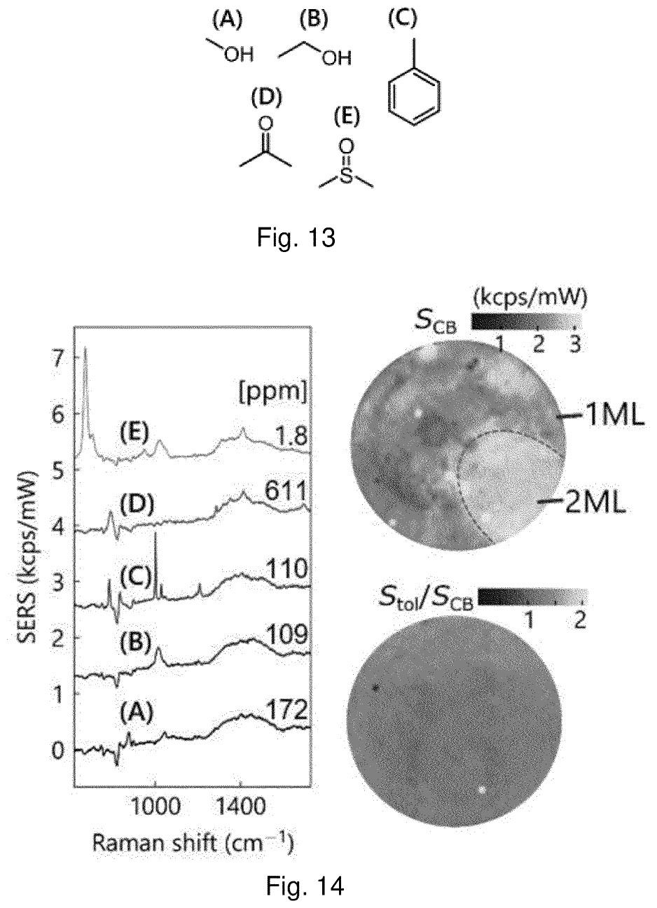

To demonstrate the sensitivity of the nanoparticle layers to a range of volatile compounds, layers are exposed to the vapours of five molecules (FIG. 11 and FIG. 13), again on plasma-cleaned and CB[7] redefined nanoparticle layers. Sensing is performed in a glass container sealed by the coverslip, which allows the vapour to build up and reach its saturation concentration (acetone 611 ppm, methanol 120 ppm, toluene 1.8 ppm, ethanol 172 ppm, DMSO 109 ppm). The background-subtracted SERS intensities (FIG. 14, left) confirm the capability for nanoparticle layers to detect methanol, ethanol, toluene, acetone and dimethyl sulfoxide (DMSO). Here CB[7] is employed as it has a large enough inner volume to trap each of these molecules. DMSO produces the strongest SERS signals at a very low saturation concentration of just 1.8 ppm, which is likely because DMSO interacts most strongly with the gold surface.[43]

The spatial distribution and repeatability of toluene vapour sensing inside the CB[7]-defined nanogaps on the nanoparticle layers is tracked through high resolution 50×50 μm SERS maps (FIG. 14, right). The CB[7] vibrational response clearly images the monolayer regions (weaker), bilayer regions (stronger), and mixed monolayer and bilayer regions on the nanoparticle layers. Essentially this maps the number of nanogaps under the laser spot, which thus can be used as a normalisation signal. Comparing the toluene signal normalised to CB[7] (FIG. 14, bottom right) reveals a much more homogeneous response, independent of the number of layers in the nanoparticle layer or gap density. This suggests that toluene vapour penetrates equally deeply into the nanogaps of both layers of the nanoparticle layer when it is a bilayer. Quantitative measurements thus can reliably use the normalisation to CB[7] vibrational components to calibrate detected signals. To ascertain the ultimate limits of detection of VOCs for nanoparticle layers requires systematic experiments to examine the optimum scaffolding ligand L2 for each analyte. However, the repeatable and sensitive performance for VOC sensing suggests their future utility.

### Flow Sensing and Cleaning

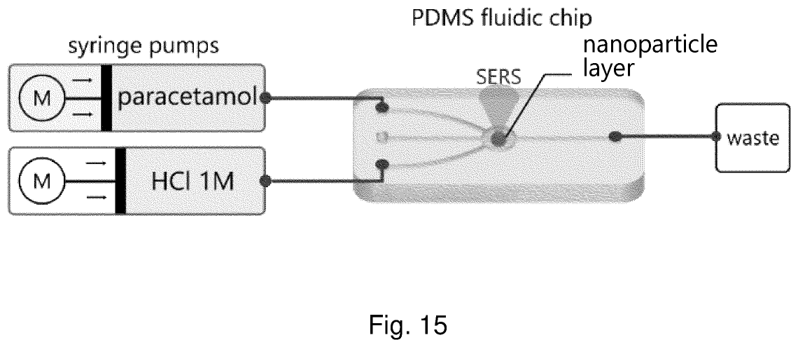

A further application of the nanoparticle layers of the present invention is their direct integration into flow cells for in-flow sensing of analytes (FIG. 15).c As for the liquid and vapour sensing, nanoparticle layers are tethered to a glass coverslip (coated with a 5 nm Cr layer to increase adhesion, see Gold Nanoparticle SERS Substrates—Detailed Methods) and plasma-bonded to PDMS fluidic chips. Again, the nanoparticle layers are plasma cleaned and redefined with CB[7]. Analyte flow ~10 μL/s is initiated and controlled by two syringe pumps which are connected to the PDMS chip. The SERS pump laser is incident through the cover slip with light collected along the same path, straightforwardly separating optics and fluidics.

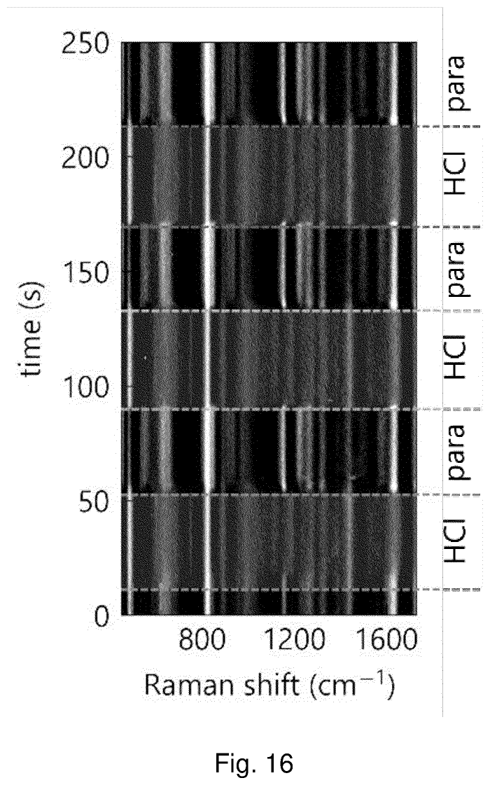

With this flow-cell, the inventors investigate kinetics of analyte sequestration and cleaning of the nanogaps. This is demonstrated in flow by switching the liquid flowing over the nanoparticle layers between a selected analyte and HCl for cleaning. Here as our analyte we choose paracetamol. During this experiment, the cleaning cycle with HCl for 20 s is followed by flowing paracetamol (1.5 mM) for another 20 s. The resulting kinetic SERS scan using 0.5 s integration times clearly resolves the switching between the flowing paracetamol and HCl (FIG. 16). We find tens of cycles of cleaning and sensing retain consistent signals.

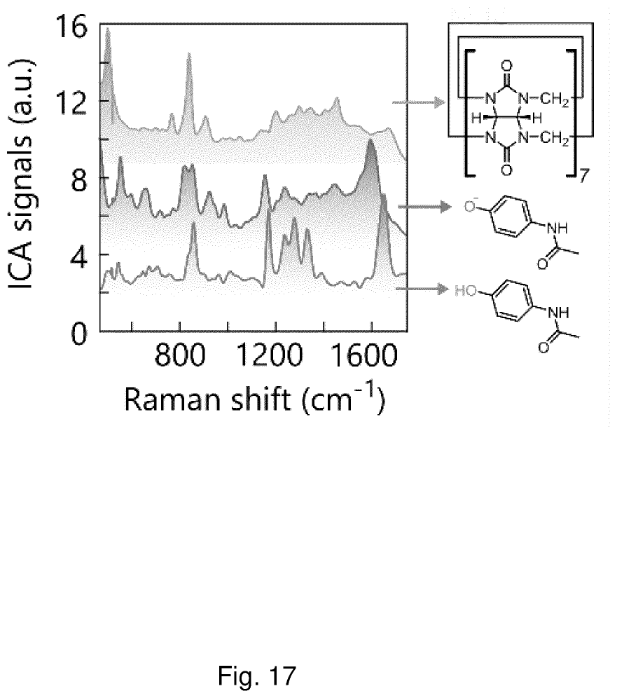

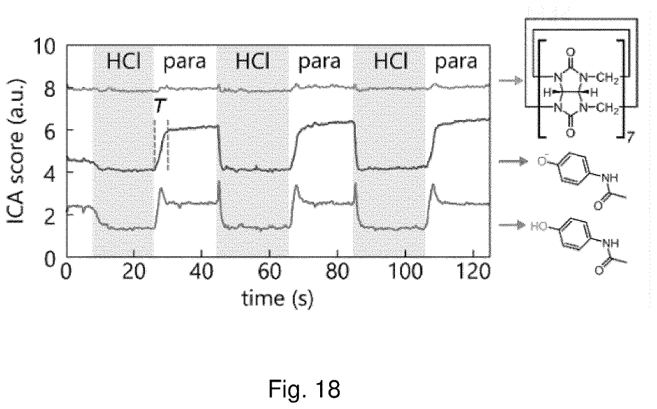

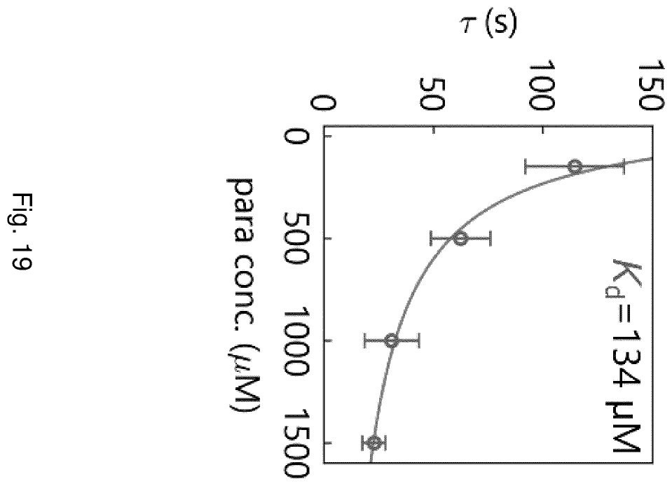

Extracting different component spectra from such dynamic measurements is ideally suited to independent component analysis (ICA) which retrieves three independent spectra (FIG. 17) (see Gold Nanoparticle SERS Substrates—Detailed Methods). These spectra resemble CB[7] and paracetamol. The latter shows two different spectra which are related to its protonated and deprotonated states (from density functional theory simulations). The corresponding time-dependent ICA scores (FIG. 18) reveal that cleaning with HCl occurs within a few seconds and is fully repeatable between cycles. Furthermore, it is evident that the time-dependent sequestration of paracetamol into the sensing gaps follows an exponential function (FIG. 19), which matches a simple theoretical model based on Langmuir isotherms. This confirms that equilibrium can be obtained in the simple and open layered nanoparticle geometry despite the small gap sizes used to obtain intense SERS for sensing.

Surprisingly, the protonated paracetamol profile exhibits sharp spikes just after the paracetamol flow commences as well as when the HCl flow is initiated. During the transition from HCl to paracetamol, a significant fraction of protonated paracetamol enters the nanogaps. The protonation occurs because of acid back-flow into the paracetamol-carrying tubing during the HCl flow. As more paracetamol flows over the nanoparticle layer, the pH recovers to equilibrium, resulting in a fixed protonated to deprotonated signal ratio. During the transition from paracetamol to HCl, the acid flow first protonates the paracetamol inside the nanogaps before it is released, leading to the second observed spike. This clearly demonstrates that protonation is faster than the removal of paracetamol from the nanogaps, as expected from the diffusion rate dependence based on proton to paracetamol molecular weights. This rapid SERS flow sensing device is therefore very promising for distinguishing a wide range of small-molecule analytes.

The above demonstrates that nanoparticle layers composed of random close-packed layers of one (or several) layers of gold nanoparticles offer a sensing platform with excellent optical and fluidic access. The inventors show here that their nanogap chemistry can be controlled far more carefully than previously, which is vital for real sensing applications. Treating the layers with an oxygen plasma strips all organic compounds off the surface whilst leaving the gold facets intact. The oxide layer remaining on the surface protects and stabilises the nanoparticles from sintering. If removed by acid without any ligands present, gold atoms flow between opposite facets forming bridges that destroy the sensing properties. However, in the presence of a ligand, the gold facets restructure to accommodate these new scaffolds inside the nanogaps, modifying the local chemical environment. Even with initially non-uniform nanogaps defined by various molecules, it is possible to successfully incorporate CB[5] molecules into the nanogaps after oxygen plasma and acid treatment. The newly redefined layers now deliver highly reproducible SERS spectra with robust and precise gaps (as for solution aggregation, but now attached to a solid support).

This facile protocol gives a reconfigurable and sensitive SERS substrate with excellent sensing capability for compounds in solution (such as toluene) and vapours. Cleaning of the nanoparticle layers between sensing cycles is achieved by flowing HCl over them. Plasma-treated CB[7] nanoparticle layers detect many volatile organic compounds including DMSO, toluene, acetone, methanol and ethanol. VOCs penetrate both layers of a bilayer nanoparticle layer giving a calibrated analyte response using normalisation by CB[7] signals. The nanoparticle layers are shown to be exceptionally suitable for integration into flow cells due to backside optical access, and demonstrate repeatable sensing and cleaning cycles. This work thus offers the prospect for continuous monitoring in many applications, such as water quality, urine or saliva sensing, spanning from environmental to healthcare monitoring.

### Gold Nanoparticle SERS Substrates—Detailed Methods

### Nanoparticle Layer Preparation

Equal volumes (500 μL) of chloroform (CHCl₃) and commercial AuNPs are added to a standard 2 mL centrifuge tube (Eppendorf) forming a two-phase system with the AuNP suspension floating on top of the chloroform phase. The AuNP size is 80 nm for SERS measurements at 785 nm excitation if not otherwise noted. For the aggregation step using CB[n], 5 μL of a ~1 mM CB[n] solution is mixed with the AuNP phase. For NaCl aggregation, a higher volume of 150 μL of a 0.5 mM NaCl solution is added. Aggregation using 11-mercaptoundecanoic acid (MUA) is achieved through saturating the chloroform phase with MUA followed by vigorous shaking of the centrifuge tube. By this method it is possible to aggregate AuNPs with molecules which are not soluble in water but in chloroform (such as MUA).

After vigorous shaking of the AuNP/chloroform system, the goal is to remove ~80% of the supernatant of the freshly aggregated AuNP via careful pipetting. This step is followed by replenishing the centrifuge tube with DI water. Replacing the supernatant and with DI water is repeated three times to remove large aggregates and to reduce salt concentration significantly. During this process, a monolayer of AuNP is formed between the liquid-air and liquid-chloroform interfaces (extending up the inside walls of the centrifuge tube). Lastly, as much as possible supernatant is removed (>80%) to concentrate the AuNP monolayers into a small droplet (1-5 μL). This droplet is then transferred onto a support such as a gold-coated Si-wafer or a coverslip (for flow and vapour sensing experiments). The droplet is left to dry for several hours.

Once dry, excess salt is removed by gentle rinsing with DI water followed by blow-drying with N₂. Plasma treatment is performed with a commercial oxygen plasma cleaner (Diener electronic GmbH+Co. KG) for 30 min at an oxygen mass flow of 30 sccm at 90% RF power for 30 min. CB[n]-redefinition is achieved by firstly drop-casting a CB[n] solution (~20-50 μL, 1 mM) onto the nanoparticle layers, then, adding a small amount (1-5 μL) of HCl (1M) to the CB[n] droplet. After 10 min, the nanoparticle layers are rinsed with DI water and finally carefully blow-dried.

### Darkfield and SERS Measurements

SERS spectra are taken on a commercial Raman instrument (Renishaw inVia) at 785 nm excitation (laser line profile) using a 20× objective at ~150 μW of laser power (0.1% setting) to avoid damage to the nanoparticle layers. MUA, CB[5], and NaCl high-resolution maps are recorded using supplied Renishaw software.

For map scans, nanoparticle layers are deposited onto one large gold-coated coverslip (with 5 nm chromium adhesion layer) each resulting in 2-4 mm diameter layers. SERS spectra are taken with a 200 μm grid size (10-20 rows and columns, depending on layer diameter) exposing the sample for 1 s per spectrum.

Darkfield reflection spectra are taken on a custom microscope setup consisting of an Olympus BX51, a 20× Zeiss objective and an Ocean Optics QE-Pro spectrometer (0.5 s integration time). All spectra are referenced to a white scatterer (Labsphere). Grid size is consistent with SERS measurements (200 μm). To obtain alignment between SERS and darkfield spectra, the substrates are spatially referenced.

SEM measurements

Nanoparticle layer samples are prepared according to the standard protocol (see Nanoparticle layer preparation) and deposited on Au-coated silicon wafer which are cut into small pieces. SEM measurements are taken on a FEI Philips Dualbeam Quanta 3D device (dwell=100 ns, HV=5 kV, curr=25 pA and WD ~4 mm). Magnification is varied between 150 k, 200 k and 250 k.

### Vapour Sensing Experiments

A droplet of the volatile compound (~50 μL) is pipetted inside a ~5 mL glass vial whose finish and neck (inside and outside the vial) is wrapped with a single layer of ‘Parafilm M’). The CB[n]-redefined nanoparticle layer deposited on a thin borosilicate coverslip is then placed on top on the class vial with the nanoparticle layer facing the inside of the vial. To seal the setup, the coverslip is gently pressed against the ‘Parafilm’ lined finish. To give sufficient time for the saturation concentration to build up, the setup is left for around 20 min before a SERS measurement is taken. SERS spectra taken through the coverslip. During the experiments, the droplets have never fully evaporated indicating that there is sufficient analyte available to build up the saturation concentration without knowing the exact volume.

### Liquid Sensing Experiments

Aqueous toluene sensing is performed in a similar fashion to vapour sensing; the CB[7]-redefined nanoparticle layer is again deposited on a thin borosilicate coverslip followed by placing it on a droplet of a toluene solution for 20 min (±10 s) after which a SERS spectrum is taken immediately. For the experiment, only one layer is used which is recycled between measurements by HCl treatment, rinsing with water as well as N₂ blow-drying. The experiment starts with the highest toluene concentration and moves to lower concentrations after each cycle.

### Flow Sensing Experiments

The paracetamol/HCl sensing and cleaning experiments are carried out on a nanoparticle layer deposited on a coverslip. The nanoparticle layers are prepared according to the standard protocol but redefined with CB[7] molecules instead of CB[5]. The layers on the coverslip are then plasma bonded with a PDMS chip (layers facing inside channels of the chip) by a short exposure (a few seconds) to oxygen plasma. Briefly, the PDMS chip is manufactured by standard soft lithography from a template master mould. For the process, the SU-8 2100 negative photoresist is spin-coated evenly onto a silicon wafer to yield a layer height of ~150 μm. After additional baking and exposure to UV light (through photomask), the photoresist is developed by immersing the wafer into PGMEA (1-methoxy-2-propanol acetate) and then hard baked. A PDMS kit (SYLGARD 184, Sigma-Aldrich) with a mixing ratio of 1:10 (curing agent to PDMS monomer base) is used to manufacture the chips (Baked for 30 min at 120° C. after degassing). For flow experiments, two inlets and one outlet are punched (1 mm diameter) into the PDMS chip. The inlets are connected to custom-made syringe pumps containing HCl (1 M) and the paracetamol (1.5 mM) solutions. Kinetic SERS measurements are taken through a 63× (numerical aperture, NA=1.2) water-immersion objective with 0.5 s integration time. The liquid flow is cycled between paracetamol and HCl for 20 s each.[44]

### Additional Information

TABLE 1
Calculated saturation concentrations of five volatile compounds

| sVOC | P/Pa~20′C. | c/mM | c/ppm |
|---|---|---|---|
| Acetone | 25544 | 10.52 | 610.8 |
| MeOH | 2889.7 | 1.19 | 119.6 |
| Toluene | 55.6 | 0.023 | 1.8 |
| EtOH | 13010.9 | 5.36 | 171.6 |
| DMSO | 5726 | 2.36 | 108.6 |

For the plasma-cleaned films in FIG. 12, the highest concentration (180 ppm) shows the toluene peak in a different spectral position (and in the same position as pure toluene). At lower concentrations, the peak is slightly shifted to lower wavenumber, as known for toluene interactions with water. The loss of signal at high concentrations thus likely comes from its dimerization and thus weaker SERS cross section.

The dark-field spectral peak positions of the nanoparticle layer fractal modes are closely related to the plasmons on a 1D chain. Their resonance wavelength can thus be estimated through an electrical coupling model (which resembles a tight-binding interaction model), giving

$${ω}^{2} = {ω}_{0}^{2} - 2 {c}^{2} cos ( \frac{π}{N + 1} )$$

for N coupled nanoparticles (NPs), isolated plasmon frequency ω₀, and coupling c. This allows the chain resonance to be directly related to the dimer mode resonance.

A simple estimate to compare the dimer with the nanoparticle-on-mirror mode (which inserts a ground plane (i.e. mirror) halfway between the two NPs of the dimer) uses the factor of two scaling between their coupling capacitance.

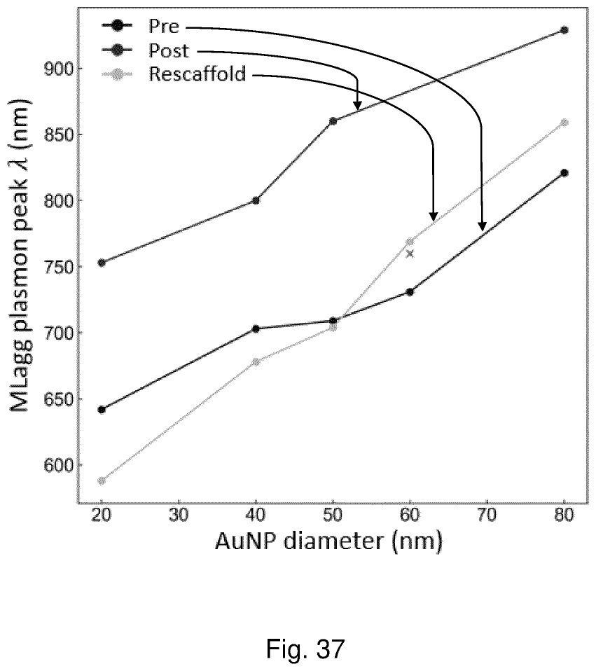

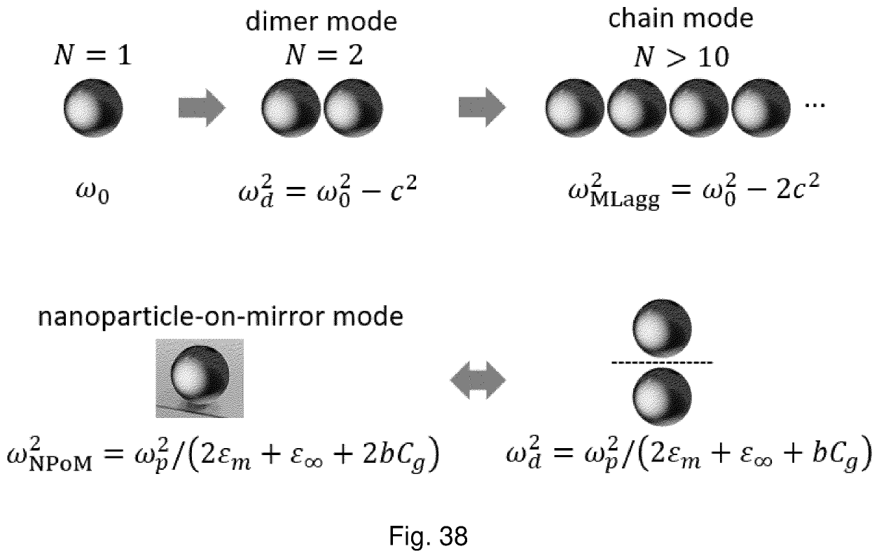

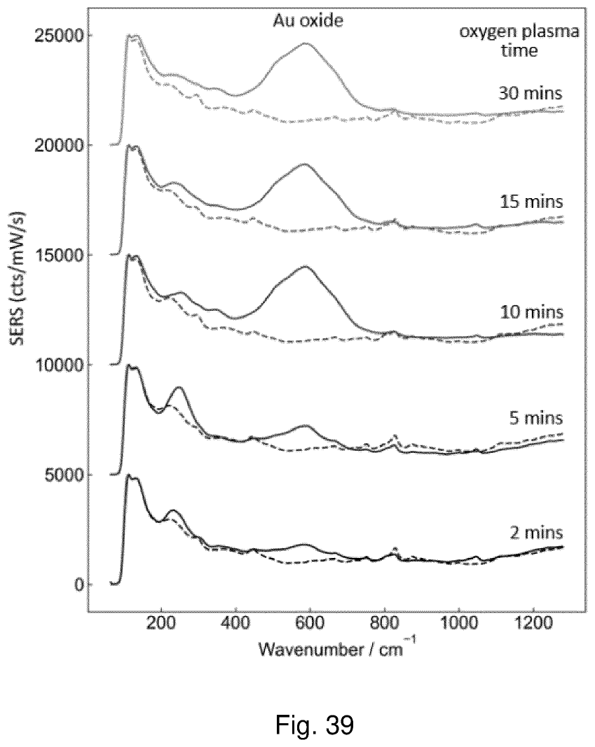

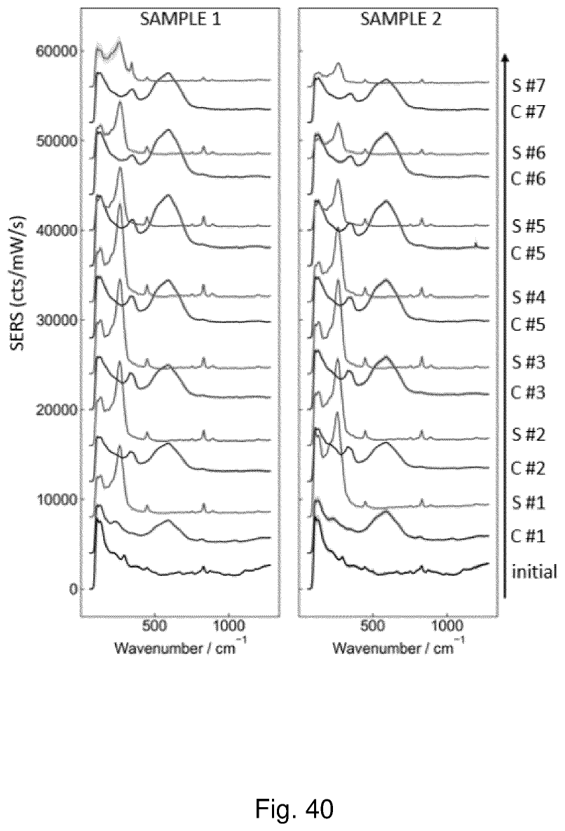

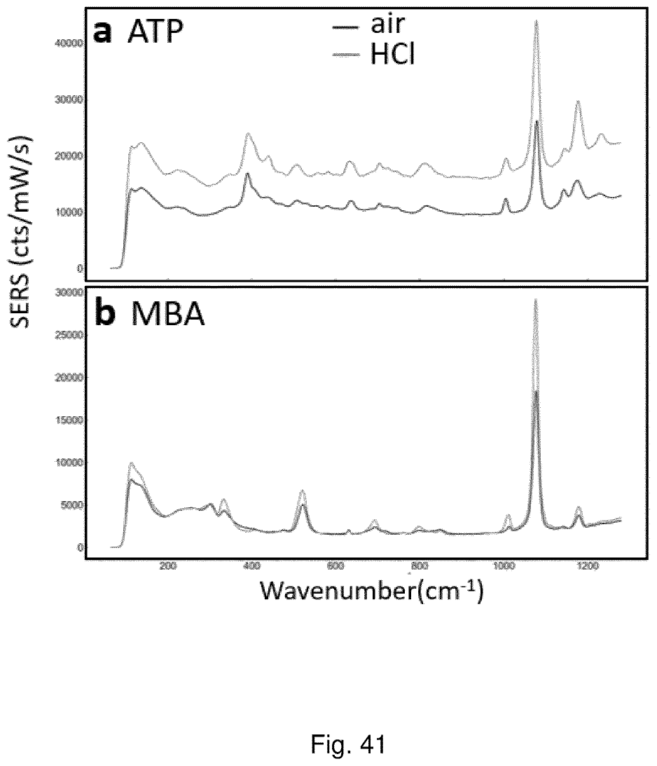

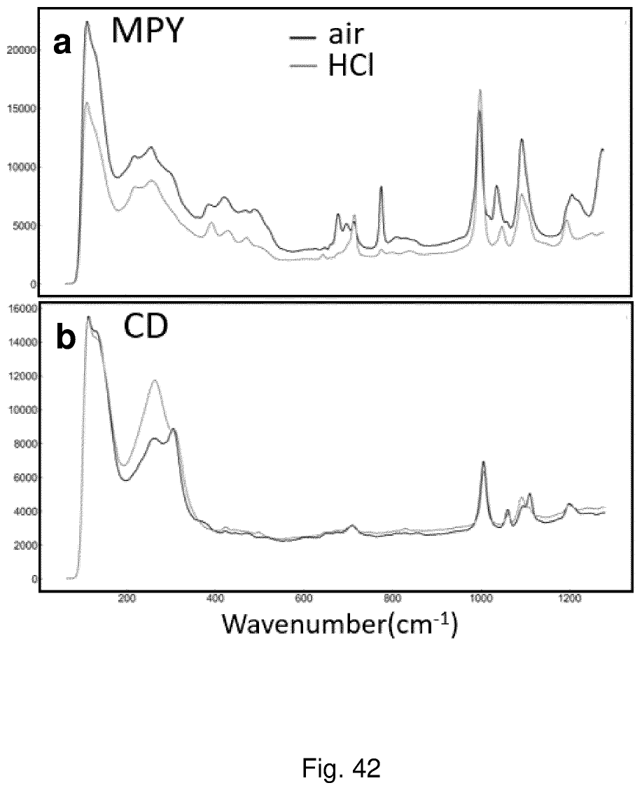

Combining these gives the NpoM resonance in terms of the nanoparticle layer resonance as

$${λ}_{NpoM} = \sqrt{4 {( {λ}_{Mlagg}^{- 2} + {λ}_{0}^{- 2} )}^{- 1} - {λ}_{p}^{2} ( 2 {ε}_{m} + {ε}_{∞} )}$$

where λₚ~135 nm is the Au plasma frequency, εₘ=1 is the dielectric permittivity of the surrounding medium, ε_{∞}~8 is the short-wavelength Drude permittivity of Au, and λ₀~520 nm is the plasmon resonance of the Au NPs. Using the known dependence of the NpoM resonance on NP diameter, facet size (~20% of diameter), NP gap refractive index n_{g}, and gap size d allows the latter two values to be estimated (see [37] and https://www.np.phy.cam.ac.uk/npom-calculator [accessed 30 Mar. 2023]). Using the data in FIG. 37, suggests that for CB-spanned gaps, d~0.9 nm and n_{g}~1.1 (as expected for a non-polar molecule). When they are oxidised, the significant red-shift is consistent with the expected refractive index of Au₂O₃ n_{g}~1.8 and compatible with the doubled gap size of d~1.8 nm.

### Sensitised Gold Nanoparticle SERS Substrates

The inventors have found that sensing of neurotransmitters down to nM concentrations is possible by utilising self-assembled nanoparticle layers of 60 nm gold nanoparticles in close-packed arrays immobilised onto glass supports. Multiplicative SERS enhancements are achieved by integrating Fe(III) sensitization into the precisely-defined <1 nm nanogaps, targeted for dopamine sensing. The transparent glass supports allow for efficient access from both sides of the nanoparticle layers by fluid and by light, allowing repeated sensing in different analytes. Repeated reusability after analyte sensing is shown through oxygen plasma oxidative cleaning and redefinition which restore pristine conditions for the nanogaps. Examining binding competition in multiplexed sensing of two catecholamine neurotransmitters, dopamine and epinephrine, reveals their bidentate binding and interactions. These systems are promising for widespread microfluidic integration enabling a wide range of continuous biofluid monitoring for applications in personalised medicine.

Continuous monitoring, diagnostic devices, and precision health have become of significant societal interest but require improved detection of meaningful target biomarkers. Neurotransmitters are key biomarkers since they control an array of biological and physiological processes as chemical messengers that transmit electrochemical signals.[50, 51] An imbalance or dysregulation of particular neurotransmitters such as dopamine (DA) is linked to diverse neurological and psychiatric disorders such as Parkinson's disease,[52] schizophrenia,[53] Alzheimer's, depression[54] and attention deficit-hyperactivity disorder (ADHD).[52] DA also influences cognitive behaviour including mood, concentration, and motivation, as well as metabolism and functions of the immune system.[55, 56]

To understand the intricate changes in neurochemistry as well as a holistic understanding of the influence of DA in physiological processes, a highly sensitive, selective and accurate quantitative sensing platform that can be used frequently with nanomolar levels of detection is required.[57] Several conventional techniques to detect neurotransmitters include the classic electrophysiological methods by measuring the changes in membrane currents,[57, 58] or more technically-demanding high-performance liquid chromatography, mass spectrometry,[59] fluorescence detection, ELISA,[50] capillary electrophoresis[60] and microdialysis.[51, 61] Nonetheless, all techniques face the same fundamental challenges which are imposed by the inherently low concentration of neurotransmitters in biofluids, by the chemical structural similarities between different neurotransmitters decreasing selectivity, and by the resulting very restricted sampling intervals.[62] Furthermore, these conventional techniques are all limited by long operation times, large sample volumes, requirements for bulky instrumentation, labour-intensive operation, and need for highly trained personnel, which are all costly.[50, 63]

To move towards innovating the next generation of personalised point-of-care medical sensors, key challenges must be tackled including integration, improved sensitivity of analytes, reproducibility, reusability, and multiplexed sensing. A promising and emerging technique addressing these challenges is based on optical sensing using surface-enhanced Raman spectroscopy (SERS). SERS exploits the plasmonic properties of metal nanostructures where light couples to collective electron oscillations (plasmons) in the metal. These plasmons allow optical fields to be focused below the diffraction limit, down to dimensions approaching molecular length scales.[64] The spatially-localised optical fields known as hotspots are typically formed in gaps or at the edges of self-assembled nanostructures.[65, 66] The resulting plasmonic field greatly enhance impinging light as well as its consequent Raman scattering from molecules. The signature vibrational SERS fingerprints recorded from different molecules (which do not need analyte labelling) enable multiplexing, and its exceptional sensitivity down to real-time single molecule specificity[67-69, 30] has the potential to deliver a low-cost solution to bioanalyte sensing. However, suitable flow-based reusable and reproducible SERS platforms have been challenging to deliver. At the same time, a detailed understanding of the SERS sensing process has been hindered by the lack of precise knowledge about molecular binding, surface chemistries, nanoscale geometries and their interplay.

### SERS Platform

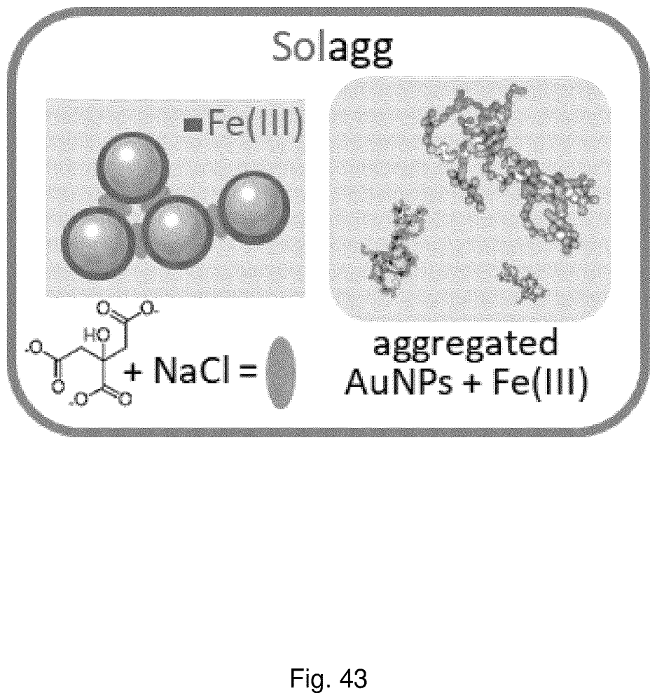

Herein described is a versatile SERS platform and its use for quantifying catecholamine neurotransmitters, which reveals analyte binding, competition, and attains effective reusability. While signal enhancements are relatively easy to obtain with SERS substrates, detailed control of the precise hotspot geometry is mostly lacking, leading to irreproducible/unpredictable signals when anything other than simple thiolated targets or dyes are used. When self-assembled Au nanoparticles (AuNPs) are optimally aggregated to form nanogap hotspots, these deliver archetypal substrates due to their reproducibility, ease of fabrication, scalability, low-cost, and accuracy (FIGS. 43, 44, 45 and 46).[70] However aggregating AuNPs in solution (‘Solagg’, FIG. 43) using a gap-defining molecule or salt as the coagulant, yields suspended SERS-active substrates which experience Brownian motion requiring large focal volumes to allow averaging of SERS signals, interference from aggregating agents, and restricts any scope for reusing or cleaning the system. In addition, the difficulty of controlling the number of active nanogaps compared to the bulk analyte concentration restricts detection limits.

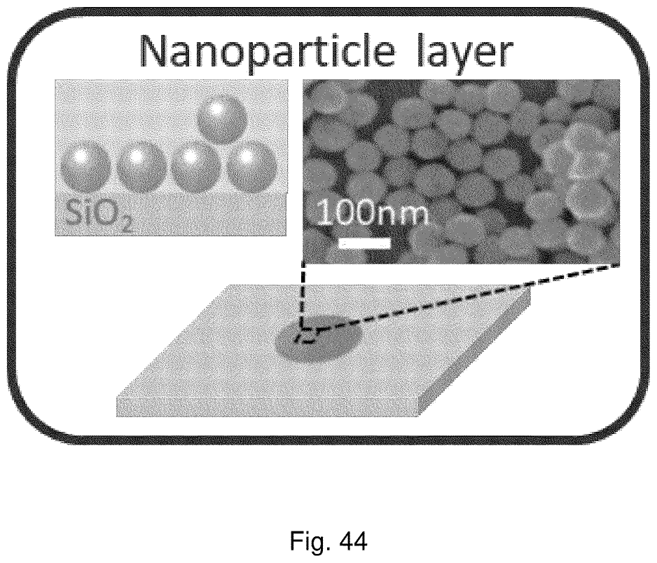

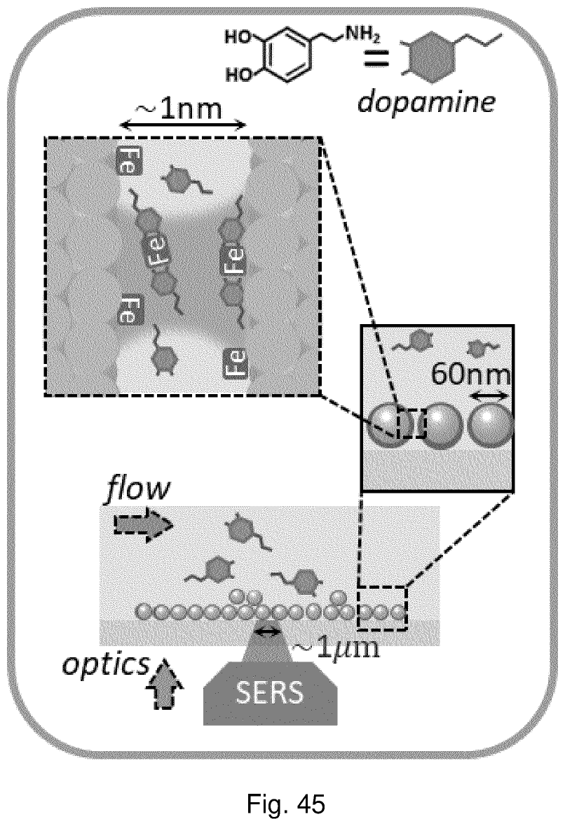

Herein, the inventors aggregate AuNPs into two-dimensional random close-packed arrays, immobilising them onto a substrate which fixes the nanogap positions and spacings for further treatment. These nanoparticle layer (FIG. 44) can be reliably formed through liquid-liquid interface assembly,[71] and transferred to any desired substrate (here Raman-grade glass). The resulting low-tortuosity molecular access into the nanogaps gives effective analyte access from fluids, vapours, or gases flowing over the nanoparticle layers. At the same time, light directly probes the same nanogaps from the opposite side (FIG. 45), giving a favourable device geometry (compared to for instance optically-opaque electrochemical-roughened Ag, or colloidally-sedimented nanoparticles). Another key hallmark of employing nanogaps immobilised as a layer on a substrate is the ability to clean and reuse them, which is optimal for applications of such sensors in point-of-care technologies. Both acid (HCl) and oxygen plasma treatments are found here to thoroughly clean all organic molecules off the nanogap surfaces to reinstate pristine surface chemistry.[72, 73] This greatly helps to maintain the consistency and reproducibility of the sensor performance and removes all potential interfering aggregating agents as well as capping agents such as citrate.[34] Finally, substrate-immobilised nanogaps can be integrated into microfluidic systems, for instance for monitoring fractionation, or as a SES substrate suitable for in-situ cleaning and calibration against standards for quantification.

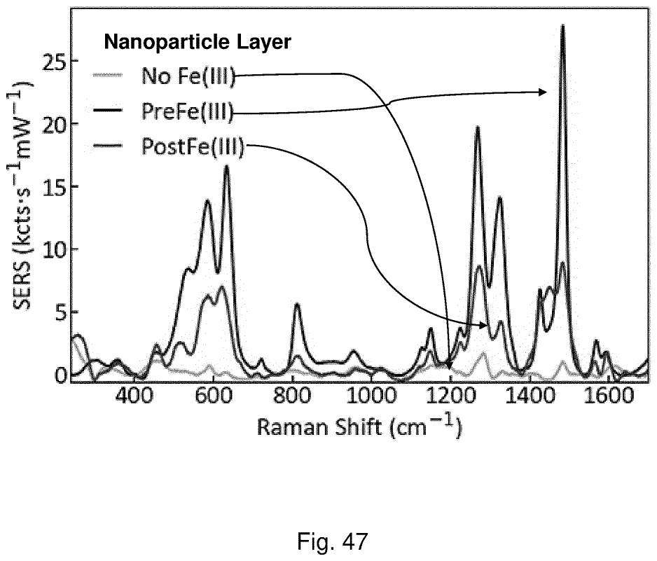

However, the affinity of neurotransmitters (NTs) for such SES substrates is too low for nanoparticle layers to facilitate NT sensing at clinically relevant concentrations (FIG. 47, ‘No Fe’), which this work addresses. By utilising the nanoparticle layers, the inventors outline how NT sensing can be optimised by exploiting the complexation of Fe(III) and catecholamines[74-79] to demonstrate nanomolar sensitivity. The inventors find the nanoparticle layers outperform the Solagg colloids by a factor of 5000 in terms of SERS intensity, and implement a cleaning treatment for repeated flow sensing through plasma cleaning protocols with good repeatability. The inventors elucidate factors that play key roles in the surface chemistry of analyte binding which influences quantitative measurements. Finally, the inventors explore competitive binding mechanisms and vibrational coupling between different NTs (dopamine (DA), epinephrine (EPI)) for multiplexed sensing.

### Results

### Fe(III) Sensitisation in Nanoparticle Layers

Recent work has demonstrated Solaggs can be sensitised more specifically to catecholamine NTs by incorporating Fe(III) ions into the SERS substrate.[79] It is believed that Fe(III) attaches to the Au surface and then binds NTs into the hotspots. Two protocols for introducing Fe(III) were explored, either where Fe(III) is introduced simultaneously with DA after the AuNP aggregation process (PostFe), or by prior incubation of the AuNP constituents with Fe(III) solution before the AuNP aggregation (PreFe). Herein it is showed that the presence of Fe(III) is crucial for detecting NTs, and that the PreFe protocol gives the best results, allowing nanomolar NT detection. It suggests that individual NTs diffuse more readily into the nanogaps (compared to first forming the larger Fe complex), where they then bind to surface-bound Fe(III).

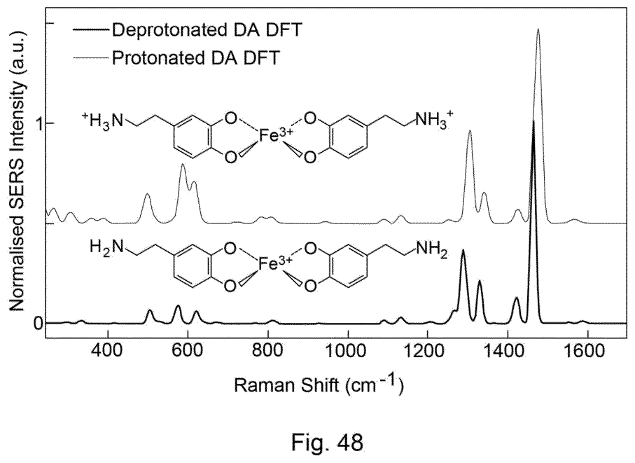

The same protocols are now applied to nanoparticle layers, with an additional initial precleaning process using plasma (see Sensitised Gold Nanoparticle SERS Substrates—Detailed Methods). The PreFe protocol is found to be three times more sensitive than PostFe, with a 30-fold increase over no Fe(III) sensitisation (FIG. 47). This confirms that nanoparticle layers behave similarly to Solaggs seen before.[79] For both PreFe and PostFe sensing, DA peaks are observed at 812, 1269, 1324, 1425, and 1482 cm⁻¹ which can be assigned to the well-documented iron catechol complex of DA[74, 75, 77, 80-83] and matches with density functional theory (DFT) calculations regardless of the NT protonation state (FIG. 48).

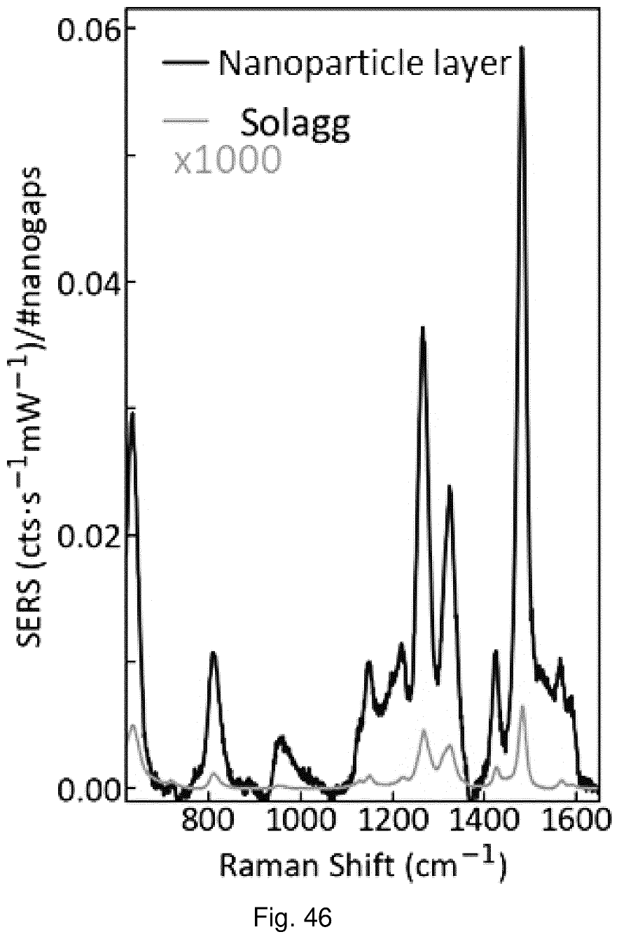

Furthermore, comparing the sensitised nanoparticle layers with the sensitised Solagg (FIG. 46), the inventors find that when normalizing for power, time, and the number of hotspots, five thousand times stronger signals for the nanoparticle layer system is achieved per hotspot. This shows that the PreFe nanoparticle layer system provides the highest SERS response out of these protocols and is used here for the remaining characterisation and optimisation. This also permits lower laser power excitation (<1 mW) allowing cheaper and safer laser products to be implemented (such as Class 2 lasers), aiding the transition to miniaturised technology.

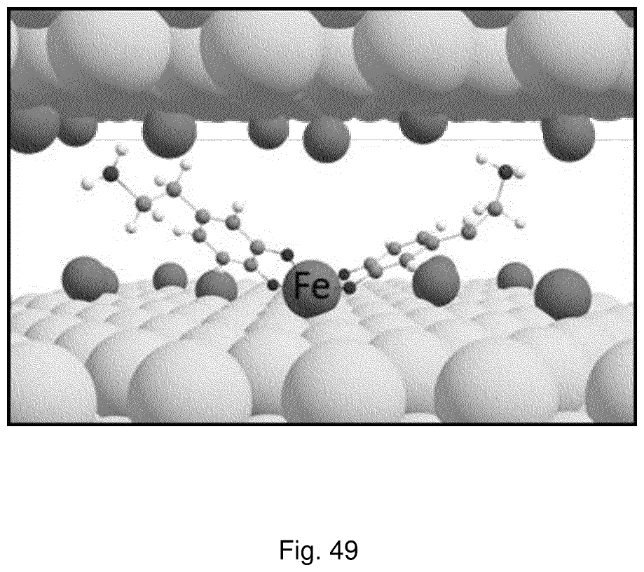

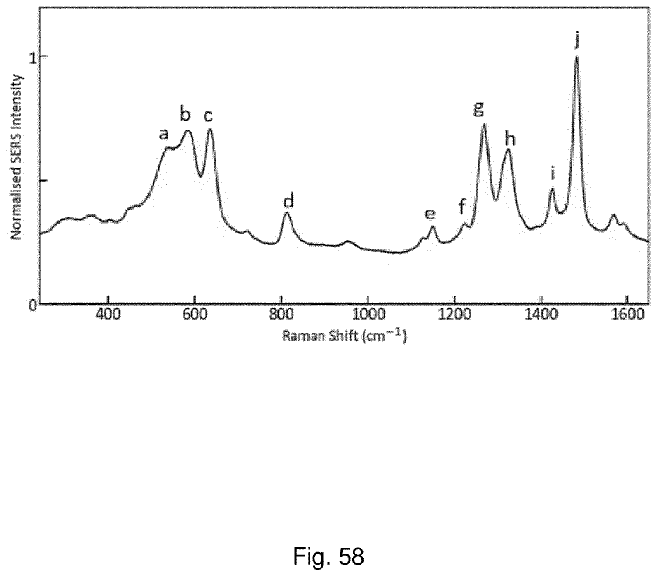

The trio of SERS peaks in the range 450-600 cm⁻¹ are attributed to iron-catechol complexation (Fe—O) bond vibrations,[74, 75, 77, 84, 85] and their changes with pH of the environment are attributed to either the mono-, bis-, or tris-complexation of DA to Fe(III). These peaks therefore allow us to distinguish between the different metal-ligand complexes.[75] In particular, the peaks at 585 cm⁻¹ and 633 cm⁻¹ are assigned to the interaction between Fe—O (C3) and Fe—O (C4) stretches of the Fe-catechol bonds,[77, 85] which confirms the formation of DA: Fe(III) complexes. The peak at 530 cm⁻¹ is assigned to the charge transfer interaction of the bidentate iron-catecholamine complex (FIG. 58, peak a). The relative ratio of integrated 530 cm⁻¹ peak compared to the 585 & 633 cm⁻¹ peaks signals the coordination of the DA:Fe(III) complexation state.[75, 77, 85] The analysis here indicates that bis-complexation of NTs dominates for the Fe(III)-sensitised nanoparticle layer system (FIG. 49).

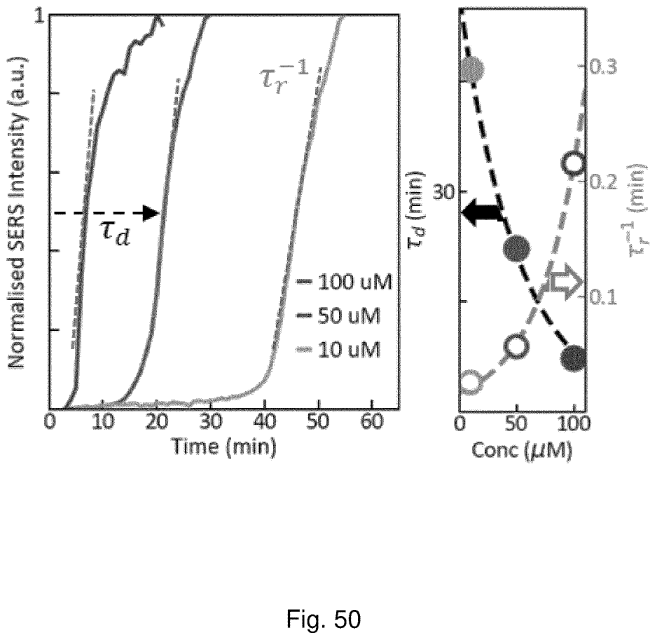

To determine the sensitivity and to optimise the performance of these sensors, it is important to determine the analyte diffusion, binding kinetics, and resolve the key surface chemistries involved. The kinetic behaviour of nanoparticle layer sensing is first tracked in time using the dominant SERS peak intensity at 1482 cm⁻¹ for different DA concentrations varying from 10 to 100 μM (FIG. 50, left). This shows the SERS signals increase at an initially near-linear rate, but only after a characteristic offset delay (τ_{d}), which corresponds to stripping off a protective molecular coating in the nanogaps (see discussion below). Smaller DA concentrations are seen to increase the offset time, and to slow analyte diffusion into the hotspots

$$( {τ}_{r}^{- 1} ) .$$

These parameters are extracted from fitting the concentration data to a Langmuir isotherm model[86] (FIG. 50, left). The unexpected offset delay observed implies the existence of surface protection that must be overcome before DA can bind with the Fe(III) and be detected. To understand this, the surface chemistry is analysed at several stages of the nanoparticle layer fabrication process.

### Characterisation of the Cleaning Treatment

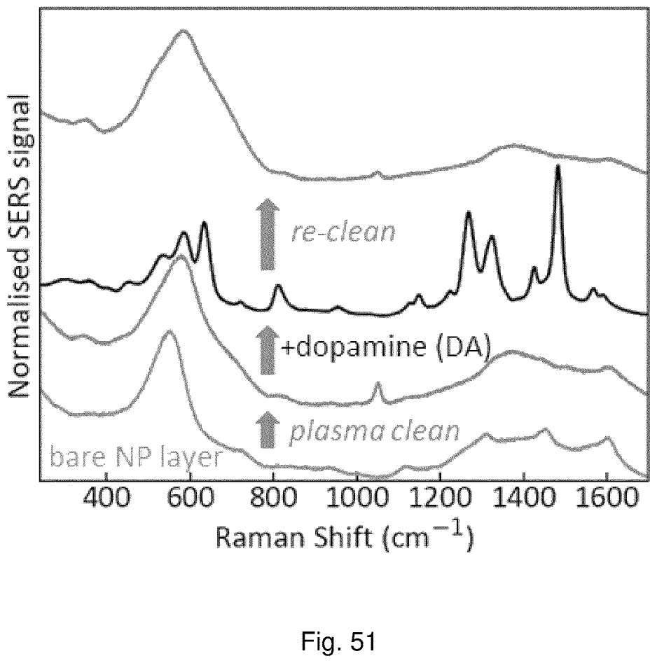

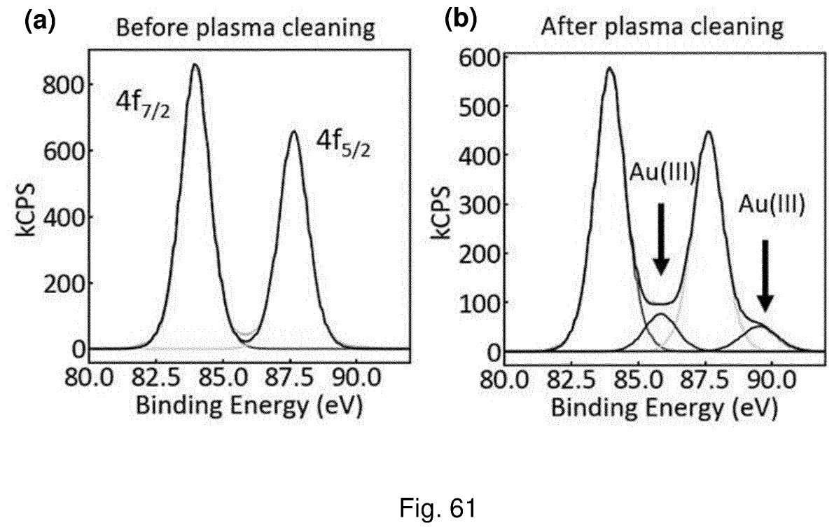

After the AuNPs are first aggregated into the nanoparticle layers, bare nanoparticle layer with surfactants is exposes as seen in the initial SERS spectrum (FIG. 61, bottom line) with multiple broad peaks from 1100-1600 cm⁻¹. This highlights one of the key confounding factors in practical SERS sensing from surfactants and contaminants, both modifying surface binding and introducing unwanted vibrational lines. To condition a pristine surface, the nanoparticle layer then undergoes oxygen plasma treatment for 15 minutes. The oxygen plasma removes any organic deposits including all AuNP stabilising/capping agents such as citrate.[71] After the oxygen plasma treatment, all organic peaks have disappeared, leaving a broad gold oxide peak around 600 cm⁻¹ (FIG. 51, top line and second line from bottom). Residual oxidised citrate gives the 1050 cm⁻¹ peak when treatment is not long enough. The primed substrate from this repeatable cleaning protocol gives a newfound opportunity to reuse nanoparticle layer sensors even after loading the nanogaps with analyte. This reuse delivers a key property for versatile sensors, since it is more sustainable, aids in reproducibility, and enhances accessibility for wider target users.

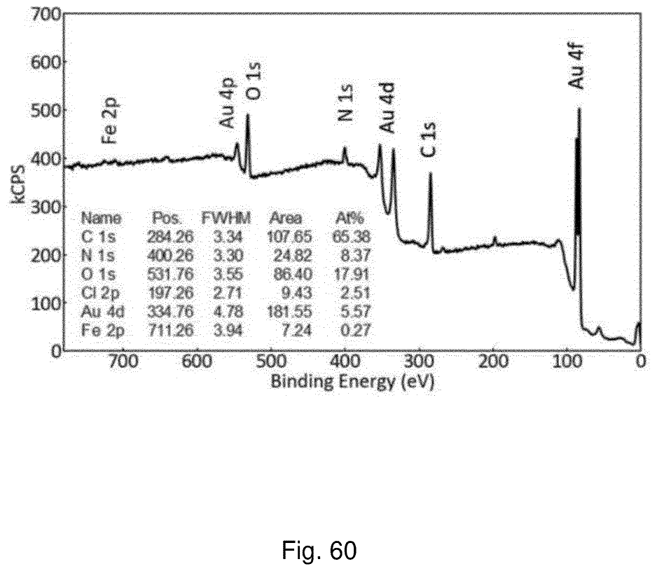

To demonstrate the effectiveness of this cleaning protocol, DA is now flowed onto the plasma cleaned nanoparticle layer giving large signals (FIG. 51, second line from top) as before (FIG. 47). To further emphasise this control, after a subsequent plasma cleaning cycle no trace of DA is found (FIG. 51, top line).[71] This oxygen plasma cleaning treatment and re-exposure to analyte can be repeated many times (FIG. 60 and FIG. 61), with the SERS DA signal remaining stable after an initial slow decrease over the first 11 cycles. No changes in vibrational fingerprint or uniformity across the sample are seen, with a decrease in statistical variability observed as the gap morphologies reach stable configurations. The inventors note that Fe(III) is not added back, suggesting it remains robustly incorporated and active. The stability of these SERS substrates significantly improves upon those that are quickly damaged when exposed to cleaning protocols such as ultraviolet irradiation or other gas plasmas.[73, 87, 88] The inventors note that even where literature claims SERS substrates to be reusable,[89, 90] no thorough statistical analysis is quantified. Cleaning here is only possible because the inventors utilise nanoparticle layers, where the nanogaps are accessible to the plasma ions, and is ineffective in substrates with greater nanoscale tortuosity.

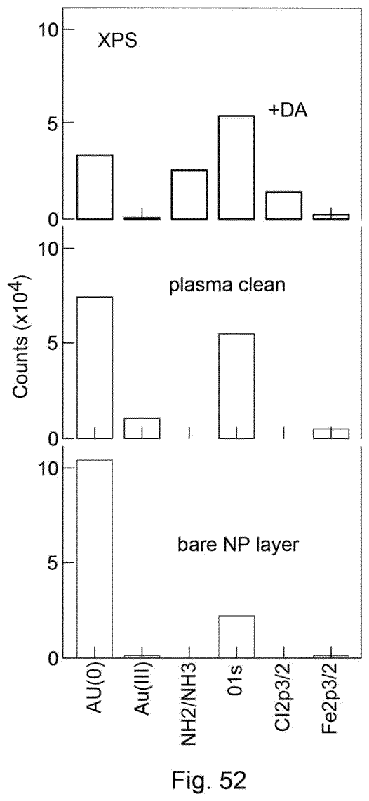

For both ‘plasma cleaned’ and ‘re-cleaned’ samples (FIG. 51, top line and second line from bottom), the large peak observed at 600 cm⁻¹ arises from formation of Au oxides.[91, 92] To investigate this further, X-ray photoelectron spectroscopy (XPS) is used to map the various elements and their charge states in the nanoparticle layer. Relative XPS intensities (FIG. 52) are extracted for the different sample conditions. After plasma cleaning, a metastable Au(III) oxide layer[38] is clearly present on the gold surface (FIG. 52 centre, Au(III); further details in Sensitised Gold Nanoparticle SERS Substrates—Detailed methods, characterisation via X-ray photoelectron spectroscopy). This oxide layer (estimated to be 0.3 nm thick, Sensitised Gold Nanoparticle SERS Substrates—Detailed methods, characterisation via X-ray photoelectron spectroscopy) is important in maintaining the gap when the molecular spacers are removed by the oxygen plasma, and avoid the Au facets sintering together.[71, 38] When re-exposed to DA solution, the Au(III) XPS peak disappears as expected for removal of the Au oxide. The powder form of DA utilised here is dopamine hydrochloride in a 1:1 ratio with hydrochloric acid (HCl) which is required for crystallisation. The inventors find that it is this HCl which strips out the oxide layer. Without removal of the oxide, DA cannot bind to Fe(III) which thus explains the longer offset times observed for lower DA concentrations with correspondingly less HCl (FIG. 50, left).

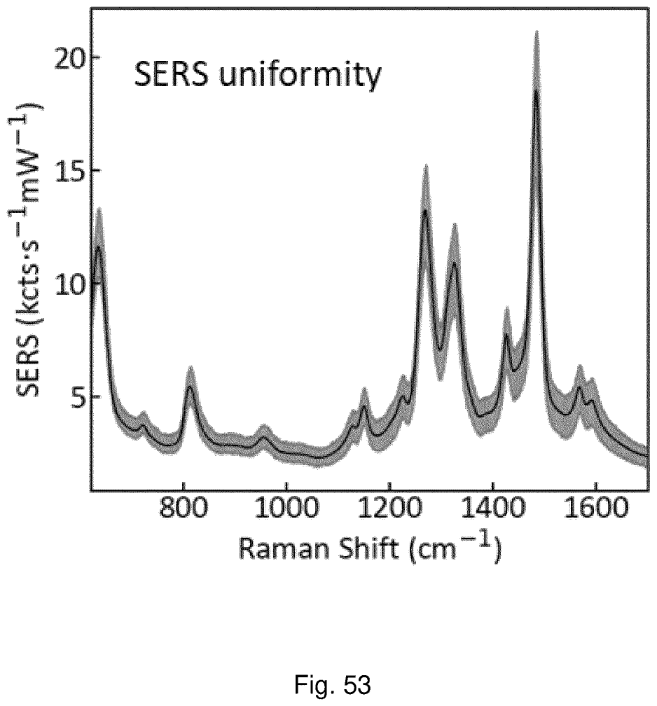

Another important factor for SERS substrates is their uniformity and reproducibility which can be quantified from their relative standard deviation (RSD).[70] The RSD is defined as the standard deviation of SERS peak intensities over their mean intensity (often reported in %). Substrates with RSD values between 5-15% are considered to perform well, while exceptional reproducibilities reach RSDs as low as 1-3%. This typically occurs when nanogap spacings are precisely controlled, such as when utilising robust scaffolds such as cucurbit[n]urils (CB[n]) to define 0.9±0.05 nm gaps.[17, 18] Field enhancements (E/E₀) from gap plasmons are exceptionally sensitive to changes in gap spacing as SERS signals ∝|E/E₀|⁴∝d⁻⁴.[70, 93] Recording 50 SERS spectra from across a substrate (FIG. 53) yields RSD uniformity of 6%, similar to CB[n]-defined nanoparticle layer substrates. Variation arise from any non-uniform coverage of Fe(III), as well as local domains of 2-monolayer-stacked AuNPs that vary the number of hotspots probed at each measurement location. Based on the XPS data, Fe(III) coverage of 40±5% is calculated per AuNP (see Sensitised Gold Nanoparticle SERS Substrates—Detailed methods, characterisation via X-ray photoelectron spectroscopy), but this might vary between hotspots. Overall the sensitised nanoparticle layer thus proves to be a reproducible and accurate SERS platform.

### Time Resolved Limit of Detection

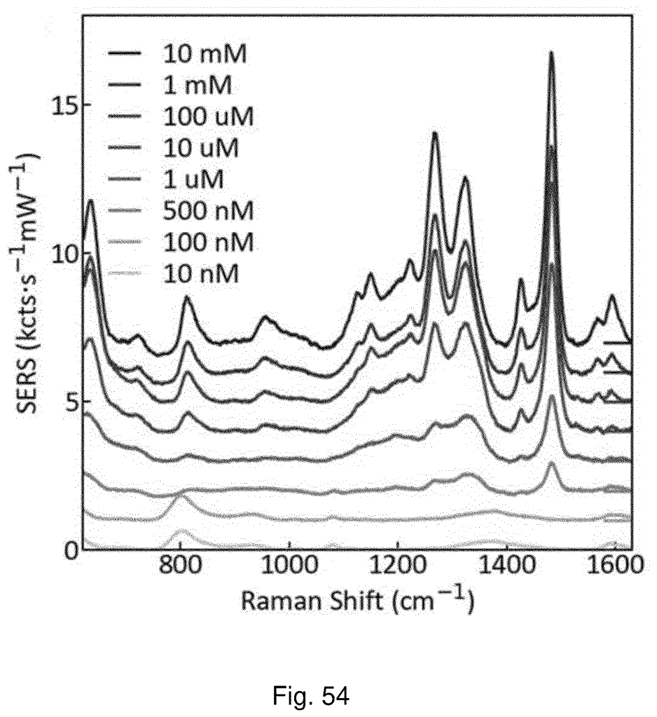

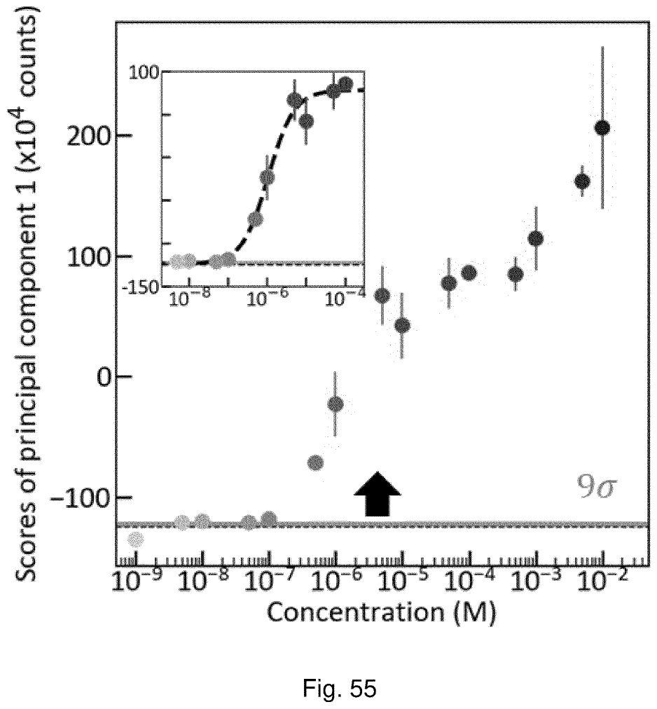

To determine the limit of detection (LOD) of sensitised nanoparticle layers, they were immersed for long periods in DA solutions of various concentrations which ensures equilibrium binding even at the lowest concentrations (24 hours). SERS spectra were collected from 10 points on each sample. The resulting averaged spectra (FIG. 54) display the signature DA peaks clearly down below 500 nM. Principal component analysis (PCA) is performed and the non-linear response observed (FIG. 55) implies that competitive binding or inhibition is present (Sensitised Gold Nanoparticle SERS Substrates—Detailed methods, Principal component analysis). Indeed, two separate behaviours can be found. The inventors suspect that excess HCl (in the DA solution) assists the nanogaps to strip the oxide layer at a different rate at higher concentrations. Between 10-100 μM, the HCl concentration seems to reach a bottleneck between the rate of DA attachment to Fe(III) and the removal of oxide, which below 10 μM is limited by the concentration of HCl present.

The quantitative range for PCA calculation Is thus limited here to 5 nM-100 μM and the first principal component is fit to a Langmuir-Hill model (inset FIG. 55, Sensitised Gold Nanoparticle SERS Substrates—Detailed methods, Langmuir-Hill model). The LOD is then determined as the intersection of the Langmuir-Hill fit with the 3σ confidence band of the noise level. The LOD for this system is 13.8 nM (while for the uncleanable Solagg the LOD is 1.3 nM), and since the mean concentration of DA in human urine is 4 μM, this indicates that nanoparticle layers are suited for clinical applications.[94] Furthermore, the limit of quantification (LOQ) is 49 nM using a confidence level of 9σ. The inventors also note other work claims extracellular DA levels ranges from 0.5 to 100 nM.[55, 95] The Hill coefficient extracted from fitting is 1.3 (Sensitised Gold Nanoparticle SERS Substrates—Detailed methods, Langmuir-Hill model), signifying positively cooperative binding of the DA to Fe(III) and clearly suggesting that further understanding of the different surface chemistries present in different SERS platforms is required to fully identify the accessible application space.

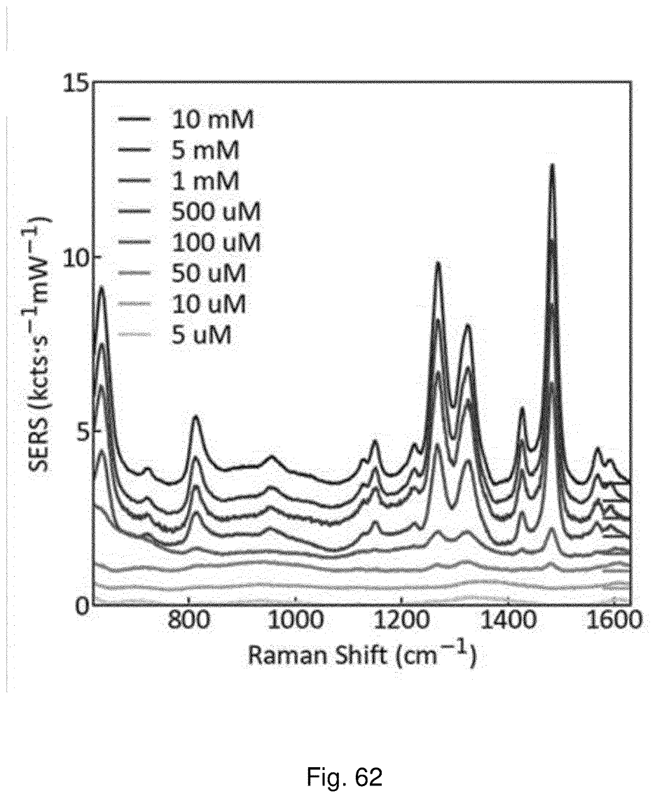

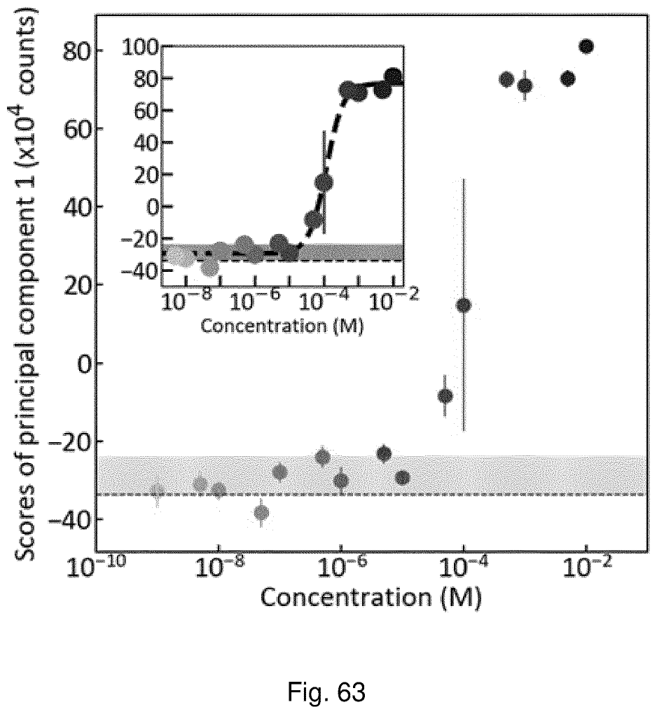

On the contrary, when the layers are exposed to DA concentrations for only 10 minutes (FIG. 62 and FIG. 63), the LOD observed was only 22.8 μM. Again, this is likely due to the restricted stripping within this time of oxide from nanogaps at low [HCl], where longer onset times (FIG. 50, left) prevent immediate DA detection. The inventors thus emphasise that the Langmuir equilibration time (typically not considered in assay specification), and other effects such as opening up of hotspot sites or binding to Fe(III), always need to be considered for LOD specification. One advantage of these nanoparticle layer sensors is that they automatically filter for only small analytes which can fit into these nanogaps, while larger proteins and cellular components are swept away. Clearly however, enhanced binding affinities are desirable for reducing assay timescales in realistic applications.

### Multiplex Neurotransmitter Sensing

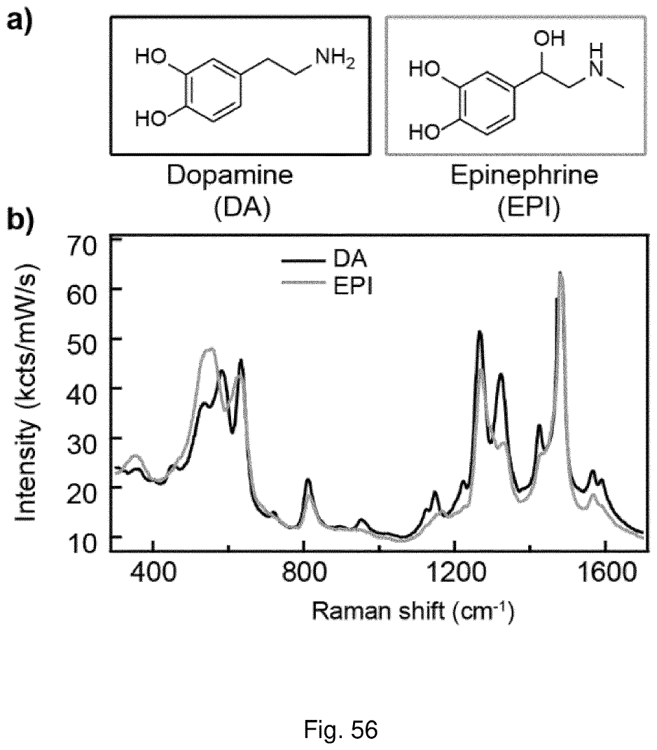

For clinical application in sensing neurotransmitters from human fluids such as urine, it is important for the sensor to be selective, however it must also measure multiple analytes simultaneously. The inventors thus study multiplexed sensing of DA and epinephrine (EPI) to characterise the discrimination of two similar species and if any interactions influence their signals. EPI is also a catecholamine with a very similar structure to DA except for different functional groups (FIG. 56a), hence they also form Fe-catechol complexes and again produce highly enhanced SERS signals (FIG. 56b). Their SERS spectra are consequentially similar, in both Fe-catechol and catechol ring vibration regions. Even so, the characteristic differences in peak ratios and additional peaks allow independent molar concentrations to be faithfully extracted, as the inventors now show.

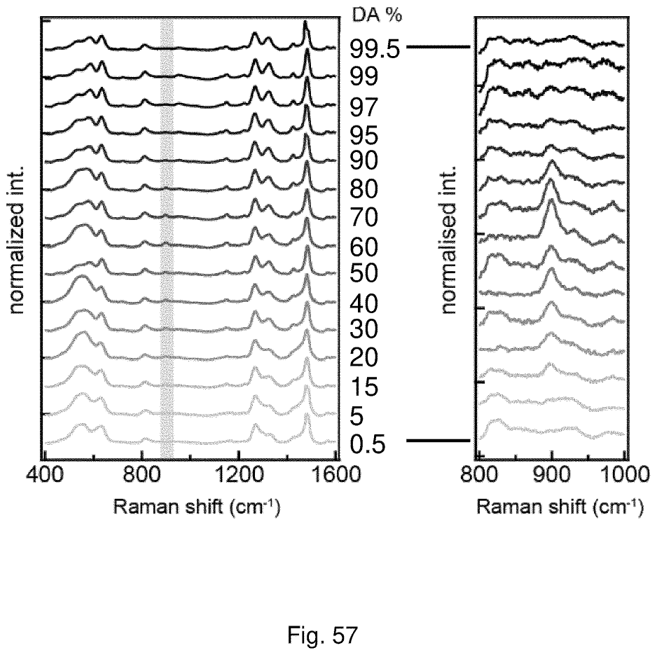

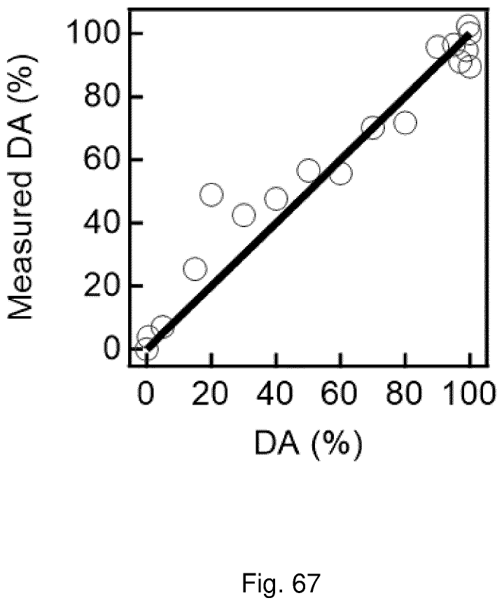

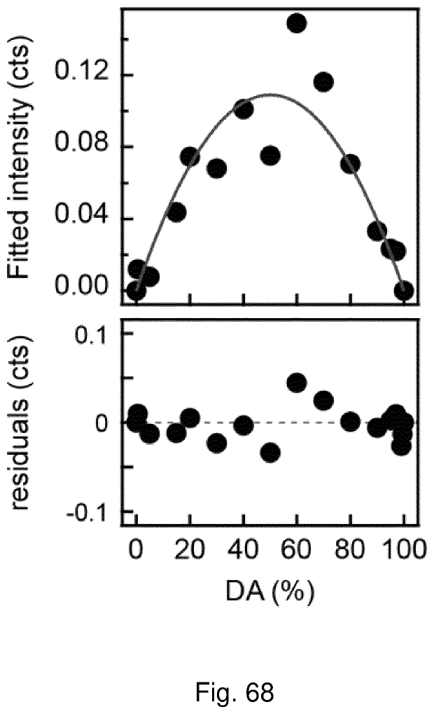

When the ratio of DA:EPI is swept from 0 to 100%, the measured SERS spectra (FIG. 57, left) can predominantly be reconstructed using linear superpositions of the individual 100% DA and EPI SERS spectra (FIG. 67). An intriguing additional effect is however also seen, which is a new SERS peak at 895 cm⁻¹ only appearing with mixtures and strongest for 60:40% DA:EPI (FIG. 57, right, FIG. 68). This implies again that bis-complexation with Fe(III) in the nanogaps is most stable, and produces a previously-unseen vibrational transition. The inventors suggest that hydrogen bonding between the NH₂ end group of DA and OH tail group of EPI, shifts and intensifies a weak vibrational mode at ~940 cm⁻¹ in each 100% complex (which is due to NH₂ tail wagging). DFT calculations on individual complexes are not able to reproduce this mixed line (whatever the protonation and hydration state of the cluster, see Sensitised Gold Nanoparticle SERS Substrates—Detailed methods). This suggests that these are inter-complex rather than intra-complex interactions, and thus confirms the separation of the catechol tails within each complex.

As a result of these investigations, the inventors arrive at a more detailed nanoscale understanding for how Fe(III)-sensitised nanoparticle layer substrates produce strong SERS signals for catechols. Removal of all other organics by oxidation leaves high coverage Fe(III) inside the nanogap hotspots. Stripping of the oxides leaves these Fe(III) active on the Au surface, and able to bind catechols in a bis-complex (FIG. 45). The inventors find similar binding activities for different catechols so that faithful extraction of multiplexed concentrations can be achieved, with limits of detection below 13 nM.

The Inventors have demonstrated the sensing of neurotransmitters using Fe(III)-sensitised AuNPs on highly sensitive and reproducible nanoparticle layer SERS substrates. These nanoparticle layers are deposited on transparent glass substrates resulting in efficient access and sensing from both sides by fluid and light, achieving a RSD of 6% and LOD of DA below 13 nM exceeding clinical limitations. By using oxygen plasma cleaning treatments, it is possible to completely remove all analytes, reuse the layers, and provide reproducible pristine hotspots for sensing. Such cleaning is only possible for nanoparticle layer samples, where the gaps are accessible to the plasma ions. During the oxygen plasma cleaning, the formation of gold oxides can be directly observed by SERS and XPS, as well as their subsequent reduction prior to detection of DA. Multiplexed sensing of neurotransmitters reveals excellent mixing and identical site competition, as well as unusual complexation and vibrational coupling suggesting inter-complex interactions. These devices are extremely promising for microfluidic integration and for translational implementations such as ‘smart toilets’ for continuous monitoring and drug compliance. Simplified forms of plasma cleaning are accessible and should be explored, as well as alternative methods for removing organics within the nanogaps.

### Sensitised Gold Nanoparticle SERS Substrates—Detailed Methods

### Fabrication of Nanoparticle Layers

Standard 60 nm nominally spherical AuNPs stabilised with citrate were purchased from BBI Solutions (UK). 500 μL of these 60 nm AuNPs were added to an Eppendorf tube containing 500 μl of chloroform, pipetted in using a Pasteur pipette to form a two-phase system. This allows aggregation of the AuNPs to be initiated with the addition of 150 μL of 0.5 M NaCl. The tube is then shaken for approximately 1 minute until the colour changes from clear red to opaque greyish purple. The mixture is left to settle causing the aggregated AuNPs to settle at the interface between the chloroform and the aqueous phase. This aqueous phase was washed three times by the addition and removal 300 μL of DI water, in each round diluting and removing any excess citrate and salts. The remaining liquid is removed slowly from the aqueous phase until a small dense droplet of aggregated AuNPs is formed. This droplet is carefully transferred onto a glass slide (Fisherbrand Borosilicate Glass, 16 mm), which is washed prior to using ethanol and DI water. The droplet is left to dry forming a nanoparticle layer, and upon drying the nanoparticle layer is rinsed using DI water and then dried using nitrogen gas flow. The surfactants on the AuNP surfaces are stripped away using oxygen plasma treatment by exposing the nanoparticle layer to an oxygen plasma for 15 min (30 sccm, 90% RF power) using a Diener electronic Gmbh & Co. KG Plasma etcher. The substrate is removed carefully from the plasma etcher and the layer immersed in 355 μL solutions of dopamine hydrochloride (10 nM-10 mM) pipetted into black polypropylene 96 well microplates (Greiner Bio-One Ltd). All chemicals were purchased from Sigma-Aldrich.

### Raman Measurement

The nanoparticle layers are measured using a Renishaw inVia confocal Raman microscope, with 20× objective (NA=0.40) and 785 nm laser. The spectrum is typically collected using 1 s integration time and 0.5% laser power (~2.2 mW incident power), unless otherwise specified.

### Nanoparticle Layer Characterization

Scanning electron microscope images are obtained using a FEI Philips Dualbeam Quanta 3D with accelerating voltage of 5 kV, and current of 25 pA. X-ray photoelectron spectroscopy (ThermoFisher Escalab 250Xi) is conducted using a monochromated Al Kα X-ray source.

### Density Functional Theory (DFT)

DFT calculations were performed using the B3LYP[96, 97] hybrid generalised gradient approximation exchange-correlation functional, augmented with Grimme's D3 dispersion correction with Becke-Johnson damping (GD3BJ).[98] The Def2SVP[99] basis set was employed for all atoms. All DFT calculations were implemented using an ultrafine integration grid in Gaussian 09 Rev. E.[100]

### Calculation of Hotspot Probed in SERS Substrates

A simple calculation is implemented to approximate the number of hotspots probed for both SolAgg and nanoparticle layer systems. For both substrates, λ=785 nm and the ×5 objective used has a NA of 0.12.

For the nanoparticle layer, assuming a diffraction limited spot on the sample, the illumination spot size of the laser can be calculated as:

$${D}_{l} = \frac{λ}{NA} = 3271 nm$$

Considering a homogenous monolayer coverage of Fe(III) around the AuNP, the effective diameter is estimated as 61.9 nm thick, this illuminates an area of:

$$A = π \times {( \frac{{D}_{l}}{2} )}^{2} = 3009 {nm}^{2}$$

Assuming that each nanoparticle layer consists of 1.5 layers of AuNPs probed, and that each AuNP supports 1.6 surrounding hotspots, this suggests that N~6700 gaps are probed.

For SolAgg, the laser spot diameter (A) can be approximated to be 1250 μm² and using the Rayleigh length zᵣ, the volume probed can be calculated:

$$V = A \cdot 2 {z}_{r} = A \cdot 2 \cdot \frac{{πω}_{0}^{2}}{λ} = 2 \cdot \frac{{A}^{2}}{λ} = 0.398 μ L$$

Aggregation does not change the average particle density, and since commercially bought AuNPs from BBI Solutions have 2.6×10¹⁰ AuNP per mL, there are approximately 1.03×10⁷ AuNPs probed. Again, assuming that each AuNP has 1.6 hotspots (similar fractal dimension) this totals around 1.7×10⁷ hotspots.

### DFT Calculation of DA:Fe(III) Complexes

DFT was computed for both the protonated and deprotonated DA as outlined above. Bis-complexed DA: Fe(III) were calculated, and it can be seen that the simulations are well correlated with the experimental spectra as seen in FIG. 48. The existence and influence of different protonation states due to the presence of HCl in the DA solution can be discounted through inspection of FIG. 48 as well as Table 2, since both the protonated and deprotonated DFT spectra are near identical. Based on the literature, it is possible to assign the Raman modes as shown in Table 2.

TABLE 2
Peak positions of DA:Fe(III) complexes for experimental, deprotonated
and protonated DFT calculations. Assignment of vibrations is
based on the DFT calculations as well as literature.

| | Peak position (cm⁻¹) | | | | | |
|---|---|---|---|---|---|---|
| | Experimental | Deprotonated | Protonated | Other works | | |
| Label | (this work) | DFT | DFT | [85] | [77] | Peak Assignment |
| a | 530 | 504 | 499 | | 550 | Charge transfer interactions of the |
| | | | | | | bidentate chelate. Increases with |
| | | | | | | pH [85, 77, 75] |
| b | 585 | 573 | 585 | 592 | 596 | Interaction between Fe(III) and C3 |
| | | | | | | oxygens of catechol (v Fe—O) [85, |
| | | | | | | 77, 75, 74, 84] |
| c | 633 | 619 | 615 | 633 | 637 | Interaction between Fe(III) and C4 |
| | | | | | | oxygens of catechol (V Fe—O) [85, |
| | | | | | | 77, 75, 74, 84] |
| d | 812 | 813 | 814 | | 824 | Ring breathing [74] |
| e | 1151 | 1136 | 1133 | | | V15 stretching, δCH [74, 84] |
| f | 1224 | 1260 | 1254 | | | |
| g | 1269 | 1288 | 1305 | 1270 | 1270 | vC—O, catechol carbon-oxygen |
| | | | | | | stretching [75, 74, 84, 81] |
| h | 1324 | 1332 | 1341 | 1317 | 1322 | vCC [75, 74, 84] |
| i | 1425 | 1423 | 1426 | 1422 | 1423 | |
| j | 1482 | 1463 | 1479 | 1480 | 1476 | v CC + δCH, C—C stretch in |
| | | | | | | benzene ring to which the oxygen |
| | | | | | | atoms are attached [75, 74, 84, 81] |

### Langmuir Isotherm Model

The Langmuir model[86] is based on the assumption that only a monomolecular layer of non-interacting solutes is formed dynamically on the sorbent surface. The fraction of occupied hotspots

$$\frac{d θ}{dt} = {k}_{a} [ A ] N ( 1 - θ ) - {k}_{d} N θ$$

where N is the total number of hotspot sites, [A] is the analyte concentration, and kₐ and k_{d} are respectively the adsorption and desorption rate constants. For θ=0 at t=0 the solution

$$θ = {θ}_{eq} ( 1 - {e}^{- \frac{t}{τ}} )$$

shows experimental time equilibration, where,

$${θ}_{eq} = \frac{K [ A ]}{1 + K [ A ]}$$

is the equilibrium (t→∞) fraction of hotspots occupied, and the time

$$\frac{1}{τ} = {Nk}_{d} ( 1 + \frac{{k}_{a}}{{k}_{d}} [ A ] ) = {Nk}_{d} + {Nk}_{a} [ A ]$$

In the fitting of the experimental SERS spectra which track θ, the inventors separately fit the onset delay τ_{d}.

### Repeatability Test Using Oxygen Plasma Treatment

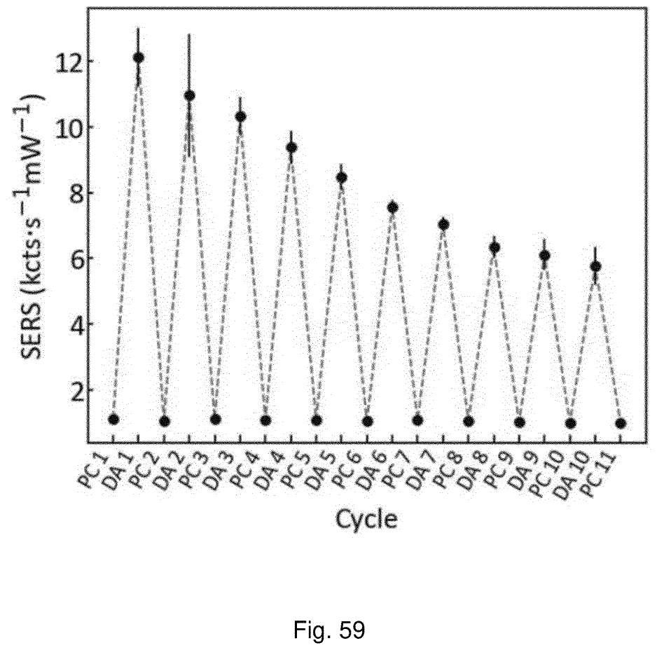

For the cleaning protocol used after fabrication and for reuse, each nanoparticle layer was oxygen plasma cleaned for 15 minutes, at 30 sccm and 90% power. To test the repeatability and the stability of the nanoparticle layers, the cleaning process was repeated as shown in FIG. 59. After each plasma cleaning (PC), the sample was immersed in a 10 mM DA solution for 5 minutes prior to measurement. Five separate measurements were taken each time which provided the standard deviation of the SERS counts. The 1481 cm⁻¹ peak intensity was analysed for this repeatability test. It can be clearly seen that the DA is fully stripped away from the substrate after each PC since the SERS counts go back to the baseline throughout the test. This also implies minimal structural damage. However, with increasing repetitions, the SERS counts diminish saturating over long times to a SERS count about half that initially.

The inventors note since the SERS scales as E⁴, this would correspond to only a 20% drop in nanogap field E, or a reduction in accessible gaps. Such a field reduction can easily occur due to changes in the in-coupling of pump light, through slight changes in faceting of the nanogaps which red-shifts their resonances.

### Characterisation Via X-Ray Photoelectron Spectroscopy

The nanoparticle layers were characterised by X-ray photoelectron spectroscopy (XPS) and the results were analysed using CasaXPS. All spectra were calibrated against the Au 4f7/2 peak (at 83.9 eV) and the survey spectrum of the nanoparticle layer after being exposed to dopamine (FIG. 60).

Before plasma cleaning, the native Au4f at binding energy of 83.9 and 87.6 eV are present as expected (FIG. 61a). However, after oxygen plasma cleaning (FIG. 61b), a new species with a binding energy of 85.8 and 89.5 eV is present. This shift of 1.9 eV compared to untreated samples is consistent with literature values for the formation of Au2O3 [101, 102]. Separations of 1.8-2.1 eV correspond to the formation of Au(III) [103-105] confirming the new oxide species formed.

Utilising these XPS results, it is possible to calculate the packing density of specific elements as well as the coverage of the Fe(III) per AuNP. Firstly, the mean free paths from the universal XPS probe-depth calibration at λ_{Au}=2.2 nm implies that approximately ~3 gold surface layers can be probed.

Utilising the relative sensitivity factor values of 9.976 and 11.593 for Fe and Au respectively (unique to the specific instrument used), the inventors can calibrate the XPS intensity ratio and calculate the surface coverage of Fe(III)

$${ρ}_{Au} = \frac{1}{{d}^{2}} = 0.14 Au atoms {Å}^{- 2}$$

XPS atomic % ratios

$${δ}_{Fe ( III )} = \frac{{A}_{Fe ( III )}}{{A}_{Au monolayer}} = \frac{6400}{59000 / 3} = 0.0325$$

Which gives a surface coverage of:

$${ρ}_{Fe ( III )} = {δ}_{Fe ( III )} \cdot {ρ}_{Au} = 0.0455 {Å}^{- 2} = 45.5 \times {10}^{17} {m}^{- 2}$$

The thickness of the Au(III) layer can also be approximated by utilising the ratio of the Au(III):Au(0) in FIG. 61b, which is 0.137. Again, utilising the mean free paths of gold, this gives as expected

$${t}_{Au ( IIII )} = {λ}_{Au} \times \frac{{I}_{Au ( III )}}{{I}_{Au ( 0 )}} = 0.3 nm$$

### Principal Component Analysis

Principal component analysis (PCA) takes into account the whole spectrum and is a powerful tool for examining correlations and extracting any changes in the spectra. This is advantageous because it removes the need to perform background subtraction or fitting to an already complicated SERS background. The key is that each principal component represents a linearly-transformed eigenspectrum that has different levels of correlation to the original SERS spectra.

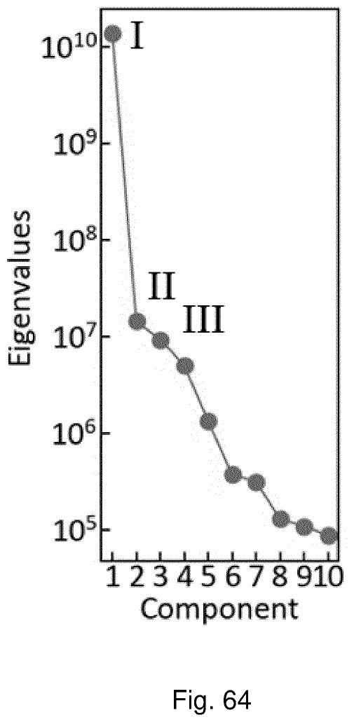

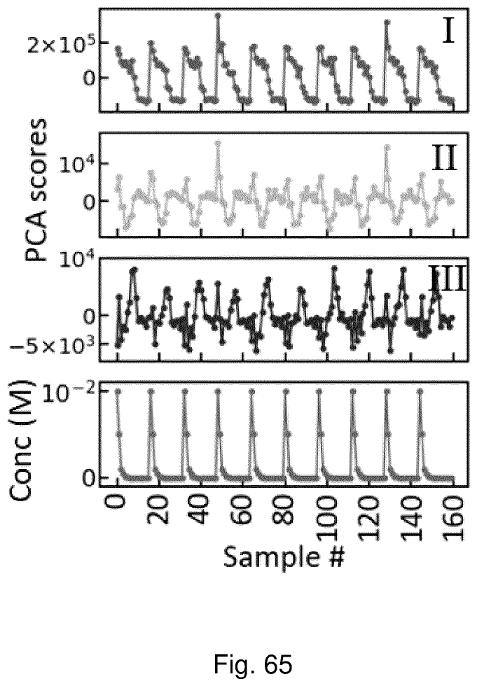

PCA was used to extract the correlation between the concentration and the sensitivity of the system, which was later used to calculate the LOD. The eigenvectors (components) and eigenvalues were then calculated (FIG. 64). Higher eigenvalue weights successively decrease and the trend with only the first three components is analysed (as labelled). For each concentration, 10 measurements were made (FIG. 65 bottom) and the corresponding eigenvalues for each sample number are plotted in FIG. 65. Considering that 99% of the eigenvalue originates from component 1, this closely follows the analyte concentration.

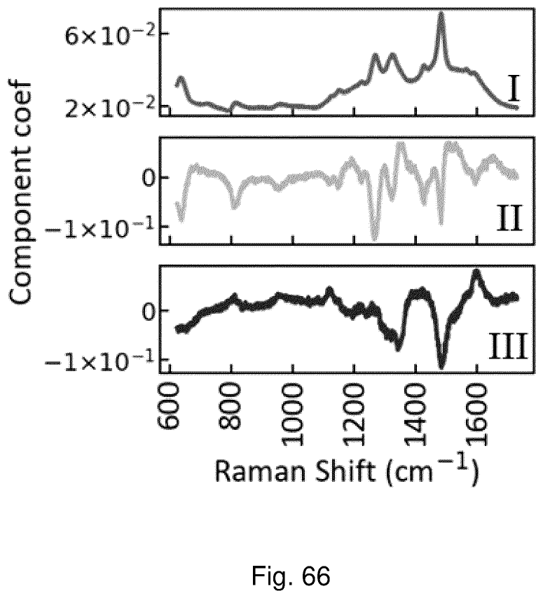

To remove the contribution from the other loadings, the following equation is used:[44]

$${S}_{I}^{′} = {S}_{I} - {\sum }_{n \to ∞} ( {S}_{I + n} \times \frac{{C}_{I + n} ( 0 \% )}{{C}_{I} ( 0 \% )} )$$

where S_{I} is the first component and n denotes the rest of the components contributing to the eigenvalues. The loading plots (eigenvectors) of each component are shown in FIG. 66, with comp I resembling the typical DA SERS spectrum.

### Langmuir-Hill Model

The inset in FIG. 55 was fitted according to the standard Langmuir-Hill equation:[44]

$$f = \frac{A}{1 + {( \frac{{K}_{a}}{[ C ]} )}^{n}} + b$$

where Kₐ is the analyte concentration to occupy half of the binding sites (also known as the dissociation constant), n is the Hill coefficient, [C] is the concentration of the analyte, and A and b are constants. These were fitted to FIG. 55 and FIG. 63 in the quantitative regions (inset figures) and the fit coefficients as well as the LOD and LOQ are detailed in Table 3.

TABLE 3
Langmuir-Hill fit coefficients of FIG. 55 as well as FIG. 63
for two different immersion times of 10 min and 24 hour. The
LOD is chosen to be at 3σ above noise while the LOQ is 9σ.

Fit values/Calculation

| Parameters | 24 hour | 10 min |
|---|---|---|
| Kₐ | 1 × 10⁻⁶ | 1.2 × 10⁻⁴ |
| n | 1.3 | 1.75 |
| A | 202 | 106 |
| b | −124 | −29 |
| LOD | 13.8 nM | 22.8 μM |
| LOQ | 48.6 nM | 60.3 μM |

### Multiplex Sensing Statistical Analysis

By further analysing the multiplexed sensing of DA and EPI, and performing simple statistical analysis, it is possible to understand if there are any prominent chemical interactions occurring between the two analytes. This is carried out by maximizing the spectral overlap between the experimental spectra and a linear superposition of the 100% DA and EPI spectra, to extract the measured ratio of DA. For analytes that do not interact with one another, the inventors would expect the data to produce a linear line (FIG. 67). To reconstruct the measured spectra, the range 588-1375 cm⁻¹ is used which provides the best fit.

From FIG. 67, most but not all data points lie exactly along the expected line. This supports existence of inter-complex interactions, in particular the new peak that appears at 895 cm⁻¹ (FIG. 68). This also confirms a 1:1 complexation between DA:EPI.[106] By fitting a Gaussian to the residual between the measured and expected spectrum, we find that this peak is maximized for 60:40% DA:EPI. However, when this curve is fitted against the red curve (which represents DA %×(1−DA %)) a simple relationship can be established, further supported by minimal residuals as shown in the latter half of FIG. 68.

### Analyte Detection and Cycling Repeatability

Oxidative cleaning in the following is achieved electrochemically, offering a strategy to control the surface properties of SERS substrates in-situ (for example, in a flow-sensing application). By setting the SERS substrate as a working electrode in a three-electrode electrochemical cell, a potential is applied to control the surface charge and induce local reactions directly on its surface.[107], [108] With a Au-based SERS substrate, the application of an anodic potential oxidises and/or desorbs analytes as well as oxidises the Au. This process is rapid (seconds) even for nanogaps, as the oxidation process is driven directly at the Au surface.[109] Electrochemical reduction of the Au oxide layer in a redefinition step then occurs upon application of a cathodic potential. Aside from analyte removal, electrochemical SERS (EC-SERS) can modulate analyte binding, increasing SERS signals by up to 10-fold through the enhanced adsorption of analytes.[107] The inventors examine multiple analyte detection, cleaning, and redefinition cycles to assess both the stripping capability and redefinition (which may also be referred to as “regeneration” herein) repeatability.

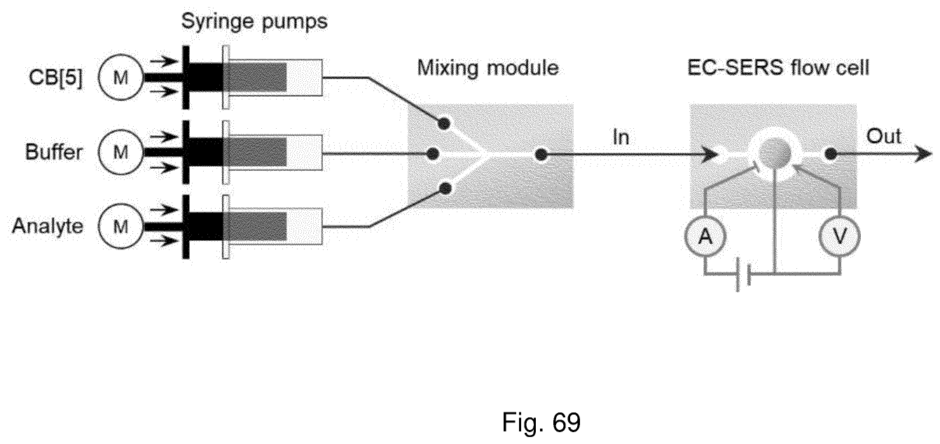

To enable electrochemical control of their surface potential, nanoparticle layers are deposited on a fluorine-doped tin oxide (FTO)-coated glass slide and assembled in an EC-SERS flow cell as the working electrode (FIGS. 69 to 72). SERS spectra are recorded by illuminating the nanoparticle layer with a 785 nm laser through the transparent FTO-coated glass, facilitating in-situ monitoring of the nanogap while simultaneously controlling the applied potential.

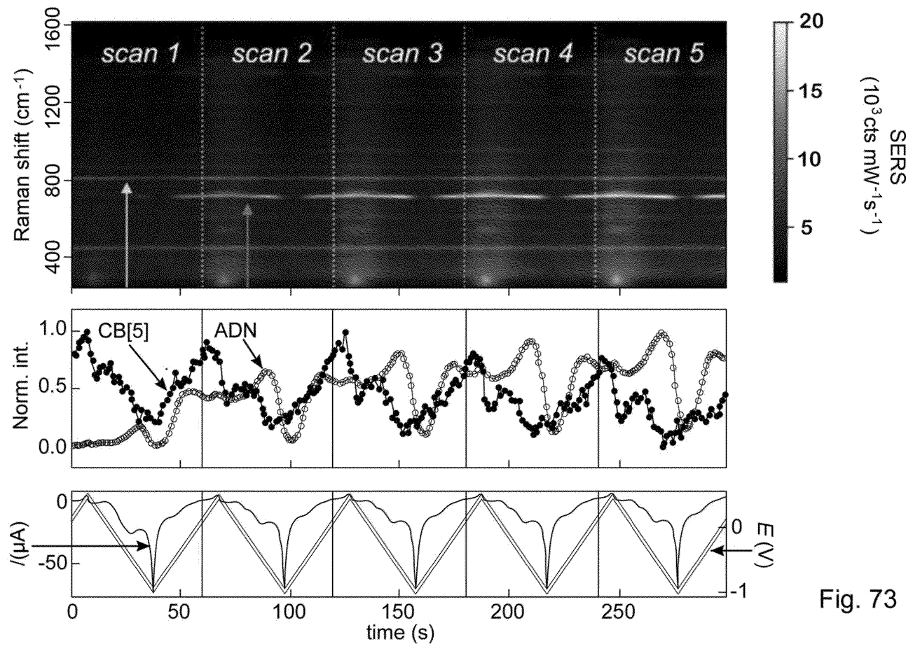

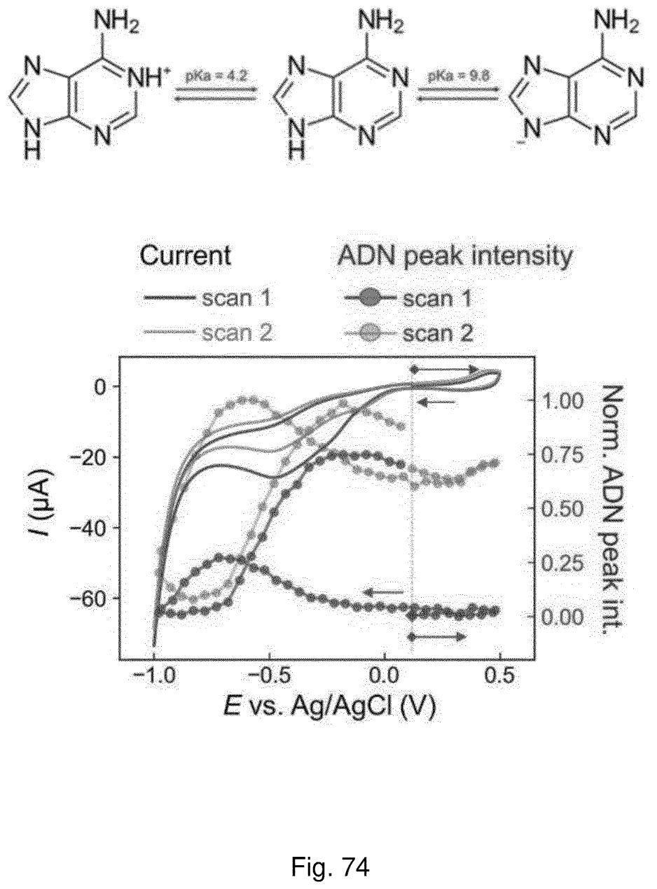

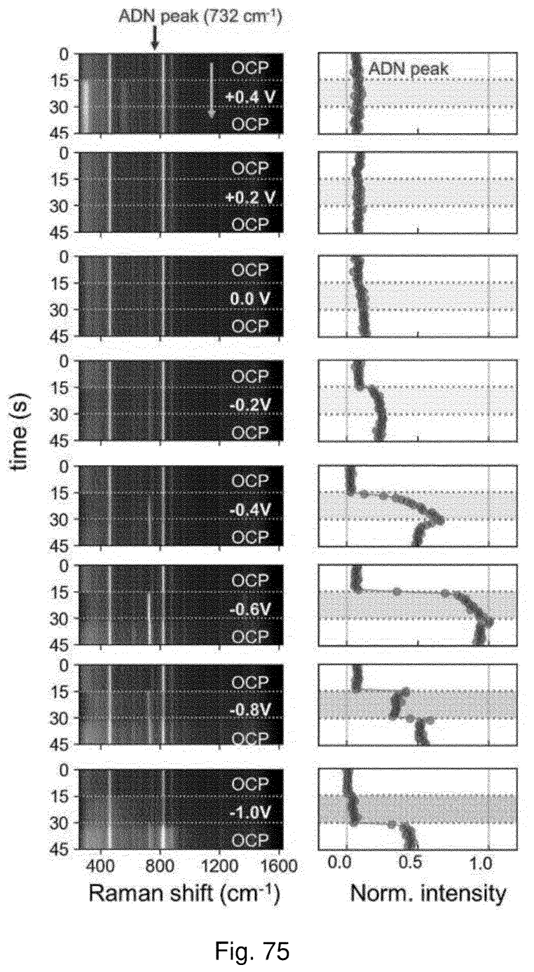

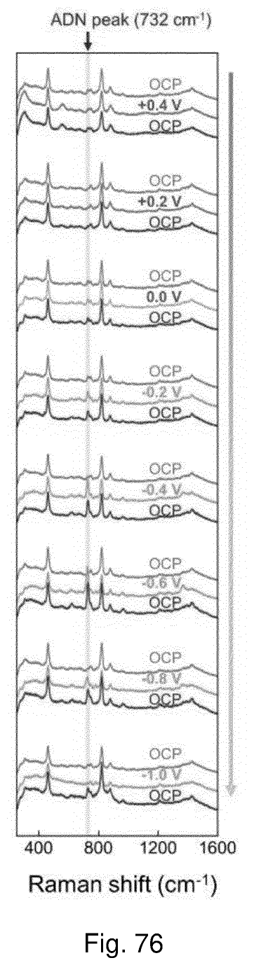

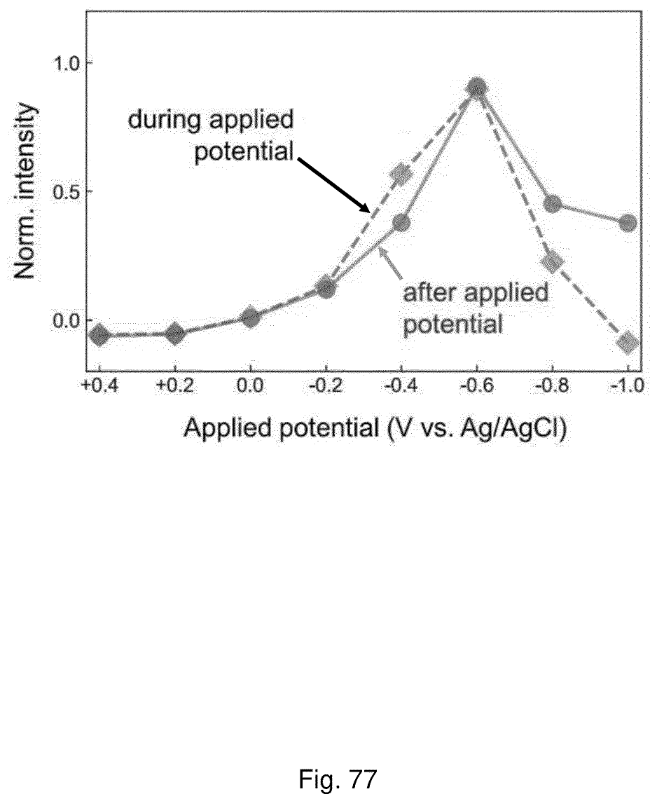

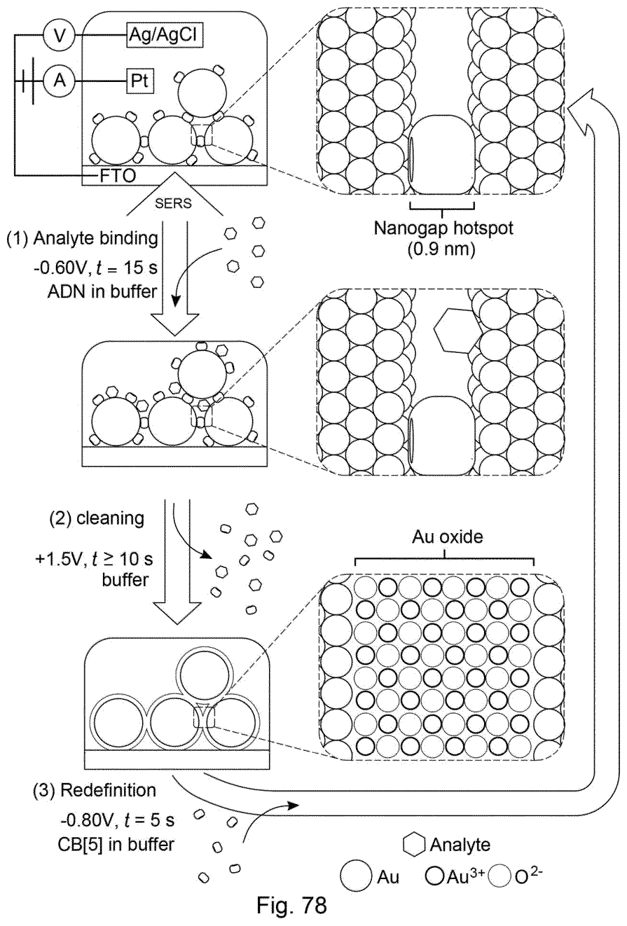

As a model analyte for recycling experiments, adenine (ADN) is selected since its potential-dependent binding and SERS spectra are well-studied,[110],[111] and tested in EC-SERS on roughened Ag electrodes.[112] At pH 7.0, adenine is predominantly neutral and binds to Au[113] however in electrolyte solutions, adenine competes with ions for binding sites in the nanogaps.[114] Negative potentials enhance adenine binding giving maximum SERS enhancement of the v_{adenine}=732 cm⁻¹ peak with a step potential of −0.60 V (FIGS. 73-77). Once adenine binds to the nanoparticle layer-CB[5] hotspots, removal of this applied potential does not lead to adenine desorption, nor does application of moderately positive potentials (up to +0.60 V, before the onset of Au oxidation). Adenine is thus strongly bound and rinsing with buffer solutions (pH 2.0, 7.0, or 12.0), 0.1 M HCl, or 0.1 M NaOH does not lead to its desorption. Since adsorbed adenine is not removed with simple rinsing, it is an ideal analyte to test in-situ analyte detection, cleaning, and redefinition (FIG. 78).

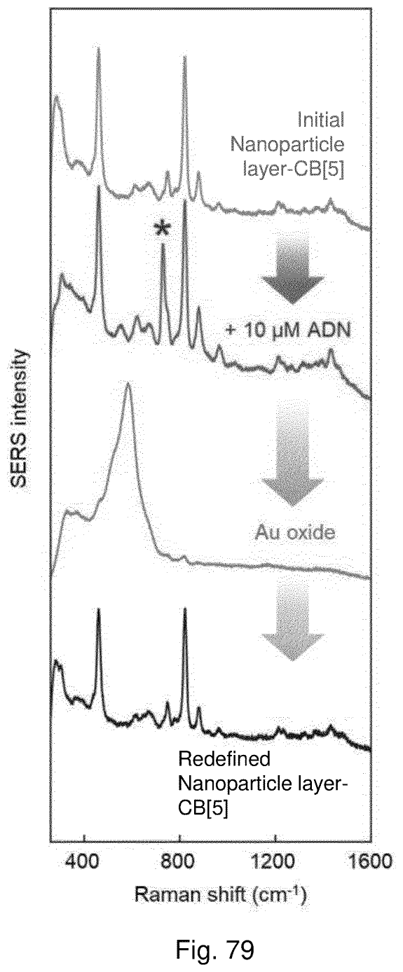

The SERS spectrum of the initial nanoparticle layer-CB[5] in the buffer-filled EC-SERS flow cell shows a clean nanoparticle layer with only the spectral fingerprint of the CB[5] molecular scaffold visible (FIG. 79 top). To detect adenine, the analyte solution is injected into the flow cell using a syringe pump and a potential of −0.6 V applied for 15 s. A spectrum is then recorded at open-circuit potential (FIG. 79, second from top). After analyte binding, the nanogaps are cleaned by flowing buffer at a constant rate of 500 μL min⁻¹ while applying +1.5 V for >10 s. This oxidises/desorbs the adenine while forming Au oxide at the AuNP surface, seen directly in the SERS spectrum (FIG. 79 second from bottom) as a broad peak ≈590 cm⁻¹ from the Au—O stretch.[109], [35] Buffer flow for another 5 s after applying the oxidising potential flushes out any decomposition products and desorbed analytes from the nanoparticle layer and sample chamber. After cleaning, the nanogap is redefined by flowing 1 mM CB[5] in buffer and applying-0.8 V for 5 s, which rapidly reduces Au oxide while facilitating the binding of CB[5] onto the Au surface. The resulting SERS spectrum of the redefined nanoparticle layer-CB[5] (FIG. 79 bottom) is near identical to the initial spectrum and shows no trace of the adenine v_{adenine} peak, indicating how effectively the nanoparticle layer nanogaps are cleaned.

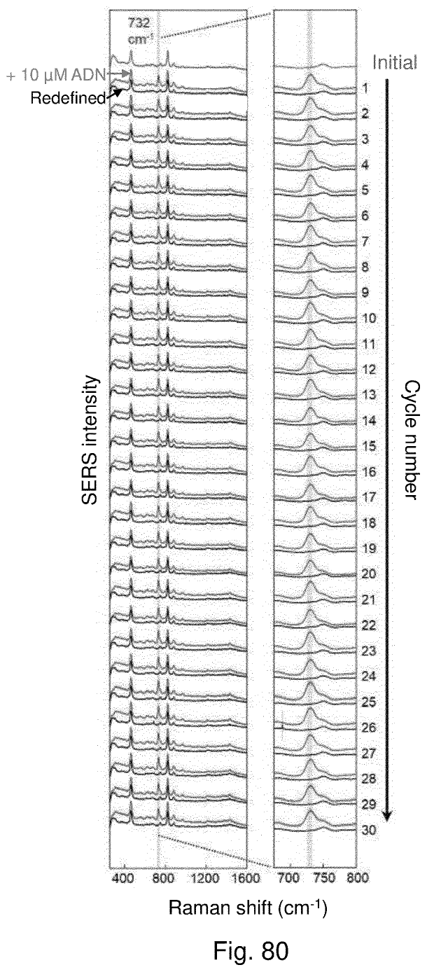

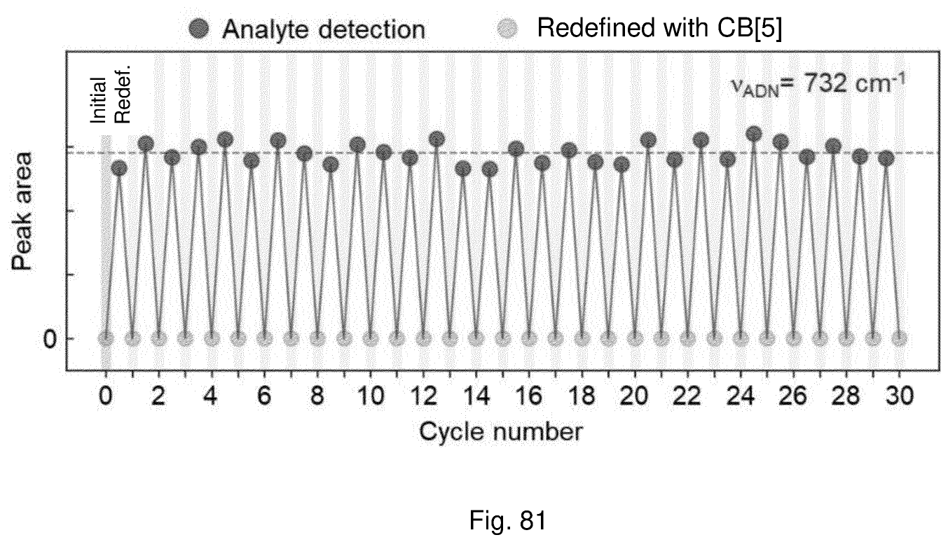

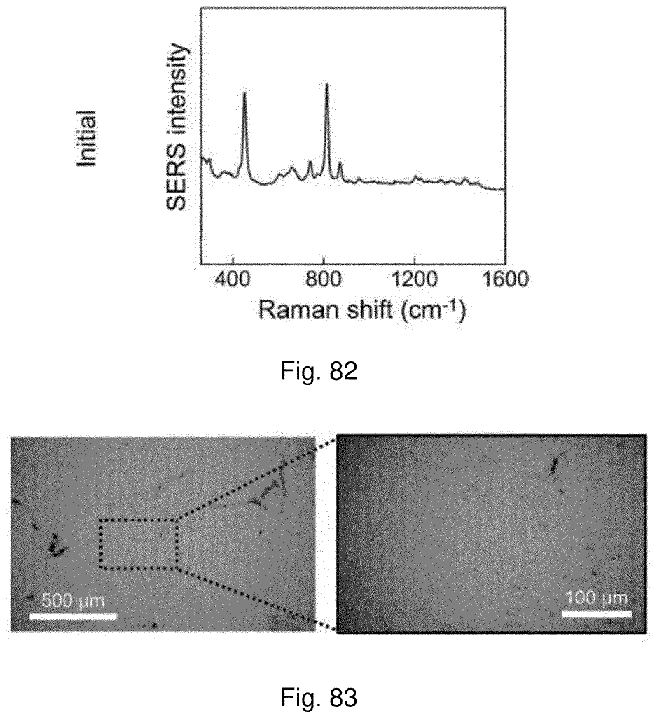

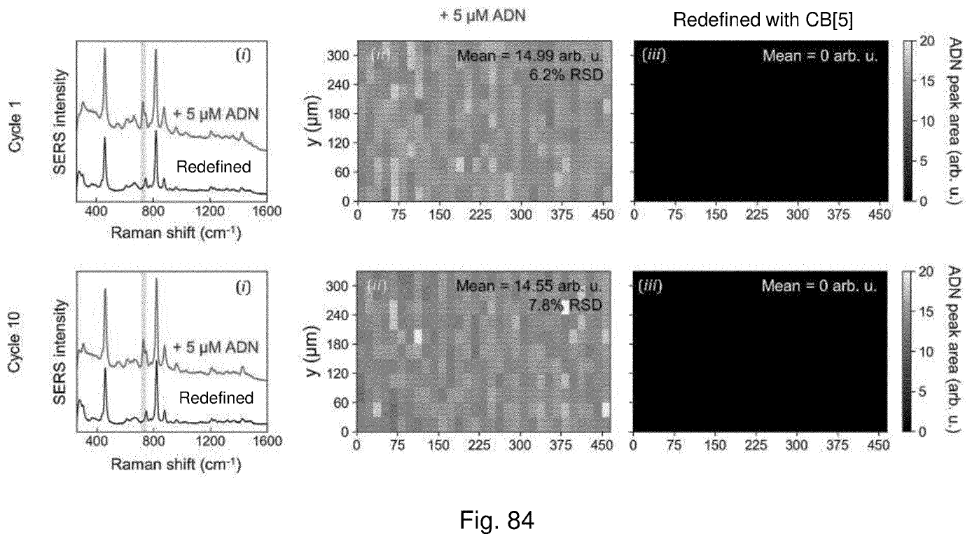

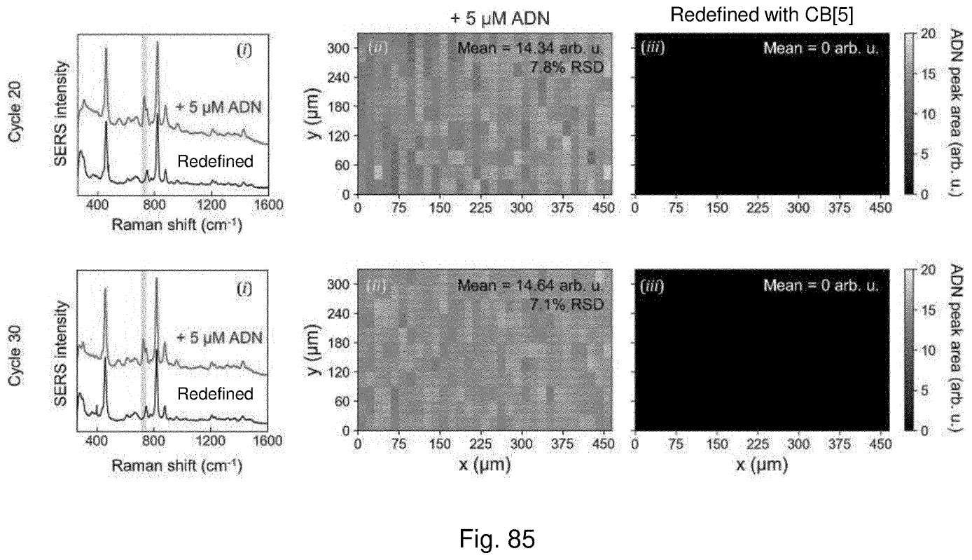

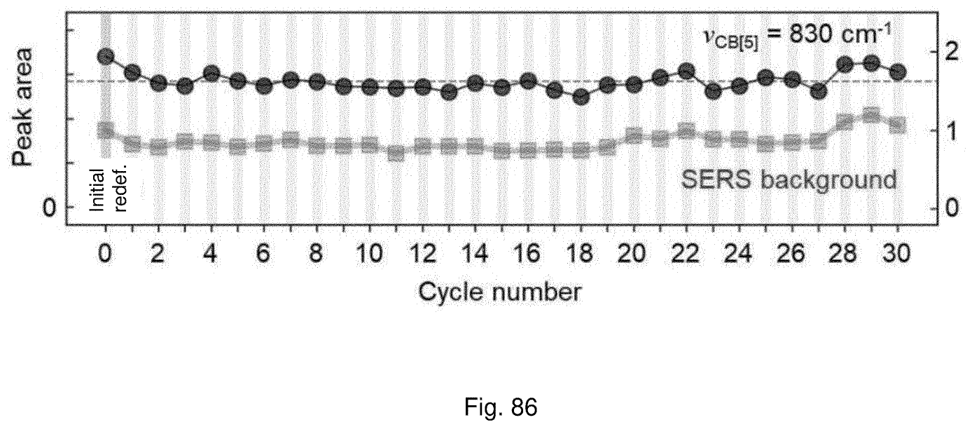

This in-situ analyte detection and oxidative cleaning and redefinition cycle is then performed 30 times to evaluate its repeatability (FIG. 80). Tracking the v_{adenine} peak area every cleaning cycle shows that not only is the analyte successfully removed each time, but the nanoparticle layer is also identically regenerated, yielding a 5.5% relative standard deviation (RSD) between all repetitions (FIG. 81). This variation in analyte detection is comparable to the 5.7% RSD previously observed when detecting and cleaning paracetamol from nanoparticle layers using HCl rinsing over multiple cycles.[115] SERS mapping of the adenine signal at cycles 1, 10, 20, and 30 also shows that the analyte signal and regional uniformity of the substrate remain consistent, implying that all hotspots across the SERS substrate surface area are effectively and reproducibly redefined (FIGS. 82-85). The SERS spectra from the regenerated nanoparticle layer are also consistent across the cycles (FIG. 80, 86), while SERS mapping shows the effective removal of the analyte across the probed area of the SERS substrate (FIG. 82-85). In terms of the number of cycles demonstrated and % RSD, this level of recycling repeatability outperforms any known method. We note that the nanoparticle layer can undergo at least 100 non-continuous analyte detection cycles, even if the nanoparticle layer is removed from the cell and dried intermittently. Under flow conditions, effective adhesion of the nanoparticle layer to the FTO-coated glass is required to ensure its robustness over continuous, prolonged use.

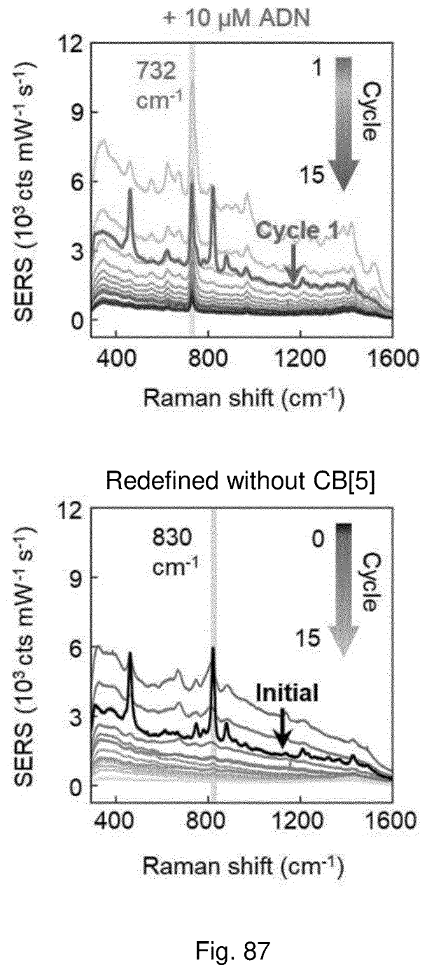

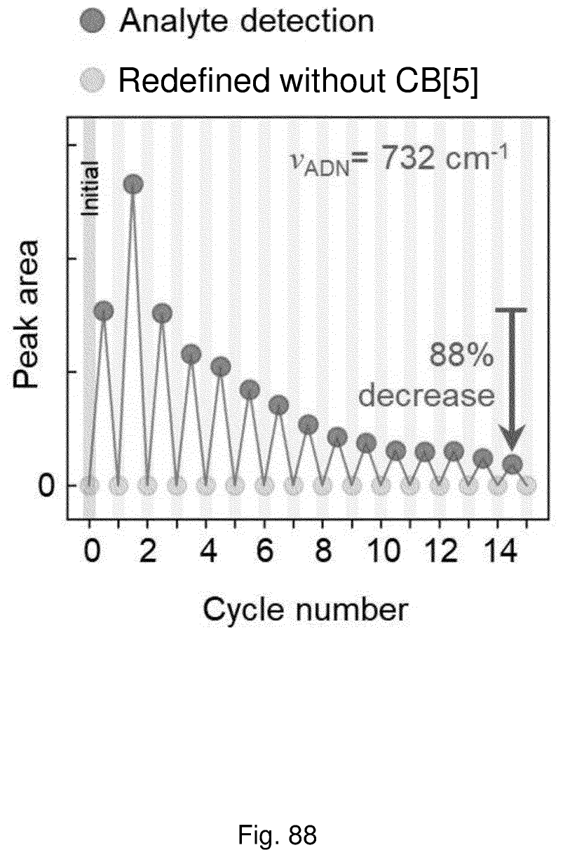

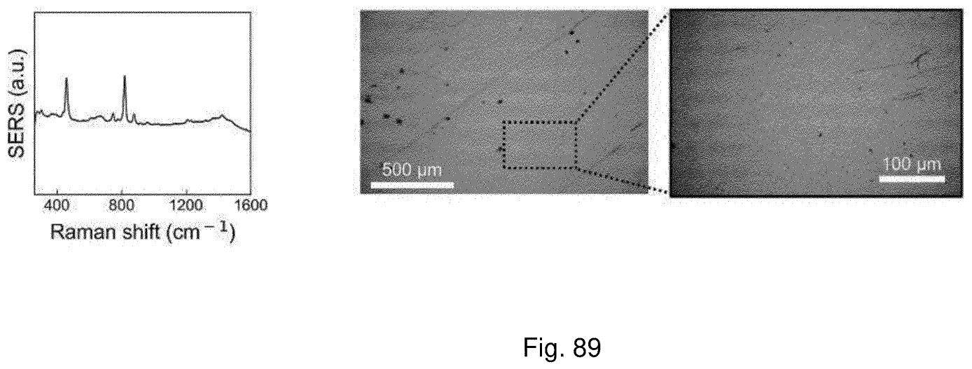

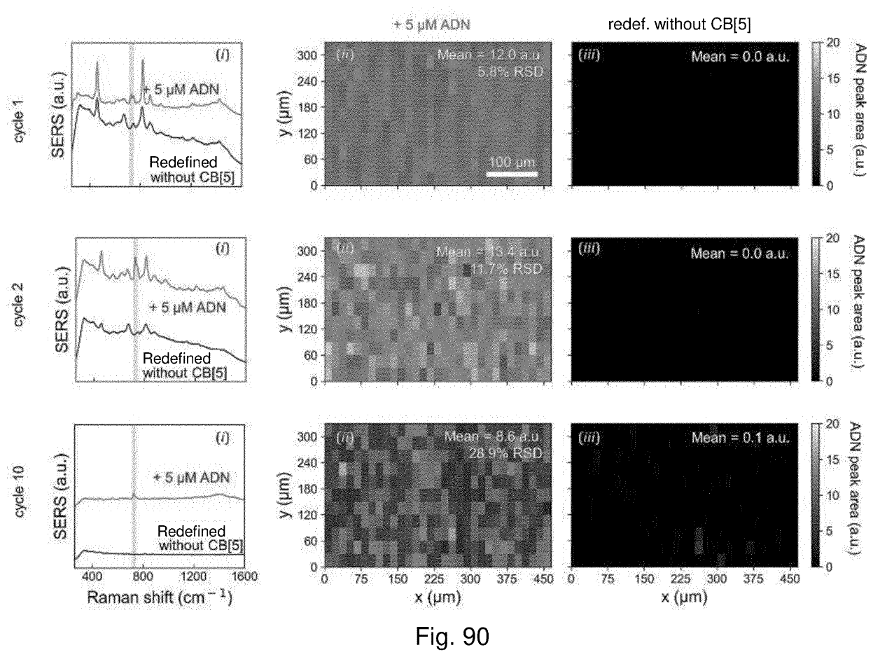

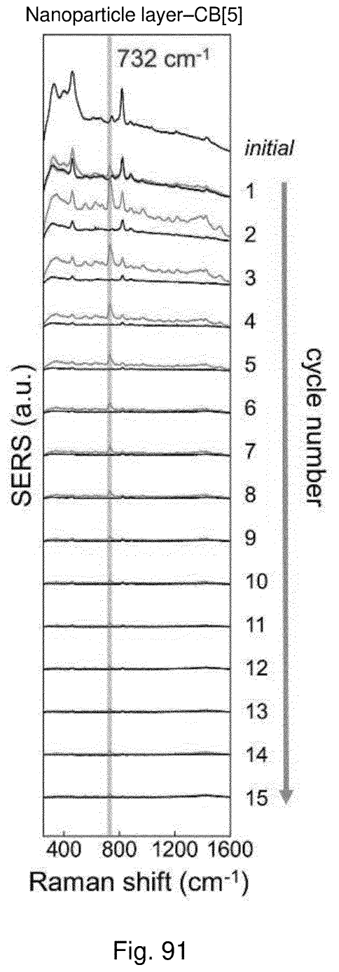

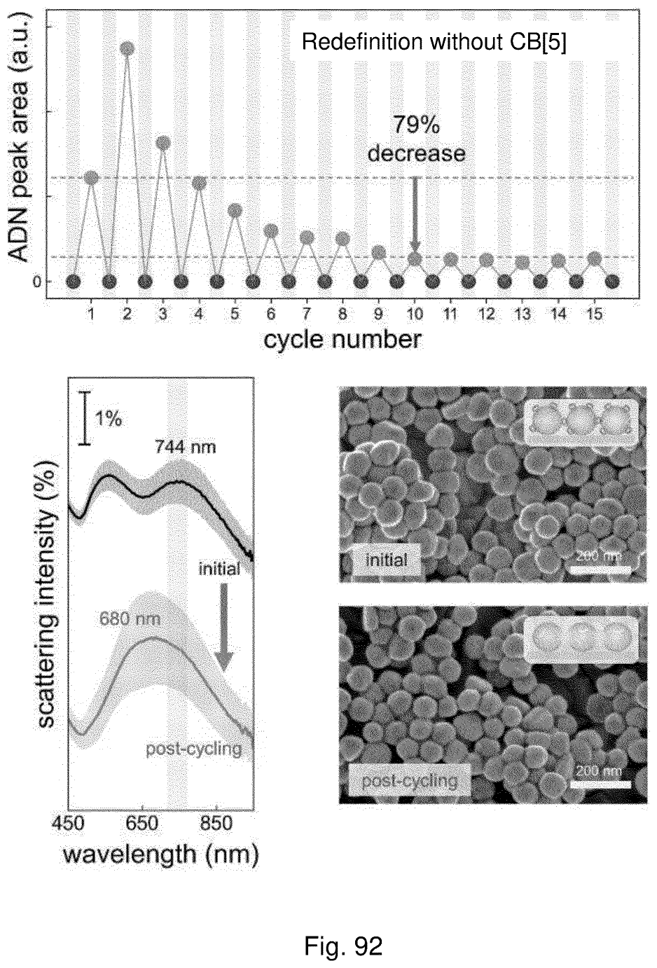

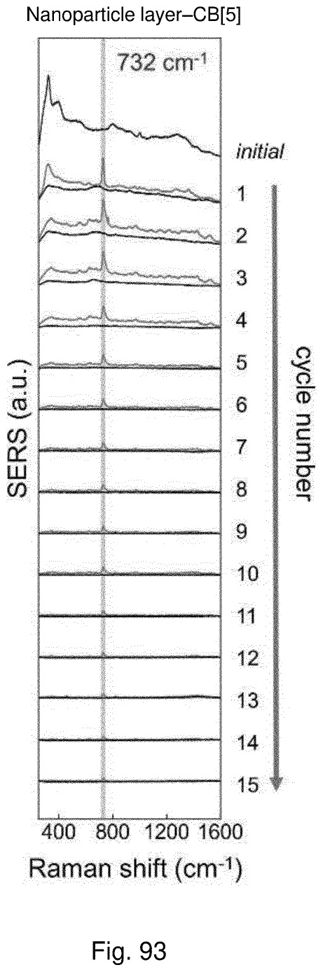

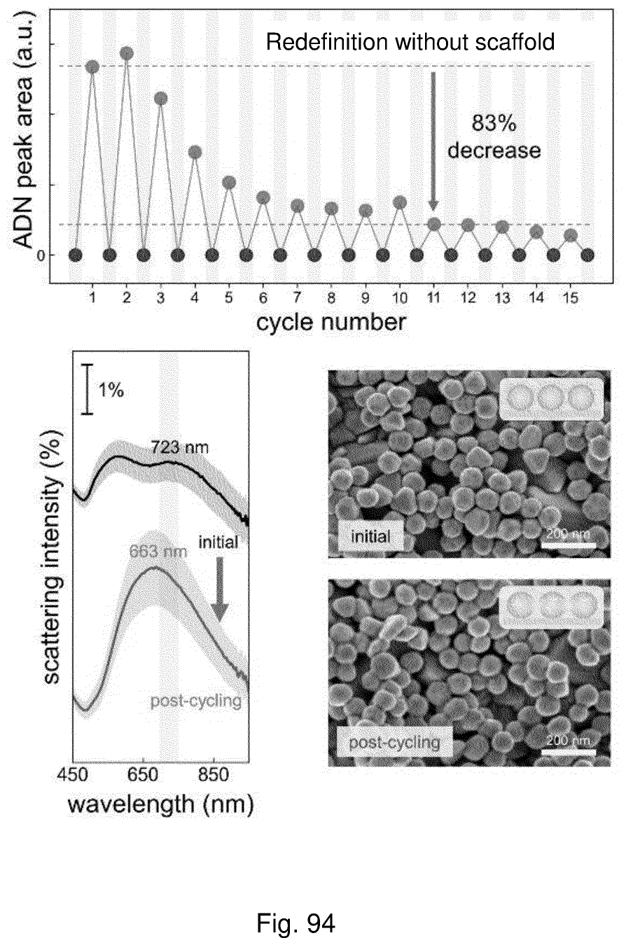

As a control, the same analyte detection, oxidative cleaning, and redefinition cycles are repeated on a new nanoparticle layer-CB[5] SERS substrate but without using a scaffolding ligand during the redefinition step (FIG. 87). Specifically, after Au oxide formation, only buffer is pumped through the EC-SERS flow cell and −0.80 V is applied for 5 s to reduce the oxide. With this protocol, the analyte signal per cycle initially fluctuates and then gradually decreases (FIG. 88), down to 12% of its strength by cycle 15. SERS maps of the analyte signal at cycles 1, 2, and 10 show similar variations in analyte signal across the probed area as well as a degradation in the local uniformity from 6% for cycle 1 to 12% and 29% RSD for cycles 2 and 10 respectively (FIG. 89, 90). A second cycling control using 1 mM KCl and buffer in the redefinition step characterises the effect of chloride ions in the CB[5] solution, giving similar analyte signal fluctuations and a decrease to 21% by cycle 15 (FIGS. 91 and 92). A further control using nanoparticle layers prepared from NaCl-aggregated AuNPs (without CB[5]) yields similar results (FIG. 93, 94).

### Analyte Detection and Cycling Repeatability—Detailed Methods

### Materials

All chemicals were used as received. Citrate-stabilised 80 nm AuNPs (optical density 1.0 at 555 nm) were purchased from BBI Solutions. Analytical-grade chloroform (≥99.8%) was obtained from Merck. HCl (37%) was from Fisher Scientific. NaCl (≥99%), K₂HPO₄ (≥98%), and KH2PO4 (≥98%) were from Alfa Aesar. Cucurbit[5]uril hydrate (≈20% water), and adenine (≥99%) were obtained from Sigma-Aldrich. Polydimethylsiloxane (PDMS) was prepared using a SYLGARD 184 kit from DOWSIL (Dow Silicones). Fluorine-doped tin oxide (FTO)-coated glass slides (TEC 10) were purchased from Ossila Ltd and were cleaned and cut to 10×15 mm slides prior to use. All aqueous solutions were prepared using deionized (DI) water (>18.2 MΩ cm⁻¹) from a Purelab Ultra Scientific water purification system.

### Nanoparticle Layer Preparation

Nanoparticle layer SERS substrates were prepared[115], [116] by first placing 500 μl of 80 nm AuNP with an equal volume of chloroform in an Eppendorf tube. Aggregation of the AuNPs was initiated upon addition of 50 μL of 1 mM CB[5] or 1 M NaCl and was facilitated by vigorous shaking for 1 min. The aggregates were then allowed to settle at the aqueous-organic interface. Excess ligands and salts were removed by replacing the aqueous supernatant with fresh DI water. This washing step was repeated three times. The aggregates were then transferred by carefully decreasing the volume of the aqueous phase to ≈5 μL and depositing the droplet onto a pre-cleaned FTO glass slide. Once deposited, the nanoparticle layer was air dried, rinsed with DI, and dried with compressed N₂.

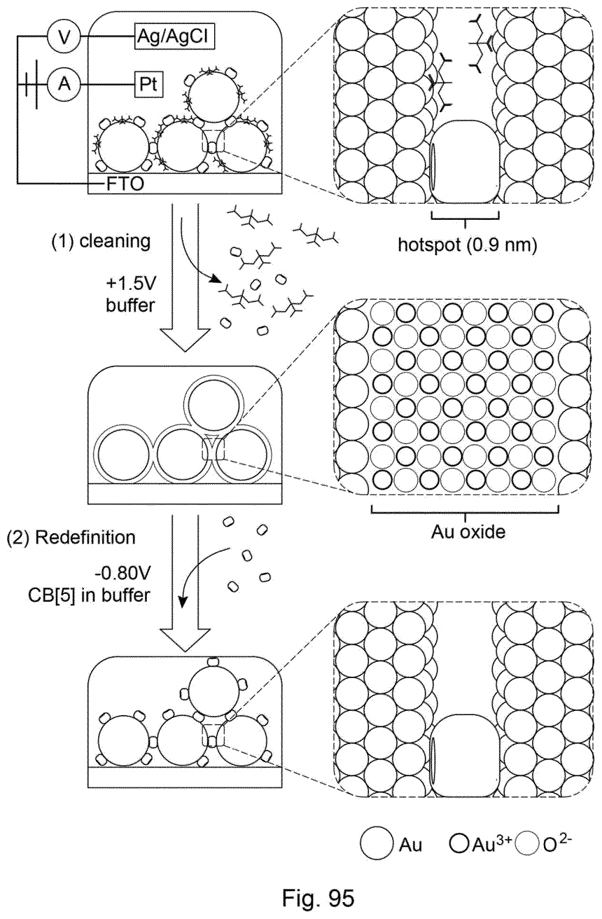

To remove remaining native AuNP ligands from the nanoparticle layer surface, all surface ligands were stripped with oxygen plasma cleaning using 90% RF power and 30 sccm (Henniker Plasma, HPT-100) for 45 min. The desired scaffolding ligand (eg. CB[5]) was then introduced by incubating the plasma cleaned nanoparticle layer in a 1 mM ligand solution prepared in 0.5 M HCl. After 5 min, the nanoparticle layer was rinsed with DI and dried with N₂. Alternatively, initial nanoparticle layer cleaning was also performed with in-situ electrochemical cleaning using the redefinition protocol described below (FIG. 95).

### SERS and Dark-Field Measurements

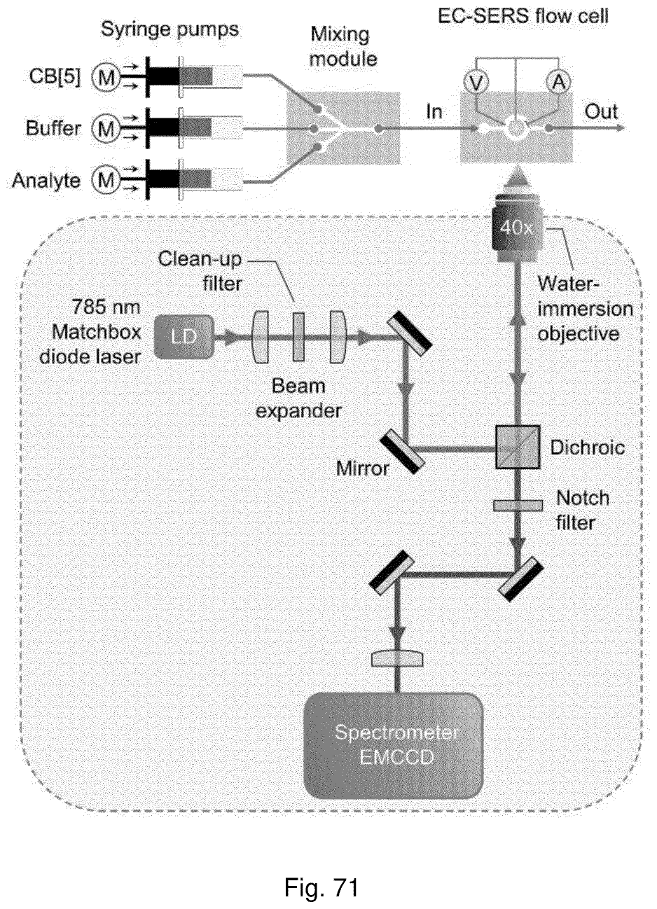

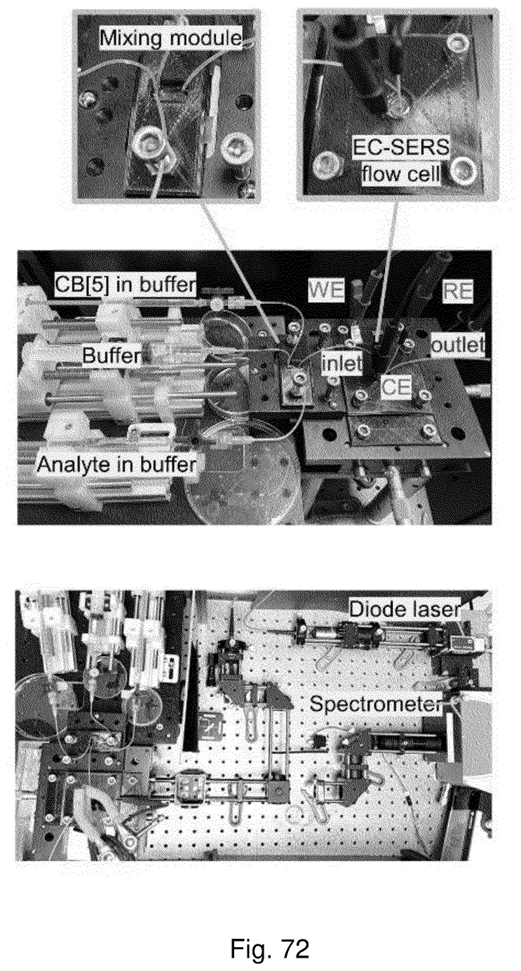

SERS measurements were recorded on a custom-built Raman set-up (FIGS. 71 and 72) using a 785 nm diode laser (Matchbox) set at ≤1 mW power. Excitation and collection were performed through an Olympus LUMPlanFI/IR 40×W 0.80-NA water-immersion objective (in inverted configuration), and spectra were recorded by an Andor Newton 970 EMCCD camera coupled to a Shamrock 168 spectrometer with 1 s integration times.

SERS mapping measurements were taken on a commercial Raman instrument (Renishaw inVia) with 1 s integration times, 785 nm excitation (laser line profile) and 2.1 mW laser power using a 20× 0.40-NA objective. Map scans were taken over a 465×330 μm region over a 31×11 grid with 15×30 μm spacings.

Dark-field (DF) scattering spectra were recorded on a modified Olympus BX51 with an Ocean Optics QE-Pro spectrometer with 0.5 s integration time. Excitation and collection were performed through an Olympus MPLanFL N 20× BD 0.45-NA objective. DF scattering spectra of nanoparticle layer samples were collected over a 600×400 μm area (in a 10×15 point grid) and then averaged. A white light scattering target (Labsphere) was used as a reference to normalize white light scattering.

### SEM Measurements

SEM measurements of nanoparticle layers deposited on FTO-coated glass slides were taken on a FEI Philips Dualbeam Quanta 3D SEM (dwell 3-10 μs, HV 2 kV, current 50 pA, and ~2.0 mm WD) or on a FEI Helios NanoLab 650 SEM (dwell 100 ns-1 μs, HV 20 kV, current 100 pA and =4.0 mm WD). Magnification ranged from 80,000-200,000×.

### EC-SERS Flow Set-Up

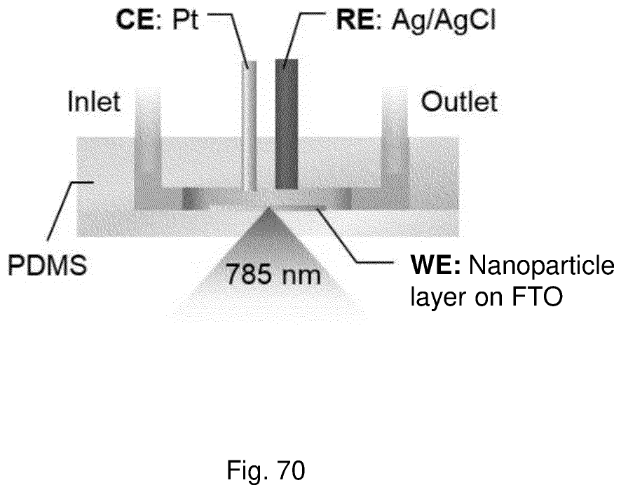

A miniaturized EC-SERS flow cell was designed and fabricated to accommodate a standard three-electrode electrochemical system: a leakless Ag/AgCl reference electrode (LF-1-45 from Innovative Instruments Ltd), a Pt wire (Sigma-Aldrich) counter electrode, and a removeable nanoparticle layer SERS substrate on FTO-coated glass as the working electrode (FIG. 70). The internal volume of the flow cell was 26 μL. The EC-SERS flow cell and a three-inlet/one-outlet mixer module were fabricated with PDMS using 3D-printed moulds. The EC-SERS flow cell was sealed and mounted onto the stage of an inverted Raman set-up using custom 3D-printed holders and bases.

Custom-built syringe pumps were used to control the flow of solutions (buffer, CB[5] in buffer, and analyte in buffer) through the EC-SERS flow cell (FIGS. 71 and 72). Electrochemical measurements were conducted using a portable potentiostat (CompactStat) from Ivium Technologies. All potentials were referenced to the Ag/AgCl reference electrode. The syringe pumps, electrochemical measurements, and SERS spectra collection were all controlled and synchronized with Python scripts.

### Analyte Detection

Aqueous analyte solutions were prepared in a background electrolyte of 50 mM potassium phosphate buffer (pH 7.0, 0.5 mS cm⁻¹ conductivity) and injected into the EC-SERS flow cell. Under static conditions, an electrochemical enhancement potential (−0.60 V) was applied where applicable for 15 s. SERS spectra were then collected at open circuit potential.

For the detection of thiols, the nanoparticle layer was removed from the EC-SERS flow cell and immersed in a 100 μM thiol solution in EtOH for 1 h. Afterwards, the nanoparticle layer was rinsed with EtOH and dried with a stream of N₂. The nanoparticle layer was then reinstalled into the EC-SERS flow cell for cleaning, redefinition, and reference calibrations of adenine detection. Since the nanoparticle layer was periodically removed from the cell, it was difficult to probe precisely the same spot on the nanoparticle layer surface, so spectra were taken over multiple random spots across the substrate (n=10) and averaged. Variations in the spectra in this case thus also include spatial variation across the nanoparticle layer.

### Cleaning and Redefinition

To clean and redefine the nanoparticle layer, 50 mM potassium phosphate buffer (pH 7.0) was pumped into the EC-SERS flow cell and a potential of +1.5 V vs Ag/AgCl was held for 5-60 s under continuous buffer flow (flow rate=500 μL min⁻¹). For initial nanoparticle layer cleaning, 60 s was typically required, while for analyte cleaning, 15-30 s was sufficient. After cleaning, 1 mM CB[5] in 50 mM potassium phosphate buffer (pH 7.0) was pumped into the flow cell. Under static conditions, a potential of −0.80 V vs Ag/AgCl was held for 5 s. Buffer was then flushed into the cell to remove excess scaffold molecules. If traces of previously detected analyte were evident from the SERS spectrum, another round of cleaning/redefinition was conducted.

During detection/cleaning cycling experiments, solution syringes were refilled every 12-15 cycles. The flow system was allowed to stabilise before measurements were resumed. Care was also taken to record the SERS spectra from the same substrate spot throughout the cycling experiments. However, the continuous operation of the flow system was occasionally halted to replenish the water droplet on the water immersion objective, which tended to dry over prolonged use. Since this required moving the EC-SERS flow cell, some variation in the probed substrate spot can occur.

### Data Analysis

SERS spectra are presented here with minimal data processing, except for background correction to eliminate the broad glass background signal centred at 1400 cm⁻¹ that arises from back-side optical measurements. Analyte peak areas were determined by iteratively fitting a polynomial to correct for the SERS background, followed by fitting Gaussian curves to the narrow analyte peaks of interest. To determine the peak wavelength of the nanoparticle layer coupled plasmon mode from DF scattering spectra, Gaussian curves were fitted for each DF spectrum. The peak wavelength was determined from the centre of the fitted Gaussian.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

A number of publications are cited above in order to more fully describe and disclose the invention and the state of the art to which the invention pertains. The entirety of each of these references is incorporated herein.

### REFERENCES

[1] Langer, J. Et al. Present and Future of Surface-Enhanced Raman Scattering. ACS Nano 14, 28-117 (2020).
[2] Yan, B. et al. Engineered SERS substrates with multiscale signal enhancement: nanoparticle cluster arrays. ACS Nano 3, 1190-1202 (2009).
[3] Que, R. et al. Highly Reproducible Surface-Enhanced Raman Scattering on a Capillarity-Assisted Gold Nanoparticle Assembly. Adv. Funct. Mater. 21, 3337-3343 (2011).
[4] Matricardi, C. et al. Gold Nanoparticle Plasmonic Superlattices as Surface-Enhanced Raman Spectroscopy Substrates. ACS Nano 12, 8531-8539 (2018).
[5] Hanske, C. et al. Solvent-Assisted Self-Assembly of Gold Nanorods into Hierarchically Organized Plasmonic Mesostructures. ACS Appl. Mater. Interfaces 11, 11763-11771 (2019).
[6] Wang, H., Levin, C. S. & Halas, N. J. Nanosphere arrays with controlled sub-10-nm gaps as surface-enhanced Raman spectroscopy substrates. J. Am. Chem. Soc. 127, 14992-14993 (2005).
[7] Li, P. et al. Evaporative Self-Assembly of Gold Nanorods into Macroscopic 3D Plasmonic Superlattice Arrays. Adv. Mater. 28, 2511-2517 (2016).
[8] Kim, J. et al. Polymorphic Assembly from Beveled Gold Triangular Nanoprisms. Nano Lett. 17, 3270-3275 (2017).
[9] Wei, W. et al. Fabrication of Large-Area Arrays of Vertically Aligned Gold Nanorods. Nano Lett. 18, 4467-4472 (2018).
[10] Park, Y. K. & Park, S. Directing close-packing of midnanosized gold nanoparticles at a water/hexane interface. Chem. Mater. 20, 2388-2393 (2008).
[11] Scarabelli, L., Coronado-Puchau, M., Giner-Casares, J. J., Langer, J. & Liz-Marzán, L. M. Monodisperse gold nanotriangles: Size control, large-scale self-assembly, and performance in surface-enhanced raman scattering. ACS Nano 8, 5833-5842 (2014).
[12] Shin, Y., Song, J., Kim, D. & Kang, T. Facile Preparation of Ultrasmall Void Metallic Nanogap from Self-Assembled Gold-Silica Core-Shell Nanoparticles Monolayer via Kinetic Control. Adv. Mater. 27, 4344-4350 (2015).
[13] Guo, Q., Xu, M., Yuan, Y., Gu, R. & Yao, J. Self-assembled large-scale monolayer of Au nanoparticles at the air/water interface used as a SERS substrate. Langmuir 32, 4530-4537 (2016).
[14] Yang, G., Hu, L., Keiper, T. D., Xiong, P. & Hallinan, D. T. Gold Nanoparticle Monolayers with Tunable Optical and Electrical Properties. Langmuir 32, 4022-4033 (2016).
[15] Yang, G., Nanda, J., Wang, B., Chen, G. & Hallinan, D. T. Self-Assembly of Large Gold Nanoparticles for Surface-Enhanced Raman Spectroscopy. ACS Appl. Mater. Interfaces 9, 13457-13470 (2017).
[16] Wu, P., Zhong, L. Bin, Liu, Q., Zhou, X. & Zheng, Y. M. Polymer induced one-step interfacial self-assembly method for the fabrication of flexible, robust and free-standing SERS substrates for rapid on-site detection of pesticide residues. Nanoscale 11, 12829-12836 (2019).
[17] Barrow, S. J., Kasera, S., Rowland, M. J., Del Barrio, J. & Scherman, O. A. Cucurbituril-Based Molecular Recognition. Chem. Rev. 115, 12320-12406 (2015).
[18] Taylor, R. W. et al. Precise subnanometer plasmonic junctions for SERS within gold nanoparticle assemblies using cucurbit[n]uril ‘glue’. ACS Nano 5, 3878-3887 (2011).
[19] Lin, X. M., Cui, Y., Xu, Y. H., Ren, B., & Tian, Z. Q. Surface-enhanced raman spectroscopy: Substrate-related issues. Analytical and Bioanalytical Chemistry, 394(7), 1729-1745 (2009).
[20] Li, M. De, Cui, Y., Gao, M. X., Luo, J., Ren, B., & Tian, Z. Q. (2008). Clean substrates prepared by chemical adsorption of iodide followed by electrochemical oxidation for surface-enhanced raman spectroscopic study of cell membrane. Analytical Chemistry, 80(13), 5118-5125.
[21] Duan, H., Hu, H., Kumar, K., Shen, Z. & Yang, J. K. W. Direct and reliable patterning of plasmonic nanostructures with sub-10-nm gaps. ACS Nano 5, 7593-7600 (2011).
[22] Luo, S. et al. Massively Parallel Arrays of Size-Controlled Metallic Nanogaps with Gap-Widths Down to the Sub-3-nm Level. Adv. Mater. 33, 2100491 (2021)
[23] Luo, S. et al. High-Throughput Fabrication of Triangular Nanogap Arrays for Surface-Enhanced Raman Spectroscopy. ACS Nano 16, 7438-7447 (2021).
[24] Jha, S. K., Ahmed, Z., Agio, M., Ekinci, Y. & Löffler, J. F. Deep-UV surface-enhanced resonance Raman scattering of adenine on aluminum nanoparticle arrays. J. Am. Chem. Soc. 134, 1966-1969 (2012).
[25] Chen, Y. et al. Rapid Focused Ion Beam Milling Based Fabrication of Plasmonic Nanoparticles and Assemblies via ‘sketch and Peel’ Strategy. ACS Nano 10, 11228-11236 (2016).
[26] Punj, D. et al. A plasmonic ‘antenna-in-box’ platform for enhanced single-molecule analysis at micromolar concentrations. Nat. Nanotechnol. 8, 512-516 (2013).
[27] Liu, L. et al. A high-performance and low cost SERS substrate of plasmonic nanopillars on plastic film fabricated by nanoimprint lithography with AAO template. AIP Adv. 7, 065205 (2017).
[28] Suresh, V., Ding, L., Chew, A. B. & Yap, F. L. Fabrication of Large-Area Flexible SERS Substrates by Nanoimprint Lithography. ACS Appl. Nano Mater. 1, 886-893 (2018).
[29] Song, J., Nam, W. & Zhou, W. Scalable High-Performance Nanolaminated SERS Substrates Based on Multistack Vertically Oriented Plasmonic Nanogaps. Adv. Mater. Technol. 4, 1800689 (2019).
[30] Kneipp, K. et al. Single Molecule Detection Using Surface-Enhanced Raman Scattering (SERS). Phys. Rev. Lett. 78, 1667-1670 (1997).
[31] Blackie, E. J., Le Ru, E. C. & Etchegoin, P. G. Single-molecule surface-enhanced raman spectroscopy of nonresonant molecules. J. Am. Chem. Soc. 131, 14466-14472 (2009).
[32] Cha, H., Yoon, J. H. & Yoon, S. Probing quantum plasmon coupling using gold nanoparticle dimers with tunable interparticle distances down to the subnanometer range. ACS Nano 8, 8554-8563 (2014).
[33] Martin, M. N., Basham, J. I., Chando, P. & Eah, S. K. Charged gold nanoparticles in non-polar solvents: 10-min synthesis and 2D self-assembly. Langmuir 26, 7410-7417 (2010).
[34] Grys, D.-B. et al. Citrate Coordination and Bridging of Gold Nanoparticles: The Role of Gold Adatoms in AuNP Aging. ACS Nano 14, 8689-8696 (2020).
[35] Pfisterer, J. H. K. et al. Role of OH Intermediates during the Au Oxide Electro-Reduction at Low pH Elucidated by Electrochemical Surface-Enhanced Raman Spectroscopy and Implicit Solvent Density Functional Theory. ACS Catal. 10, 12716-12726 (2020).
[36] Baumberg, J. J., Aizpurua, J., Mikkelsen, M. H. & Smith, D. R. Extreme nanophotonics from ultrathin metallic gaps. Nat. Mater. 18, 668-678 (2019).
[37] Elliott, E. et al. Fingerprinting the Hidden Facets of Plasmonic Nanocavities. ACS Photonics 9, 2643-2651 (2022).
[38] Tsai, H. et al. Instability of gold oxide Au2O3. Surf. Sci. 537, L447-L450 (2003).
[39] Wang, J., Chen, S., Cui, K., Li, D. & Chen, D. Approach and Coalescence of Gold Nanoparticles Driven by Surface Thermodynamic Fluctuations and Atomic Interaction Forces. ACS Nano 10, 2893-2902 (2016).
[40] Ingham, B. et al. How nanoparticles coalesce: An in situ study of Au nanoparticle aggregation and grain growth. Chem. Mater. 23, 3312-3317 (2011).
[41] Arcidiacono, S., Bieri, N. R., Poulikakos, D. & Grigoropoulos, C. P. On the coalescence of gold nanoparticles. Int. J. Multiph. Flow 30, 979-994 (2004).
[42] Benz, F. et al. SERS of Individual Nanoparticles on a Mirror: Size Does Matter, but so Does Shape. J. Phys. Chem. Lett. 7, 2264-2269 (2016).
[43] Feng, Z. et al. Trapping of Charged Gold Adatoms by Dimethyl Sulfoxide on a Gold Surface. ACS Nano 9, 8697-8709 (2015).
[44] de Nijs, B. et al. Inhibiting Analyte Theft in Surface-Enhanced Raman Spectroscopy Substrates: Subnanomolar Quantitative Drug Detection. ACS Sensors 4, 2988-2996 (2019).
[45] D. Ambrose, C. H. Sprake, and R. Townsend, “Thermodynamic properties of organic oxygen compounds XXXIII. The vapour pressure of acetone,” J. Chem. Thermodyn., vol. 6, pp. 693-700, 1974.
[46] L. M. Besley and G. A. Bottomley, “Vapour pressure of toluence from 273.15 to 298.15 K,” J. Chem. Thermodyn., vol. 6, pp. 577-580, 1974.
[47] T. B. Douglas, “Vapor Pressure of Methyl Sulfoxide from 20 to 50°. Calculation of the Heat of Vaporization,” J. Am. Chem. Soc., vol. 70, pp. 2001-2002, 1948.
[48] H. F. Gibbard and J. L. Creek, “Vapor Pressure of Methanol from 288.15 to 337.65K,” J. Chem. Eng. Data, vol. 19, pp. 308-310, 1974
[49] D. Ambrose and C. H. Sprake, “Thermodynamic properties of organic oxygen compounds XXV. Vapour pressures and normal boiling temperatures of aliphaticalcohols,” J. Chem. Thermodyn., vol. 2, pp. 631-645, 1970.
[50] Pradhan, T. et al. Chemical sensing of neurotransmitters. Chem Soc Rev 43, 4684-4713 (2014).
[51] Niyonambaza, S. D. et al. A Review of Neurotransmitters Sensing Methods for Neuro-Engineering Research. Applied Sciences 9, 4719 (2019).
[52] Zhang, A., Neumeyer, J. L. & Baldessarini, R. J. Recent Progress in Development of Dopamine Receptor Subtype-Selective Agents: Potential Therapeutics for Neurological and Psychiatric Disorders. Chem Rev 107, 274-302 (2007).
[53] Grace, A. A. Dopamine system dysregulation by the hippocampus: Implications for the pathophysiology and treatment of schizophrenia. Neuropharmacology 62, 1342-1348 (2012).
[54] Calabresi, P., Picconi, B., Tozzi, A. & di Filippo, M. Dopamine-mediated regulation of corticostriatal synaptic plasticity. Trends Neurosci 30, 211-219 (2007).
[55] Juárez Olguín, H., Calderón Guzmán, D., Hernández García, E. & Barragán Mejía, G. The role of dopamine and its dysfunction as a consequence of oxidative stress. Oxid Med Cell Longev 2016, (2016).
[56] Verma, S. et al. ZnO-rGO nanocomposite based bioelectrode for sensitive and ultrafast detection of dopamine in human serum. Biosens Bioelectron 165, (2020).
[57] Lussier, F. et al. Dynamic SERS nanosensor for neurotransmitter sensing near neurons. Faraday Discuss 205, 387-407 (2017).
[58] Wightman, R. M., Strope, E., Plotsky, P. M. & Adams, R. N. Monitoring of transmitter metabolites by voltammetry in cerebrospinal fluid following neural pathway stimulation. Nature 262, 145-146 (1976).
[59] Gemperline, E., Chen, B. & Li, L. Challenges and recent advances in mass spectrometric imaging of neurotransmitters. Bioanalysis 6, 525 (2014).
[60] Zhao, X. E. et al. Simultaneous determination of amino acid and monoamine neurotransmitters in PC12 cells and rats models of Parkinson's disease using a sensitizing derivatization reagent by UHPLC-MS/MS. J Chromatogr B Analyt Technol Biomed Life Sci 995-996, 15-23 (2015).
[61] Hugo, V. et al. An Update of the Classical and Novel Methods Used for Measuring Fast Neurotransmitters During Normal and Brain Altered Function. Curr Neuropharmacol 12, 490-508 (2014).
[62] Zhang, X. et al. Real-time sensing of neurotransmitters by functionalized nanopores embedded in a single live cell. Molecular Biomedicine 2, 1-9 (2021).
[63] Kao, Y. C. et al. Multiplex Surface-Enhanced Raman Scattering Identification and Quantification of Urine Metabolites in Patient Samples within 30 min. ACS Nano 14, 2542-2552 (2020).
[64] Benz, F. et al. Single-molecule optomechanics in ‘picocavities’. Science 354, 726-729 (2016).
[65] Mosier-Boss, P. A. Review of SERS Substrates for Chemical Sensing. Nanomaterials 7, (2017).
[66] Tian, F., Bonnier, F., Casey, A., Shanahan, A. E. & Byrne, H. J. Surface enhanced Raman scattering with gold nanoparticles: effect of particle shape. Analytical Methods 6, 9116-9123 (2014).
[67] Kasera, S., Biedermann, F., Baumberg, J. J., Scherman, O. A. & Mahajan, S. Quantitative SERS Using the Sequestration of Small Molecules Inside Precise Plasmonic Nanoconstructs. Nano Lett 12, 5924 (2012).
[68] Nie, S. & Emory, S. R. Probing Single Molecules and Single Nanoparticles by Surface-Enhanced Raman Scattering. Science 275, 1102-1106 (1997).
[69] Kasera, S., Herrmann, L. O., del Barrio, J., Baumberg, J. J. & Scherman, O. A. Quantitative multiplexing with nano-self-assemblies in SERS. Sci Rep 4, (2014).
[70] Grys, D. B. et al. Eliminating irreproducibility in SERS substrates. Journal of Raman Spectroscopy 52, 412-419 (2021).
[71] Grys, D.-B. et al. Controlling atomic-scale restructuring of gold nanogaps for SERS sensing. In preparation (2022).
[72] Wang, C. C. & Chen, J. S. Improved surfaced-enhanced Raman scattering based on electrochemically roughened silver substrates modified through argon plasma treatment. Electrochim Acta 53, 5615-5620 (2008).
[73] Negri, P., Marotta, N. E., Bottomley, L. A. & Dluhy, R. A. Removal of Surface Contamination and Self-Assembled Monolayers (SAMs) from Silver (Ag) Nanorod Substrates by Plasma Cleaning with Argon. Appl Spectrosc 65, 66-74 (2011).
[74] Harrington, M. J., Masic, A., Holten-Andersen, N., Waite, J. H. & Fratzl, P. Iron-clad fibers: A metal-based biological strategy for hard flexible coatings. Science 328, 216-220 (2010).
[75] Holten-Andersen, N. et al. pH-induced metal-ligand cross-links inspired by mussel yield self-healing polymer networks with near-covalent elastic moduli. Proceedings of the National Academy of Sciences 108, 2651-2655 (2011).
[76] Andersson, K. K. et al. Purification and characterization of the bluegreen rat phaeochromocytoma (PC12) tyrosine hydroxylase with a dopamine-Fe(III) complex Reversal of the endogenous feedback inhibition by phosphorylation of serine-40. Biochem. J 284, 687-695 (1992).
[77] Taylor, S. W., Bruce Chase, D., Emptage, M. H., Nelson, M. J. & Herbert Waite, J. Ferric Ion Complexes of a DOPA-Containing Adhesive Protein from Mytilus edulis. Inorg Chem 35, 7572-7577 (1996).
[78] Charkoudian, L. K. & Franz, K. J. Fe(III)-coordinator properties of neuromelanin components: 5,6-dihydroxyindole and 5,6-dihydroxyindole-2-carboxylic acid. Inorg Chem 45, 3657-3664 (2006).
[79] Chen, W.-H. et al. Plasmonic Sensing Assay for Long-term Monitoring (PSALM) of Neurotransmitters in Urine. ACS Nanoscience Au (2022).
[80] Phung, V. D., Jung, W. S., Nguyen, T. A., Kim, J. H. & Lee, S. W. Reliable and quantitative SERS detection of dopamine levels in human blood plasma using a plasmonic Au/Ag nanocluster substrate. Nanoscale 10, 22493-22503 (2018).
[81] Li, P. et al. Functionalized Acupuncture Needle as Surface-Enhanced Resonance Raman Spectroscopy Sensor for Rapid and Sensitive Detection of Dopamine in Serum and Cerebrospinal Fluid. Chemistry—A European Journal 23, 14278-14285 (2017).
[82] Cao, X. et al. Probing catecholamine neurotransmitters based on iron-coordination surface-enhanced resonance Raman spectroscopy label. Sens Actuators B Chem 268, 350-358 (2018).
[83] Li, P., Ge, M., Cao, C., Lin, D. & Yang, L. High-affinity Fe3O4/Au probe with synergetic effect of surface plasmon resonance and charge transfer enabling improved SERS sensing of dopamine in biofluids. Analyst 144, 4526-4533 (2019).
[84] Öhrström, L. & Michaud-Soret, I. Quantum Chemical Approach to the Assignment of Iron-Catecholate Vibrations and Isotopic Substitution Shifts. J Am Chem Soc 118, 3283-3284 (1996).
[85] Michaud Soret, I., Andersson, K. K., Que, L. & Haavik, J. Resonance Raman Studies of Catecholate and Phenolate Complexes of Recombinant Human Tyrosine Hydroxylase. Biochemistry 34, 5504-5510 (1995).
[86] Chen, W. L. et al. Toward quantitative SERS detection in low analyte concentration by investigating the immersion volume and time of SERS substrate in analyte solution. Journal of Raman Spectroscopy 53, 33-39 (2022).
[87] Sadate, S. et al. Recycling of surface-enhanced Raman substrates by ultraviolet cleaning. Optical Engineering 49, 106501 (2010).
[88] Hyeok Park, D. et al. Development of self-cleaning SERS-active nanostructures based on ZnO nanorods and Ag nanoparticles. J Phys Conf Ser 2103, 012128 (2021).
[89] Bai, S., Du, Y., Wang, C., Wu, J. & Sugioka, K. Reusable Surface-Enhanced Raman Spectroscopy Substrates Made of Silicon Nanowire Array Coated with Silver Nanoparticles Fabricated by Metal-Assisted Chemical Etching and Photonic Reduction. Nanomaterials 9, (2019).
[90] Gill, H. S. et al. Reusable SERS active substrates for ultrasensitive molecular detection. Sens Actuators B Chem 220, 794-798 (2015).
[91] Diaz-Morales, O., Calle-Vallejo, F., de Munck, C. & Koper, M. T. M. Electrochemical water splitting by gold: evidence for an oxide decomposition mechanism. Chem Sci 4, 2334-2343 (2013).
[92] Yeo, B. S., Klaus, S. L., Ross, P. N., Mathies, R. A. & Bell, A. T. Identification of hydroperoxy species as reaction intermediates in the electrochemical evolution of oxygen on gold. ChemPhysChem 11, 1854-1857 (2010).
[93] Ie Ru, E. C. & Etchegoin, P. G. Rigorous justification of the |E| 4 enhancement factor in Surface Enhanced Raman Spectroscopy q. Chem Phys Lett 423, 63-66 (2006).
[94] Bouatra, S. et al. The Human Urine Metabolome. PloS One 8, e73076 (2013).
[95] Owesson-White, C. A. et al. Sources Contributing to the Average Extracellular Concentration of Dopamine in the Nucleus Accumbens. J Neurochem 121, 252 (2012).
[96] Becke, A. D. Density-functional thermochemistry. III. The role of exact exchange. J Chem Phys 98, 5648-5652 (1993).
[97] Lee, C., Yang, W. & Parr, R. G. Development of the Colle-Salvetti correlation-energy formula into a functional of the electron density. Phys Rev B 37, 785-789 (1988).
[98] Grimme, S., Ehrlich, S. & Goerigk, L. Effect of the damping function in dispersion corrected density functional theory. J Comput Chem 32, 1456-1465 (2011).
[99] Weigend, F. & Ahlrichs, R. Balanced basis sets of split valence, triple zeta valence and quadruple zeta valence quality for H to Rn: Design and assessment of accuracy. Phys. Chem. Chem. Phys. 7, 3297-3305 (2005).
[100] Frisch, M. J. Et al. Gaussian 09. Revision E. 01. Gaussian Inc., Wallingford, CT. (2009).
[101] Tchaplyguine, M., Mikkelä, M.-H., Zhang, C., Andersson, T. & Bjö, O. Gold Oxide Nanoparticles with Variable Gold Oxidation State. Journal of Physical Chemistry C 119, 8937-8943 (2015).
[102] King, D. E. Oxidation of gold by ultraviolet light and ozone at 25° C. Journal of Vacuum Science & Technology A 13, 1247 (1995).
[103] Aita, C. R. & Tran, N. C. Core level and valence band x-ray photoelectron spectroscopy of gold oxide. Journal of Vacuum Science & Technology A: Vacuum, Surfaces, and Films 9, 1498 (1998).
[104] Pireaux, J. J., Liehr, M., Thiry, P. A., Delrue, J. P. & Caudano, R. Electron spectroscopic characterization of oxygen adsorption on gold surfaces. II. Production of gold oxide in oxygen DC reactive sputtering. Surf Sci 141, 221-232 (1984).
[105] Koslowski, B. et al. Oxidation of preferentially (1 1 1)-oriented Au films in an oxygen plasma investigated by scanning tunneling microscopy and photoelectron spectroscopy. Surf Sci 475, 1-10 (2001).
[106] Manciu, F. S. et al. Simultaneous Detection of Dopamine and Serotonin-A Comparative Experimental and Theoretical Study of Neurotransmitter Interactions. Biosensors 9, 3 (2018).
[107] Moldovan, R. et al. Review on combining surface-enhanced Raman spectroscopy and electrochemistry for analytical applications. Anal. Chim. Acta (2021) doi:10.1016/j.aca.2021.339250.
[108] Wu, D. Y., Li, J. F., Ren, B. & Tian, Z. Q. Electrochemical surface-enhanced Raman spectroscopy of nanostructures. Chem. Soc. Rev. 37, 1025-1041 (2008).
[109] Zhumaev, U. et al. Electro-oxidation of Au(1 1 1) in contact with aqueous electrolytes: New insight from in situ vibration spectroscopy. Electrochim. Acta 112, 853-863 (2013).
[110] Xiao, Y. J., Chen, Y. F. & Gao, X. X. Comparative study of the surface enhanced near infrared Raman spectra of adenine and NAD+ on a gold electrode. Spectrochim. Acta—Part A Mol. Biomol. Spectrosc. 55, 1209-1218 (1999).
[111] Yao, G., Zhai, Z., Zhong, J. & Huang, Q. DFT and SERS Study of 15N Full-Labeled Adenine Adsorption on Silver and Gold Surfaces. J. Phys. Chem. C 121, 9869-9878 (2017).
[112] Pothier, N. J. & Force, R. K. Surface-enhanced Raman spectroscopy at a silver electrode as a detection system in flowing streams. Anal. Chem. 62, 678-680 (1990).
[113] Yoshimoto, T. et al. Three distinct adsorbed states of adenine on gold nanoparticles depending on pH in aqueous solutions. Chem. Phys. Lett. 786, 139202 (2022).
[114] Van Duyne, R. P. Laser Excitation of Raman Scattering From Adsorbed Molecules on Electrode Surfaces. Chemical and Biochemical Applications of Lasers (Academic Press, Inc., 1979). Doi:10.1016/b978-0-12-505404-1.50009-x.
[115] Grys, D.-B. et al. Controlling Atomic-Scale Restructuring and Cleaning of Gold Nanogap Multilayers for Surface-Enhanced Raman Scattering Sensing. ACS Sensors 8, 2879-2888 (2023)
[116] Arul, R. et al. Giant mid-IR resonant coupling to molecular vibrations in sub-nm gaps of plasmonic multilayer metafilms. Light Sci. Appl. 11, 281 (2022)

1. A method of conditioning a surface-enhanced spectroscopy (SES) SES substrate, comprising
providing a support,
providing a nanoparticle layer on the support, wherein the nanoparticle layer comprises metallic nanoparticles,
subjecting the nanoparticle layer to an oxidative cleaning step, thereby producing an oxide coating at the surfaces of the nanoparticles, and
subsequently subjecting the nanoparticle layer to a redefinition step, wherein the oxide coating is removed in the presence of scaffolding ligands so that the scaffolding ligands are arranged between adjacent nanoparticles to define their relative spacing for subsequent use in SES analysis.

2. The method of claim 1, wherein the oxidative cleaning step acts to strip away surface-bound molecules from the surfaces of the nanoparticles.

3. The method of claim 1, wherein the metallic nanoparticles are selected from one or more metals which support optical-frequency or mid-infrared-frequency surface plasmons.

4. The method of claim 1, wherein the metallic nanoparticles are one or more of a metal selected from the group consisting of gold (Au), silver (Ag), copper (Cu) and aluminium (Al).

5. The method of claim 1, wherein the metallic nanoparticles are provided with a coating of palladium (Pd) or platinum (Pt) on their surfaces.

6. The method of claim 1, wherein the nanoparticle layer is a monolayer nanoparticle layer, a multilayer nanoparticle layer, or a nanoparticle layer with monolayer nanoparticle regions and with multilayer nanoparticle regions.

7. The method of claim 1, wherein the redefinition step comprises removing the oxide coating under reducing conditions or acidic conditions in the presence of a scaffolding ligand.

8. The method of claim 1, wherein the redefinition step comprises removing the oxide coating with an acid or reducing agent in the presence of the scaffolding ligand.

9. The method of claim 1, wherein the redefinition step comprises removing the oxide coating thermally or with UV light in the presence of a scaffolding ligand.

10. The method of claim 1, wherein the redefinition step comprises removing the oxide coating under acidic or neutral pH conditions in the presence of a scaffolding ligand and a halide ion.

11. The method of claim 1, wherein the scaffolding ligand is one or more molecules which have a binding affinity for the surfaces of the metallic nanoparticles.

12. The method of claim 1, wherein the scaffolding ligand is one or more molecules selected from the group consisting of a cucurbit[n]uril, a polystyrene molecule, 3-mercaptopropionic acid, citrate, acetic acid, cysteamine, dopamine, paracetamol, ethanol and methanol.

13. The method of claim 1, wherein the surfaces of the nanoparticles comprise a sensitising agent that facilitates binding of molecules to the nanoparticles.

14. (canceled)

15. The method of claim 1, wherein the oxidative cleaning step comprises oxygen plasma treatment, wherein the nanoparticle layer is exposed to oxygen plasma.

16. The method of claim 1, wherein the oxidative cleaning step comprises electrochemical oxidation, wherein a positive voltage is applied across the SES substrate in an electrochemical cell.

17. The method of claim 1, wherein the redefinition step comprises removing the oxide coating by electrochemical reduction, wherein a negative voltage is applied across the SES substrate in an electrochemical cell in the presence of a scaffolding ligand.

18. The method of claim 1, further comprising a subsequent oxidative cleaning step and redefinition step cycle.

19. (canceled)

20. (canceled)

21. A method of carrying out surface-enhanced spectroscopy (SES), the method comprising providing a SES substrate comprising a support and a nanoparticle layer on the support, wherein the nanoparticle layer comprises metallic nanoparticles, the method further comprising the steps of, in order:
performing a first SES analysis using the SES substrate,
subjecting the nanoparticle layer to an oxidative cleaning step,
subjecting the nanoparticle layer to a redefinition step, to provide a reconditioned SES substrate, and
performing a second SES analysis on the reconditioned SES substrate.

22. (canceled)

23. The method of claim 21, further comprising a subsequent oxidative cleaning step, redefinition step and SES analysis cycle.

24. (canceled)

25. The method of claim 21, wherein the relative standard deviation of the peak area of an analyte probed in each SES analysis is less than or equal to 10% across all oxidative cleaning step, redefinition step and SES analysis cycles.
